(19) United States
(12) Patent Application Publication
(10) Pub. No.: US 2008/0256008 A1
(43) Pub. Date: Oct. 16, 2008

(54) Human Artificial Intelligence Machine

(76) Inventor: Mitchell Kwok, Honolulu, HI (US)

Correspondence Address: Mitchell Kwok, 1675 Kamamalu Ave., Honolulu, HI, 96813, US

(21) Appl. No.: 12/129,231

(22) Filed: May 29, 2008

Related U.S. Application Data
(63) Continuation-in-part of application No. 12/110,313, filed on Apr. 26, 2008.
Application No. 12/110,313 is a continuation-in-part of application No. 12/014,742, filed on Jan. 15, 2008.
Application No. 12/014,742 is a continuation-in-part of application No. 11/936,725, filed on Nov. 7, 2007.
Application No. 11/936,725 is a continuation-in-part of application No. 11/770,734, filed on Jun. 29, 2007.
Application No. 11/770,734 is a continuation-in-part of application No. 11/744,767, filed on May 4, 2007.
(60) Provisional application No. 61/035,645, filed on Mar. 11, 2008.
(60) Provisional application No. 61/028,885, filed on Feb. 14, 2008.
(60) Provisional application No. 61/015,201, filed on Dec. 20, 2007.
(60) Provisional application No. 60/909,437, filed on Mar. 31, 2007.

(51) Int. Cl. G06F 15/18; G06N 3/02

(52) U.S. Cl. 706/20; 706/21

(57) ABSTRACT

A method of creating human artificial intelligence in machines and computer software is presented here, as well as methods to simulate human reasoning, thought and behavior. The present invention serves as a universal artificial intelligence program that will store, retrieve, analyze, assimilate, predict the future and modify information in a manner and fashion which is similar to human beings and which will provide users with a software application that will serve as the main intelligence of one or a multitude of computer based programs, software applications, machines or compilation of machinery.

### CROSS REFERENCE TO RELATED APPLICATIONS

This application claims the benefit of U.S. Provisional Application No. 61/035,645, filed on Mar. 11, 2008, this application is also a Continuation-in-Part application of U.S. Ser. No. 12/110,313, filed on Apr. 26, 2008, entitled: Human Level Artificial Intelligence Machine, which claims the benefit of U.S. Provisional Application No. 61/028,885 filed on Feb. 14, 2008, which is a Continuation-in-Part application of U.S. Ser. No. 12/014,742, filed on Jan. 15, 2008, entitled: Human Artificial Intelligence Software Program, which claims the benefit of U.S. Provisional Application No. 61/015,201 filed on Dec. 20, 2007, which is a Continuation-in-Part application of U.S. Ser. No. 11/936,725, filed on Nov. 7, 2007, entitled: Human Artificial Intelligence Software Application for Machine & Computer Based Program Function, which is a Continuation-in-Part application of U.S. Ser. No. 11/770,734, filed on Jun. 29, 2007 entitled: Human Level Artificial Intelligence Software Application for Machine & Computer Based Program Function, which is a Continuation-in-Part application of U.S. Ser. No. 11/744,767, filed on May 4, 2007 entitled: Human Level Artificial Intelligence Software Application for Machine & Computer Based Program Function, which claims the benefit of U.S. Provisional Application No. 60/909,437, filed on Mar. 31, 2007.

### STATEMENT REGARDING FEDERALLY SPONSORED RESEARCH OR DEVELOPMENT

(Not applicable)

### BACKGROUND OF THE INVENTION

1. Field of the Invention

This invention relates generally to the field of artificial intelligence. Moreover it pertains specifically to human artificial intelligence for machines and computer-based software to predict the future or past with pinpoint accuracy.

2. Description of Related Art

Current AI prediction programs are used in 2-player games such as chess, checkers and tic-tac-toe. A more advance prediction program is used to play videogames. An even more advance prediction program is used to control a human robot.

The best way to measure how intelligent an AI program is, isn't by using the Turing test, but by allowing that AI program to play videogames. There are many categories in videogames such as simulation, shooter, RPG, racing, adventure, strategy and sports. Each category comes with its own objectives and rules. By allowing the AI program to play different games we can test how intelligent it is on all cognitive levels.

For the most part all videogames have one objective: to past all the levels in the game in the quickest time possible. But, each videogame has its own objectives and rules. The rules and objective of a baseball game is totally different from the rules and objective of a plane simulation game. The purpose of the AI program is to identify the objectives and rules of a videogame and use reasoning and logic to play the game.

Some games for the Playstation 2 are so hard it would take a human adult to past all the levels. Games like Contra require the player to use pattern strategies to beat the levels. By trying the game and observing the patterns of enemies, the player can devise many strategies to beat the game. Other games like Zelda for the Nintendo Wii require the player to solve problems and use sophisticated logic to past each level. In fact, the game requires the player to understand the meaning to language and to understand common sense behavior. During your adventure in the game, the player will interact with certain characters and they will give you instructions to follow to accomplish each level.

Playing videogames require an AI program to have the intelligence at a human-level (basically solving the hardest problem facing Artificial Intelligence). In prior art, there is no AI program that can play “all” videogames for all game consoles (NES, Genesis, Playstation 3, X-box 360, PSP, Wii and so forth).

### SUMMARY OF THE INVENTION

The present invention, also known as the human artificial intelligence program acts like a human brain because it stores, retrieve, and modify information similar to human beings. The function of the HAI program is to predict the future using data from memory. For example, human beings can answer questions because they can predict the future. They can anticipate what will eventually happen during an event based on events they learned in the past.

The human artificial intelligence program comprises: an artificial intelligent computer program repeats itself in a single for-loop to receive information, calculate an optimal pathway from memory, and taking action; a 3-D storage area to store all data received by said artificial intelligent program; and a long-term memory used by said artificial intelligent program.

The main for-loop in said artificial intelligent program comprises the steps of: entering said for-loop; receiving input from the environment in a frame by frame format or movie sequence called the current pathway; using the image processor and other functions to generate an initial encapsulated tree for said current pathway, searching for said current pathway in memory and finding the closest matches; calculating the future pathway of the matches found in memory and determining the optimal pathway to follow; generating an optimal encapsulated tree for said current pathway; storing said current pathway in the optimal pathway and self-organizing said current pathway with the data in a computer storage area called memory; following the future pathway of the optimal pathway, exiting said for-loop; and repeating said for-loop from the beginning.

This patent application will explore further two subject matters discussed in parent applications: future predictions and further discussion about conscious thoughts—most notably topics on forming complex intelligence in pathways.

The main purpose of pathways in memory is to create any form of intelligence. The pathways should contain patterns that will control the AI program to take action in an intelligent way. Patterns in pathways control the robot's body functions such as moving its arms and legs or searching/modifying/storing information in memory or thinking consciously of intelligent ways to solve problems.

The pathways in memory can form for-loops, while-loops, if-then statements, and-statements, or-statements, assignment statements, sequence data, patterned data, random data, static data, hierarchical data and all the different combinations. The pathways are also able to form any type of computer program, including: databases, expert systems, genetic programs, and AI programs. Simple computer programs like a word processor or complex computer programs like the internet can form in pathways. The pathways can even form self-learning and self-accomplishing behavior to solve arbitrary problems.

As always patterns and meaning to sentences is the key to forming different types of intelligence. The robot gets its data from the environment (most notably from teachers). Teachers will teach the robot how to form these intelligent pathways. The robot will simply compare similar examples and average out pathways to find “patterns”.

This method will replace the old idea of manual insertion of rules and data into an artificial intelligence program. Most of the artificial intelligence subject matters are not used in the present invention, including: neural networks, language parsers, expert AI programs, rule-based systems, semantic models, Bayesians probability theories, genetic programming, agent programs, and recursive planning programs. The HAI program is a self-learning, self-awared, self-teaching, and self-modifying computer program that can play any videogame for any game console, drive a car, fly an airplane, build a house, write a book, start a business, cook, clean the floors or mow the lawn.

### BRIEF DESCRIPTION OF THE DRAWINGS

For a more complete understanding of the present invention and for further advantages thereof, reference is now made to the following Description of the Preferred Embodiments taken in conjunction with the accompanying Drawings in which:

FIG. 1 is a software diagram illustrating a program for human artificial intelligence according to an embodiment of the present invention.

FIGS. 2A-5B are diagrams depicting the robot's conscious thoughts.

FIGS. 6A-6E are diagrams depicting an example of using conscious thoughts to develop reasoning and deduction skills.

FIGS. 7-8 are flow diagrams depicting hierarchical element object activation and lengthening of pathways.

FIGS. 9A-12 are diagrams to demonstrate how patterns are found during the search function.

FIGS. 13A-16 are diagrams depicting a bootstrapping process to turn pathways from simple intelligence to complex intelligence.

FIGS. 17-18 are diagrams illustrating how sentences remind the robot in the future to do certain tasks.

FIGS. 19-21 are diagrams depicting conscious thoughts to play a videogame.

FIG. 22 is a diagram depicting a universal pathway to control any machine, robot, electronic device, computer software or intelligent entity to accomplish any task.

FIG. 23 is a diagram illustrating a universal pathway to control any machine, robot, electronic device, computer software or intelligent entity to move an object from a start location to a destination location.

FIGS. 24-25B are diagrams depicting self-organization of multiple hierarchical pathways in memory.

FIGS. 26-34 are diagrams depicting learning rules and objectives of a videogame.

FIGS. 35-39 are diagrams to demonstrate hierarchical intelligence to play the legend of Zelda for the Nintendo Wii.

FIG. 40 is a diagram to depict the structure of a fabricated future pathway.

FIGS. 41A-45B are diagrams depicting how linear and universal future pathways are fabricated.

FIGS. 46-52 are illustrations to demonstrate reconstruction of forgotten pathways and external reconstructive programs or ERP.

FIGS. 53A-53B are illustrations to demonstrate how the time machine can be used to predict future events that are impossible to predictable.

FIGS. 54A-55B are diagrams depicting how logic learning can be used to predict future events that are impossible to predict.

FIG. 56 is an illustration to demonstrate 3-dimensional movie sequences.

FIG. 57 is an illustration depicting the robot recalling past memories and analyzing past memories to create logic and intelligence.

FIGS. 58A-60B are diagrams depicting how the human artificial intelligence program can be used to drive a car.

FIGS. 61A-61E are diagrams depicting pathways to drive a car.

FIGS. 62-64 are diagrams depicting how the AI program finds patterns between sentences and instructions in pathways.

FIGS. 65A-65B are diagrams depicting a supervised pathway turning into an unsupervised pathway.

FIGS. 66-67B are diagrams depicting how the human artificial intelligence program can be applied to an operating system.

FIGS. 68A-68C are diagrams illustrating how distance of objects are learned.

FIGS. 69-70 are diagrams depicting how computer software can be created without any human programmers.

FIGS. 71-72 are diagrams depicting predicted future pathways stored hierarchically in a 3-dimensional grid.

FIG. 73 is a diagram depicting the steps a robot in the time machine must do to solve a problem.

FIGS. 74A-74C are diagrams depicting three data structures intelligent robots can use to predict the future efficiently.

FIGS. 75-76 are diagrams depicting alternative methods to predict the future actions of a human being.

### DESCRIPTION OF THE PREFERRED EMBODIMENTS

The present invention, also known as the human artificial intelligence program acts like a human brain because it stores, retrieve, and modify information similar to human beings. The function of the HAI program is to predict the future using data from memory.

Outline:

1. Overall AI program

2. Forming intelligent pathways to play videogames

3. Predicting the future for infinite possible outcomes

Forming intelligent pathways and future prediction have been explained in parent applications, this application serve as supplementary information. Detail or additional information is also provided about future prediction and forming intelligent pathways in the human artificial intelligence program.

Human beings build intelligent pathways from a bootstrapping process, wherein data in pathways are modified based on trial and error. Intelligent pathways merge together as the AI program learns more from school teachers and the environment. These intelligent pathways allow a human being to play a videogame, drive a car, fly an airplane, solve a math problem or run a business. In this patent application I will be using the legend of Zelda game for the Nintendo Wii to demonstrate how intelligent pathways can play a videogame.

Future prediction isn't easy when dealing with life because the possible outcomes of life are infinite. If robots want to predict the future for simple games like chess or checkers it's easy using the current AI methods. However, more complex situations with infinite possible outcomes will prove difficult. There are some future predictions that are so difficult that it would require information at the moment in order to predict. An addition problem for example, if a math teacher wants the robot to do an addition problem, then the robot has to predict what the equation will be. Predicting what the equation will look like is impossible because all the numbers in the equation can be anything. The robot will be able to predict the future steps of the addition problem only after identifying the equation. It is the purpose of the present invention to predict the future for pathways with infinite possible outcomes. In the case of the math problem, the robot will predict the addition problem before the equation is given. Instead of predicting what the addition problem will be, the robot will predict a strategy sequence to handle infinite addition problems.

Hopefully, this technology will lead to a robot or machine that can: predict the actions and words of a human being before the event occurs, predict the exact movements of objects (such as birds or water drops from a storm) before the event occurs, predict a hurricane 1 year in advance, predict a solution to cancer without doing any experiments or predict an optimal solution to a scientific problem.

Technologies that can be created from the human artificial intelligence program will range from: AI operating systems, AI search engines, AI cars, AI planes, AI TV, AI computers, AI sewing machines, AI motorcycles, AI lawnmowers, AI vacuum cleaners and so forth. Another interesting technology that can be created are “universal” drugs. If the HAI program is combined with nano-technology researchers can create biological engineered viruses. These biological engineered viruses can cure all existing human diseases and any future human diseases. This patent application and parent applications is to protect certain functions and processes of the human artificial intelligence program.

Overall AI Program

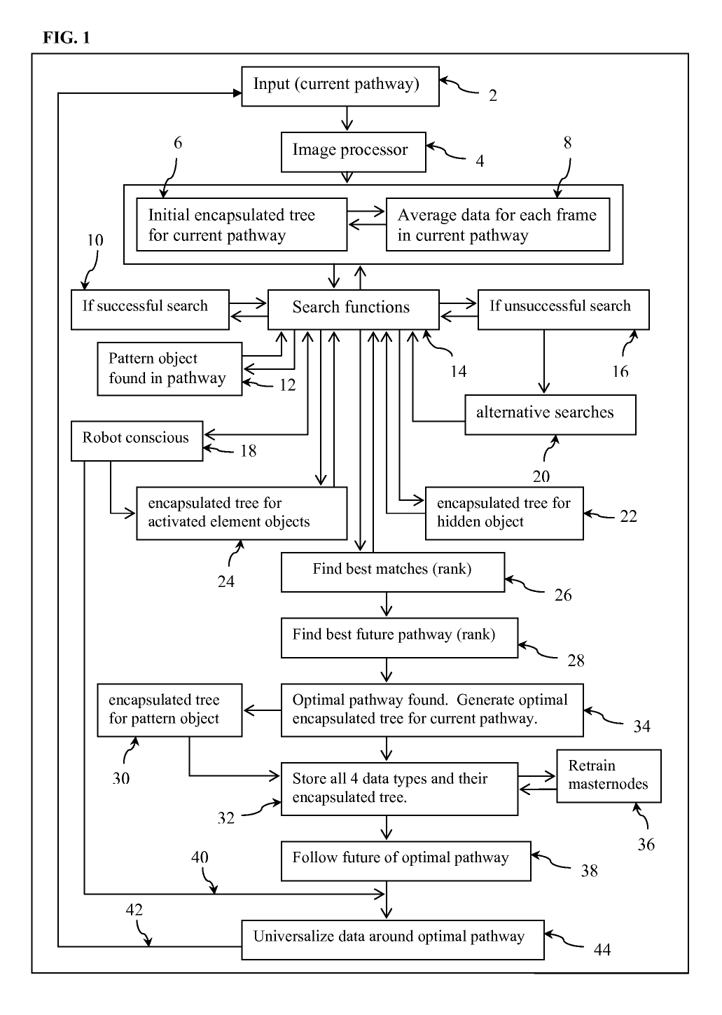

Referring to FIG. 1, the present invention is a method of creating human artificial intelligence in machines and computer based software applications, the method comprising:

an artificial intelligent computer program repeats itself in a single for-loop to receive information, calculate an optimal pathway from memory, and taking action; a 3-D storage area to store all data received by said artificial intelligent program; and a long-term memory used by said artificial intelligent program.

Said an AI program repeats itself in a single for-loop to receive information from the environment, calculating an optimal pathway from memory, and taking action. The steps in the for-loop comprises:

1. Receive input from the environment based on the 5 senses called the current pathway (block 2).

2. Use the image processor to dissect the current pathway into sections called partial data (also known as normalized visual objects). For visual objects, dissect data using 6 dissection functions: dissect image layers using previous optimal encapsulated trees, dissect image layers that are moving, dissect image layers that are partially moving, dissect image layers by calculating the 3-dimensional shape of all image layers in the movie sequence, dissect image layers using recursive color regions, and dissect image layers based on associated rules (block 4).

3. Generate an initial encapsulated tree for the current pathway and prepare visual object variations to be searched (block 6).

Average all data in initial encapsulated tree for the current pathway and determine the existence state of visual objects from sequential frames (block 8).

4. Execute two search functions to look for best pathway matches (block 14).

The first search function uses search points to match a visual object to a memory object. Uses breadth-first search because it searches for visual objects from the top-down and searches for all child visual objects before moving on to the next level.

The second search function uses guess points to match a memory object to a visual object. It uses depth-first search to find matches. From a visual object match in memory the search function will travel on the strongest-closest memory encapsulated connections to find possible memory objects. These memory objects will be used to match with possible visual objects in the initial encapsulated tree. This search function works backwards from the first search function.

The first search function will output general search areas for the second search function to search in. If the second search function deviates too far from the general search areas, the second search function will stop, backtrack and wait for more general search areas from the first search function.

The main purpose of the search function is to search for normalized visual objects separately and slowly converge on the current pathway (the current pathway is the root node in the initial encapsulated tree). All visual objects in the initial encapsulated tree must be matched. Search points and guess points call each other recursively so that top-levels of normalized visual objects will eventually be searched as well as bottom-levels of normalized visual objects.

5. Generate encapsulated trees for each new object created during runtime and include it in the initial encapsulated tree.

If visual object/s create a hidden object then generate encapsulated tree for said hidden object. Allocate search points in memory closest to the visual objects that created the hidden object (block 22).

If visual object/s activates element objects (or learned object) then generate encapsulated tree for said activated element objects. Search in memory closest to the visual object/s that activated the element object (block 24).

If pathways in memory contain patterns determine the desirability of pathway (block 12).

6. If matches are successful or within a success threshold, modify initial encapsulated tree by increasing the powerpoints and priority percent of visual object/s involved in successful search (block 10).

If matches are not found or difficult to find, try a new alternative visual object search and modify initial encapsulated tree by decreasing the powerpoints and priority percent of visual object/s involved in unsuccessful search. If alternative visual object search is a better match than the original visual object match modify initial encapsulated tree by deleting the original visual object/s and replacing it with said alternative visual object (block 16 and 20).

7. Objects recognized by the AI program are called target objects and element objects are objects in memory that have strong association to the target object. The AI program will collect all element objects from all target objects and determine which element objects to activate. All element objects will compete with one another to be activated and the strongest element object/s will be activated. These activated element objects will be in the form of words, sentences, images, or instructions to guide the AI program to do one of the following: provide meaning to language, solve problems, plan tasks, solve interruption of tasks, predict the future, think, or analyze a situation. The activated element object/s is also known as the robot's conscious (block 18 and pointer 40).

8. Rank all best pathway matches in memory and determine their best future pathways. A decreasing factorial is multiplied to each frame closest to the current state (block 26 and block 28).

9. Based on best pathway matches and best future pathways calculate an optimal pathway and generate an optimal encapsulated tree for the current pathway. All 5 sense objects, hidden objects, and activated element objects (learned objects) will construct new encapsulated trees based on the strongest permutation and combination groupings leading to the optimal pathway (block 34).

If the optimal pathway contains a pattern object, copy said pattern object to the current pathway and generate said pattern object's encapsulated tree and include it in the optimal encapsulated tree (block 30).

10. Store the current pathway and the optimal encapsulated tree (which contains 4 data types) in the optimal pathway (block 32).

Rank all objects and all of their encapsulated trees from the current pathway based on priority and locate their respective masternode to change and modify multiple copies of each object in memory (block 36).

11. Follow the future pathway of the optimal pathway (block 38).

12. Universalize data and find patterns in and around the optimal pathway. Bring data closer to one another and form object floaters. Find and compare similar pathways for any patterns. Group similar pathways together if patterns are found (block 44).

13. Repeat for-loop from the beginning (pointer 42)

The basic idea behind the AI program is to predict the future based on pathways in memory. The AI program will receive input from the environment based on 5 sense data called the current pathway. The image processor will break up the current pathway into pieces called partial data. The image processor also generates an initial encapsulated tree for the current pathway. Each partial data will be searched individually and all search points will communicate with each other on search results. Each search point will find better and better matches and converge on the current pathway until an exact pathway match is found or the entire network is searched. During the search process, visual objects will activate element objects (learned objects) or create hidden objects. Each new object created by the visual object/s will generate their respective encapsulated tree and included in the initial encapsulated tree. The optimal pathway is based on two criteria: the best pathway match and the best future pathway. After the search function is over and the AI program found the optimal pathway, the AI program will generate an optimal encapsulated tree for the current pathway. All 5 sense objects, all hidden objects, all activated element objects (or learned objects) and all pattern objects will recreate (or modify) encapsulated trees based on the strongest encapsulated permutation and combination groupings leading up to the optimal pathway. Next, the current pathway and its' optimal encapsulated tree will be stored near the optimal pathway. Then, the AI program follows the future instructions of the optimal pathway. Next, it will self-organize all data in and around the optimal pathway, compare similar pathways for any patterns and universal data around that area. Finally, the AI program repeats the function from the beginning.

The next couple of sections will emphasize on the robot's conscious and how the conscious is used to solve problems, plan tasks, predict the future and so forth. These sections are mentioned in detail in parent applications, but I will give a summary explanation so the readers can have a better understanding of how human intelligence is produced in a machine.

The human conscious works by the following steps:
1. The AI program receives 5 sense data from the environment.
2. Objects recognized by the AI program are called target objects and element objects are objects in memory that have strong association to the target object.
3. The AI program will collect all element objects from all target objects and determine which element objects to activate. Each target object might have multiple copies in memory so each target object will gather element objects from all or most same copies in memory.
4. All element objects will compete with one another to be activated and the strongest element object/s will be activated.
5. These activated element objects will be in the form of words, sentences, images, or instructions to guide the AI program to do one of the following: provide meaning to language, solve problems, plan tasks, solve interruption of tasks, predict the future, think, or analyze a situation.
6. The activated element object/s is also known as the robot's conscious.

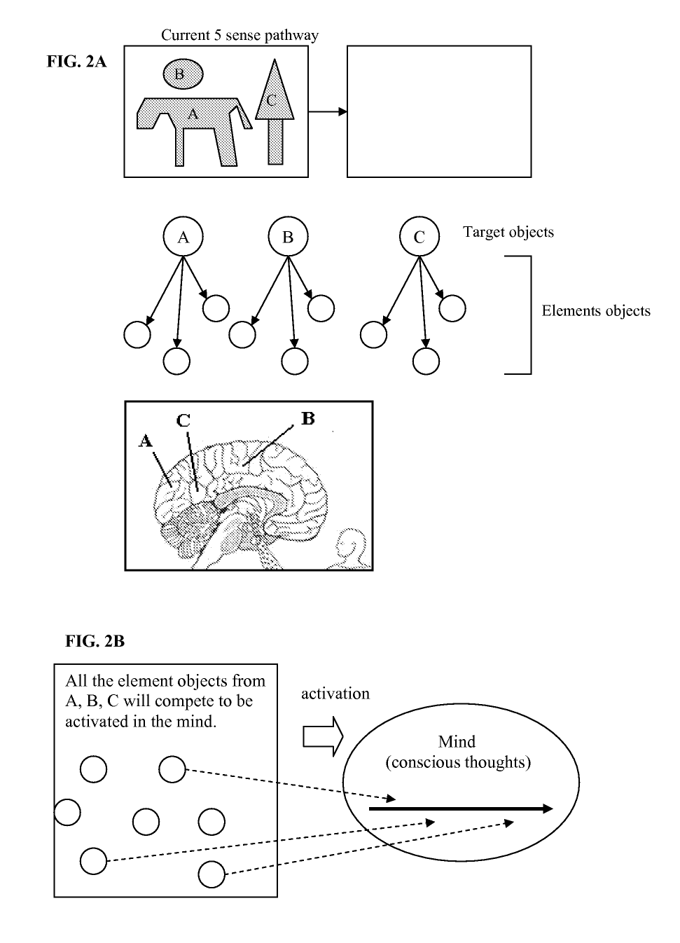

Referring to FIG. 2A, when the AI program locates the three visual objects: A, B, C in memory it will run electricity through these nodes and all of its connections.

The mind has a fixed timeline. Only one element object can be activated at a given time in this timeline. This is how we prevent too much information from being processed and allow the AI to focus on the things that it senses from the 5 senses (FIG. 2B).

Details of the Conscious

FIG. 3 shows a diagram of possible target objects. If target objects A, B and C are recognized the AI program has to also string the target objects into the strongest permutations and combinations (traveling on the strongest encapsulated connections). In this case, target object AB, BC, AC and ABC are also possible target objects. There element objects will be extracted and they will compete to be activated.

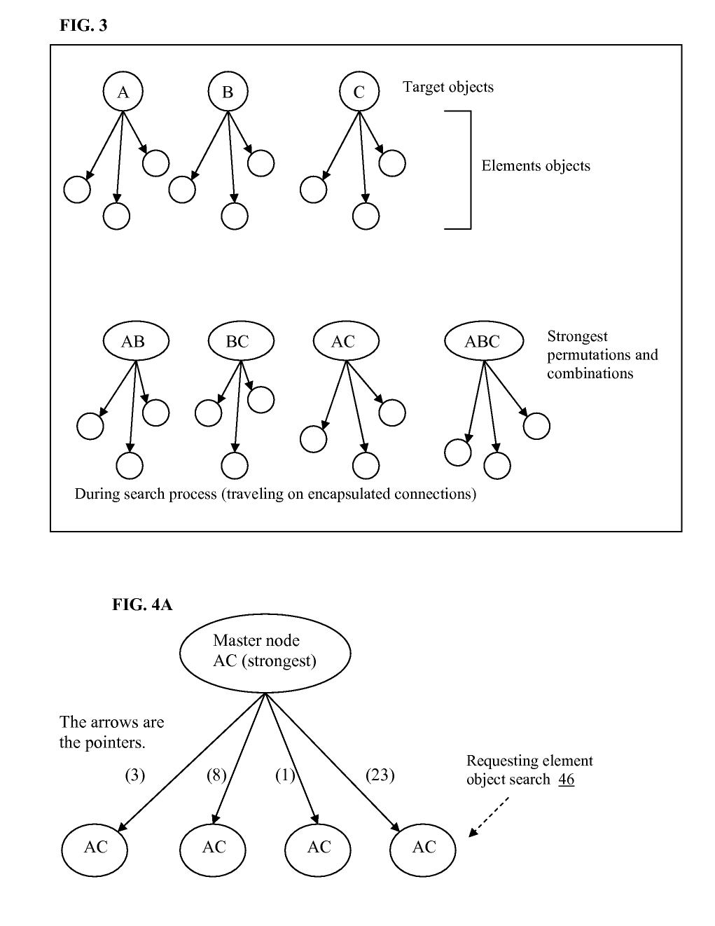

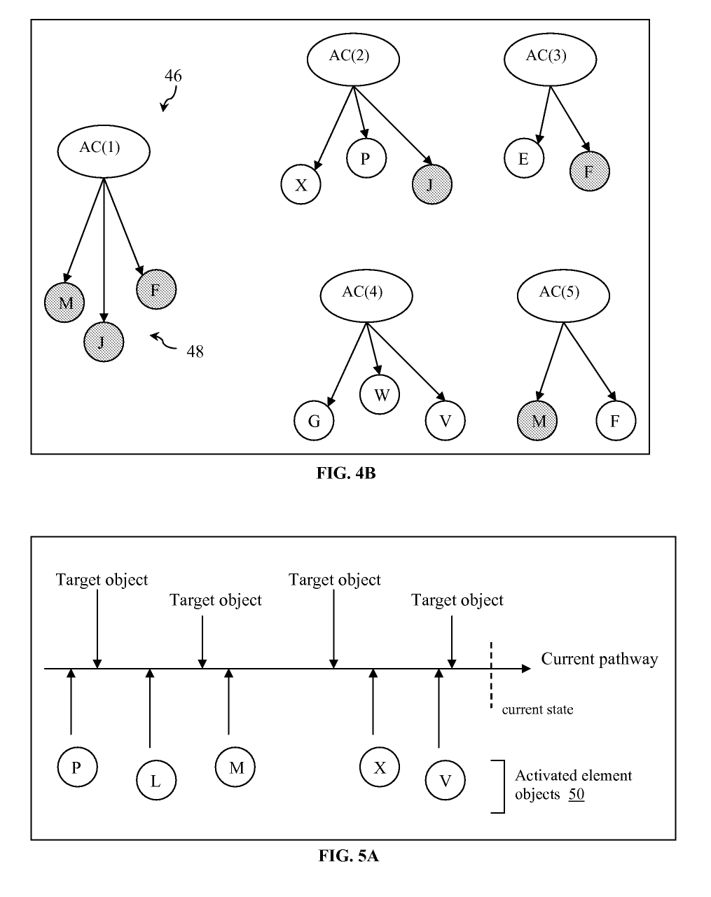

FIG. 4A depicts a target object AC (pointer 46). Each target object might have multiple copies in memory. The target object AC will send a signal to its masternode. The masternode is the copy of target object AC with the highest powerpoints. The masternode has pointers to all or most of the same (or similar) copies of AC in memory. All copies of the target object AC will extract its element objects and the priority of the element object will depend on the strength of the connection pointer and the strength of said element object.

In FIG. 4B target object AC (pointer 46) is gathering the strongest element objects from multiple same copies in memory. Intersection of element objects with different target objects is also considered. Three element objects were extracted from all copies of AC in memory: Element objects M, J and F (pointer 48). Element objects M, J and F will be competing with all the other element objects gathered from different target objects. The strongest element objects will be activated by the AI program.

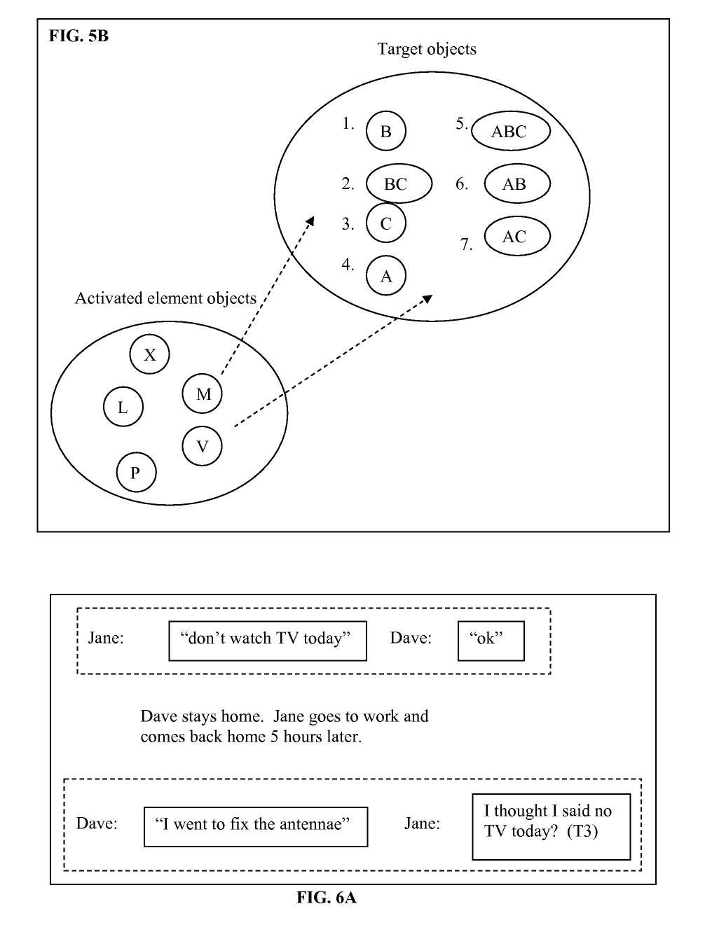

FIG. 5A shows an illustration of target objects and activated element objects (block 50). As the AI program recognizes target objects in memory it will activate element objects. If the target object and the activated element object are equal, then the activated element object is a learned object of the target object. The activated elements are P, L, M, X and V.

Referring to FIG. 5B, the activated element objects are then considered target objects with one fourth the strength of recognized target objects from the environment. A recursive loop or cascading affect will occur, wherein the target objects will activate element objects and these element objects will activate other element objects recursively. Logical thoughts and complex intelligence is based on this cascading affect.

This process is best illustrated by the chemical reactions in a real human brain. The human brain recognizes certain target objects from the environment in memory. The human brain runs chemical electricity to all target objects found in memory and these target objects propagate recursively throughout all related connections (both encapsulated connections and associated objects). During this process, the human brain decides which element objects in memory should be activated. The strongest element objects will be activated in the mind in a linear fashion.

The TV Problem

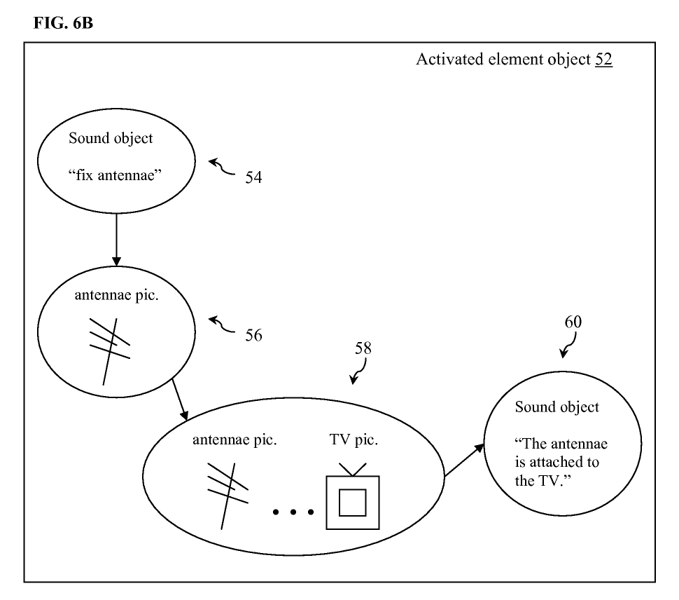

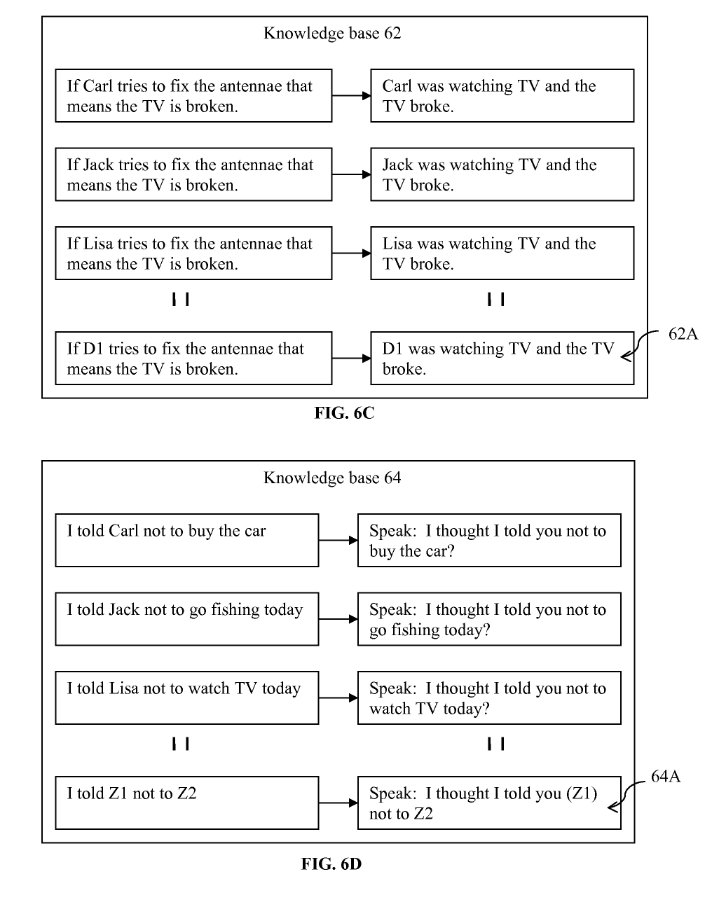

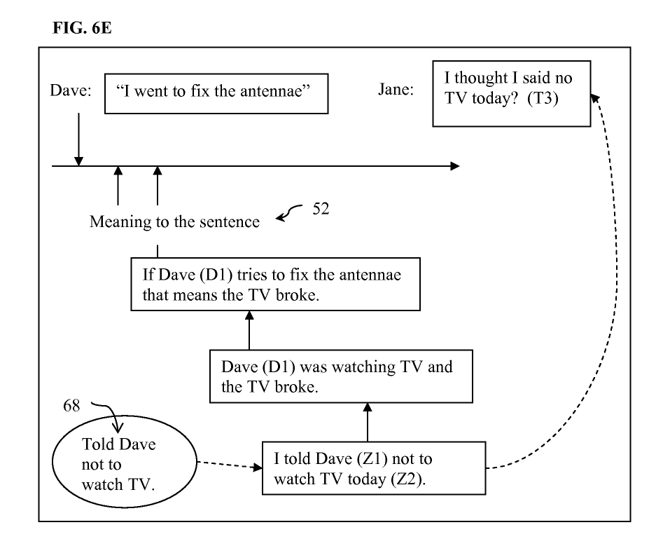

The next example illustrates how human conscious is used to create logic and reasoning. This example was taken out of a movie that I was watching. An idea popped up in my head when I was watching a scene where reasoning was needed to understand the situation. I did some reverse-engineering on how the logic was created and found out how reasoning happens in human beings. The diagrams in FIGS. 6A-6E demonstrate this form of logic.

In FIG. 6A the reasoning behind this situation is that Jane told Dave not to watch TV on that day. When Jane came home from work Dave said that he went to fix the antennae. The logic behind T3 is that Jane knows that the antennae is attached to the TV and that the TV must have been broken. The only way that the TV broke is if Dave was watching TV and something happened to it. The way that the AI program outputs the logic in T3 is by sentence association. The more times the robot learns knowledge about a situation the more likely that knowledge will be activated by the rules program. Knowledge could be any data in memory, most notably sentences or movie sequences that include sentences and words that have references to the movie sequence.

Meaning to a Sentence

In FIG. 6B and FIG. 6E, the meaning to the sentence “I went to fix the antennae” will activate in the current pathway (activated element object 52). As the sentence is recognized each word (sound objects) at a time, in sequence order, the AI program will assign certain words with the environment. The word “I” for example is assigned to Dave, the word “went” will activate a hidden object. The words “fix the antennae” will activate a movie of Dave on the roof with a screw driver trying to fix the antennae. Referring to FIG. 6B, the sound “fix antennae” 54 activated a picture 56 of an antennae. Then picture 56 activated a movie sequence 58 of an antennae. Upon analyzing the movie sequence 58, a TV picture in the movie sequence was recognized. The recognition of the antennae picture and the TV picture activated sound object 60 which is the sound: “the antennae is attached to the TV”. From there on a cascading affect occurs where all the activated element objects along with its original target objects will activate other element objects in memory.

Logical Thoughts

The knowledge from logic T3 is presented in FIG. 6C-6D. These strong sentences were activated by the rules program and it gave Jane the knowledge to come up with T3's logic.

The knowledge base 62 and 64 are lessons learned by teachers or by observation (FIG. 6C-6D). They are just a bunch of sentences and movie sequences that teach a person knowledge about a situation. The objects within these knowledge base are strong so when one object (first sentence) is recognized by the AI program the other object (second sentence) in the situation will activate.

In the example in FIG. 6E, the situation is set up when Jane told Dave not to watch TV on that day. Then 5 hours later Jane got off work and went home. When she got home Dave told her that he went to fix the antennae. The response she gave Dave comes from the logic above. That logic is: The meaning of the sentence: I went to fix the antennae activated (pointer 52). This meaning had strong association to knowledge base 62A which activated the first sentence: If Dave (D1) tries to fix the antennae that means the TV broke. Next, Jane activated the strongest association to the first sentence which is the second sentence: Dave (D1) was watching TV and the TV broke. Then Jane activated knowledge base 64A where a previous event 68 triggers knowledge base 64A. The decision to activate knowledge base 64A comes from a pattern to extract knowledge from the past, in this case extract the event where Jane told dave not to watch TV. The result is the conscious thought: I told Dave (Z1) not to watch TV today (Z2). The association that is attached to that is to say to Dave: “I thought I said no TV today”.

This example demonstrates reasoning in robots and how the conscious is used to create this reasoning. Although this is a relatively simple example, if you think about all the steps that are described above and combine that with fuzzy logic then you will understand how affective this form of reasoning is. The knowledge base can be represented through fuzzy logic, the steps of recognizing the objects from our environment can be done in fuzzy logic, and activating element objects can be done in fuzzy logic.

The knowledge base of the program can be as long as you want it too be. You can read an entire science book and all of that knowledge will group itself based on their strongest association. When that knowledge is recognized by the AI program the strongest knowledge attached to it will activate. The knowledge base isn't just text words and sentences, but visual images, taste, touch, movie sequences, hidden data or patterns—the 4 different data types.

Hierarchical Activation of Element Objects

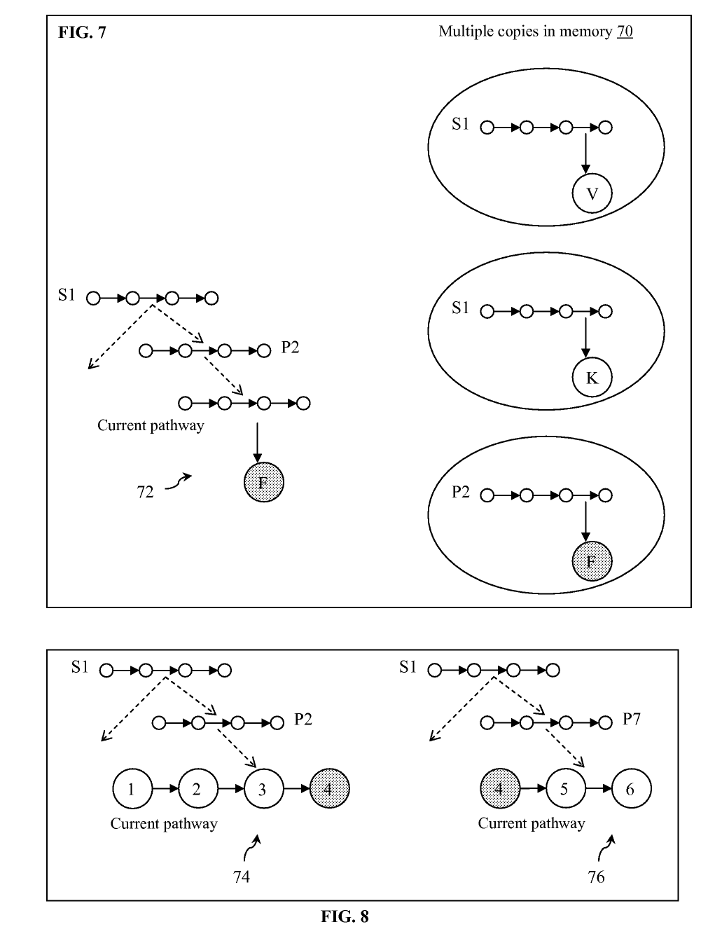

Referring to FIG. 7, activated element objects are copied to the current pathway and it contains the strongest associational objects with data in the current pathway. Entire objects, actions or situations can be copied by words and sentences. Instead of copying the entire situation it can use sentences as a “marker” to mark the beginning of a situation. This marker can be used to find similar situations in memory. The marker (represented by words or sentences) will indicate where to begin copying a situation into the current pathway. Only specific situations will be copied to the current pathway and not all situations for that marker. For example, pathway S1 and P2 use sentences to indicate the beginning of the pathway. The AI program will extract element objects from multiple copies of S1 and P2 and all element objects will compete with one another to be activated in memory (pointer 70).

S1=How do I accomplish goal?
P2=How do I beat this boss?
Current pathway=How do I beat the snake boss in Zelda?

S1 is an intelligent pathway that will solve a problem. P2 is another intelligent pathway to solve a more specific problem derived from S1. The current pathway is a pathway that is stored in the optimal pathway (pointer 72) in memory.

There are multiple copies of S1 and P2 in memory. The AI program has to activate the best element object for that situation. Activated element object F (pointer 72) shows that element object F from a different copy of P2 in memory has been chosen.

(P2) How do I beat this boss? (F) Shoot the red circle on his head.

Activated element object F is just one answer to the question “How do I beat this boss?”. One given pathway P2 can have hundreds of possible answers. Multiple copies of P2 can have same or different answers. This is why the AI program has to collect hierarchical pathways from the current pathway and choose the best activated element objects. Below are just some of the questions and answers for pathway S1 and P2:

| | |
|---|---|
| (S1) How do I accomplish goal? | Analyze the situation and come |
| | up with a plan. |
| (S1) How do I accomplish goal? | Use a strategy that will achieve the |
| | goal. |
| (S1) How do I accomplish goal? | Read the rules first and set up a plan. |
| (S1) How do I accomplish goal? | Work backwards to achieve goal. |
| (P2) How do I beat this boss? | (F) Shoot the red circle on his head. |
| (P2) How do I beat this boss? | Jump over his bullets. |
| (P2) How do I beat this boss? | Go under his jump and fire at him |
| | when he lands. |
| (P2) How do I beat this boss? | Read the game magazine for strategies. |

Pathway S1 and P2 is marked with a sentence and the answer to the question is just one data in that pathway. The answer to the question can be a sequence event and not just one answer.

In this case, the current pathway picked element object F from a different copy of P2 in memory. This specific way of beating the boss will be copied into the current pathway. Also, the activated element object F depends on the current situation such as what kinds of media is being used. In this case, it's a videogame. What kind of boss is this and is there a strategy in memory to defeat this boss? All these factors are included to activate the right element objects. If there exist a boss that the AI program is totally unfamiliar with and it has no idea how to beat this boss, it will activate element objects in its hierarchical tree. For example, it might activate something like: “Analyze the situation and come up with a plan”. This is a broader way of achieving the goal.

“All” words and sentences are represented by fuzzy logic. The question can be said in a different way but they mean the same things. For example, the question, “How do I accomplish goal” is the same or similar as “How can I achieve this task”. Logical meaning can also be included such as the Q&A:

| | |
|---|---|
| how do I accomplish goal? | Plan . . . |
| how do I accomplish goal? | Come up with strategies and make a detailed |
| | plan. |

The first Q&A has a short answer, but it has the same logical idea as the answer in the second Q&A.

Jumping to Other Pathways in Memory

Either the AI program will cut and paste data from various areas in memory to the current pathway (the last section) or the current pathway will jump to another similar copy in memory. For example, the AI program was following hierarchical tree 74 then it jumped to hierarchical tree 76 (FIG. 8). The AI program found it more efficient if it jumped to another location to store the current pathway. Both locations will have a residue of where it jumped from and where it jumped to so that the length of pathways can grow. Current pathway 74 decides to jump to another hierarchical tree in memory and current pathway 76 is stored there. Frame 4 from current pathway 74 and 76 is the residue template.

Pattern finding—looking for patterns from multiple copies in memory and looking for patterns from each copies hierarchical tree.

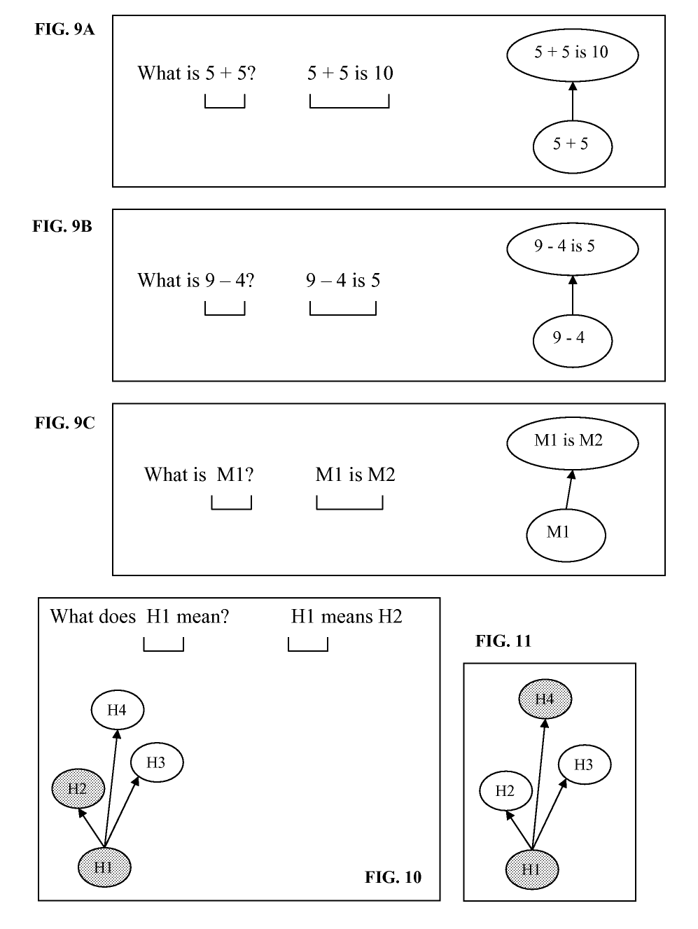

In order to answer a question the AI program has to find the patterns first. This section will discuss the various ways that the AI program will find patterns during the search function. Below are very similar Q and A examples. FIG. 9C is a diagram depicting a universal pattern for FIGS. 9A-B.

| | |
|---|---|
| What is 5 + 5? | 5 + 5 is 10 |
| What is 9 − 4? | 9 − 4 is 5 |
| What is the first letter in the alphabets? | the first letter in the alphabets |
| | is A |
| What is the name of the first president | The first president of the USA is |
| of the USA? | George Washington. |

More Advance Examples

The examples below show the meaning to a word. Meaning to a target object is the strongest associated object. This strong associated object can be anything: a visual picture, a movie sequence, sound words, a touch object or a hidden object.

What does evaluation mean? Evaluation means—
What does obsolete gate mean? Obsolete gate means?—
What does H1 mean? H1 means H2

Referring to FIG. 10, the pattern is that H1 is the target object. When H1 is found in memory then H2 is the closest object to H1. This pattern is used to find the meaning to a word or sentence. For example, if H1 represent the sound word “evaluation” then H2 can be the meaning such as the sound sentence: “when someone examines something” or it can be a movie sequence of someone looking at a piece of paper. The pattern is simply to take the strongest associated object (H2) from the target object (H1). The question and answer also has a pattern. The answer in FIG. 10 is constructed by filling in H1 and H2 in the sentence. The result is:

What does evaluation mean? Evaluation means when someone examines something.
What does H1 mean? H1 means H2

Referring to FIG. 11, another example is determining similar meaning to a word. For example if the QandA is:

Is there a similar meaning to evaluation? A similar meaning to evaluation is when someone checks something.

Is there a similar meaning to H1? A similar meaning to H1 is H4

In this example, the question and answer: Is there a similar meaning to H1? A similar meaning to H1 is H4, has a pattern. The pattern is that H4 is a meaning to H1, but isn't the strongest meaning to H1. The strength of element objects and the distance of element objects will be used to find patterns in pathways (especially for Q and A's). The type of media of the element objects is also a factor (sound, touch, visual movie, etc).

Sometimes logic is needed to answer a question and isn't very apparent in the question and answer sequence. This is why the AI program has to find patterns related to target objects and their respective element objects. Each target object will extract all or most of its element objects from multiple copies of itself in memory. The AI program will put target objects into the strongest permutations and combinations and the comparing of the strongest target objects will be compared to the strongest element objects (the strongest element objects are usually the activated element objects). This process is done during the search process when the AI program has to search for multiple copies of each target object (or combination of target objects) in memory.

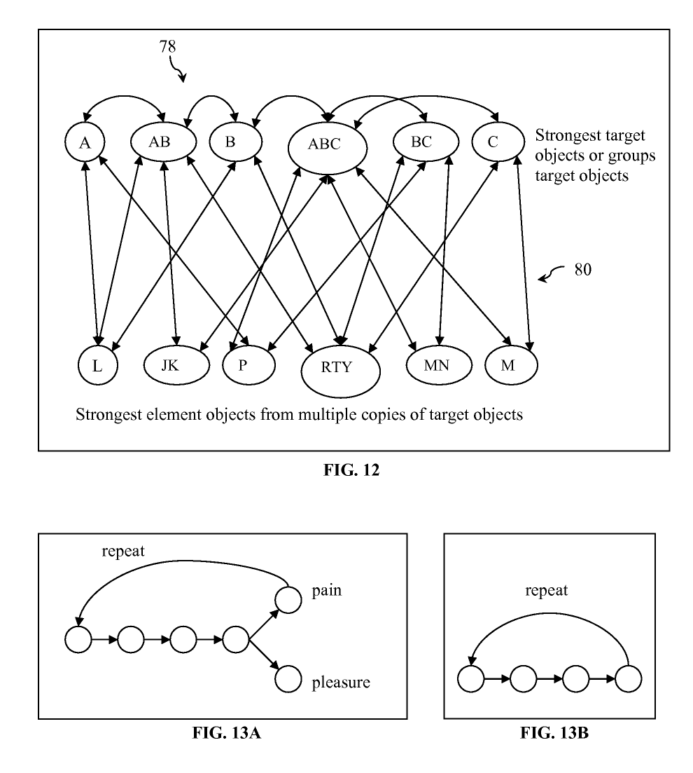

Referring to FIG. 12, The strongest target objects or groups of target objects are at the top and the strongest element objects from multiple copies of the target object are located at the bottom. Pattern finding will be done by comparing lateral patterns 78 or associated patterns 80. Lateral patterns are done by comparing target objects with one another to find if there are patterns in future sequences. The questions and answers example, what is 5+5? 5+5 is 10, show there are patterns between past data (question) and future data (answer). For associated patterns 80, the AI program will see if there are patterns between the current pathway (target objects) and element objects for each target object. Are there data in memory that have relations with certain target objects in the current pathway? Answering questions and logical thought will greatly depend on patterns found between associated objects.

To complicate the AI program even more, the element objects will go through a cascading (or recursive) loop. The activated element objects will be considered target objects and the AI program has to search for element objects for each activated element object. The activated element objects will have one fourth the strength of recognized target objects. During this “cascading” process the AI program will be comparing and analyzing for any patterns. If a pattern is found then the AI program will generate a pattern object and store it in its respective pathway. Referring to FIG. 6E, this diagram shows how activated element objects recursively loops itself to come up with logical thoughts.

Adaptive Intelligence

Pathways in memory can form any type of intelligence including adaptive behavior that will self-modify pathways to achieve goals. As mentioned before, human beings use a form of bootstrapping process to build pathways on prior existing knowledge.

When the robot is at its early stages of life, it will have to build its pathways from simple data then as it gets older and there are more data in memory it will organize the pathways into complex intelligence. Just like how we humans have to learn to walk, to talk, to move, to eat, these machines have to go through life the same way. Let's illustrate the gradual forming of simple data into intelligent data by outlining a series of stages.

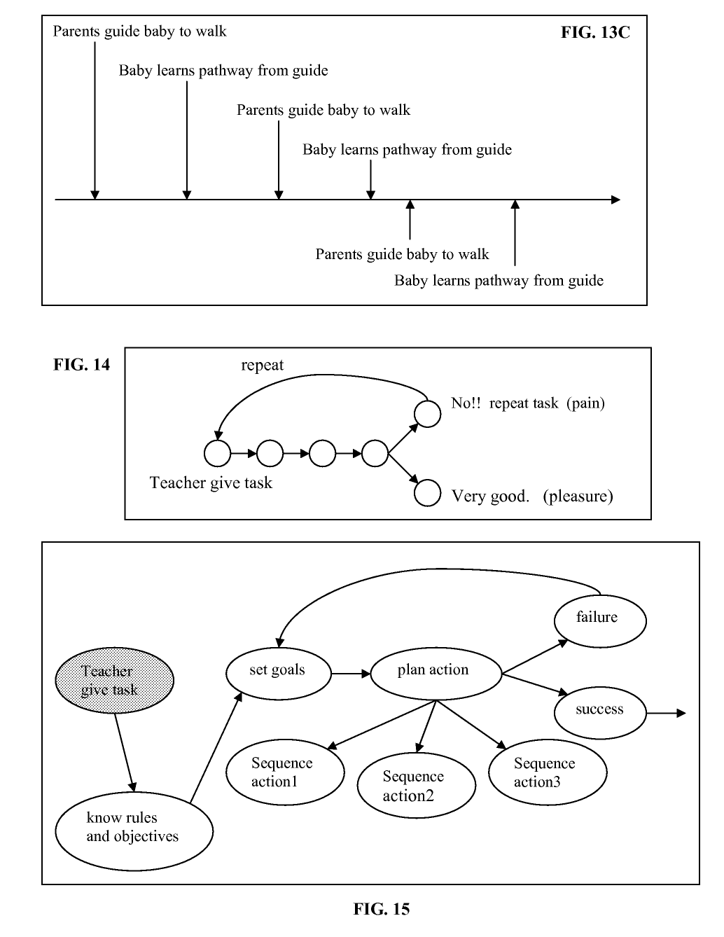

Two types of learning are required: (1) supervised learning, (2) unsupervised learning. Human babies use supervised learning. For example, parents will guide a baby to walk, or parents will guide the baby to talk, or parents will guide the baby to write letters. Things like walking, talking and writing are not something that can be preprogrammed into the robot. These things need a guide in order to force the robot to create pathways in memory to walk or to talk or to write. FIG. 13C is a diagram depicting how a parent help guide a baby to walk. As you can see, there is a loop that is recurring in the pathway. FIG. 13A-B depicts pathways that loop itself. The robot will create this simple loop in memory. Knowledge will build on the loop to include pain and pleasure. For example, if the robot walks and falls down, the pain will help it to walk a different way in the future. On the other hand, if the robot (baby robot) sees food, it might use the walking pathway to get itself from its present location to the food. The food serves as a reward for successfully walking in a correct manner from one location to the next.

Referring to FIG. 14, as the robot gets older and has the ability to understand a basic grammar the parent can use sentence commands to force the robot to do tasks. If the robot doesn't do the task correctly the parent can give the same command again. This forces the robot to build loops in pathways. Also, harsh words such as “No” will automatically produce pain in the robot because the word “No” is a word that is associated with pain. If the robot accomplishes a task correctly then the sound of certain words give the robot a sense of pleasure (words such as “very good”). The words “very good” can also indicate to the robot that the task is completed and there is no need for the robot to repeat the task.

Referring to FIG. 15, the intelligence of pathways in memory is primarily based on the lessons learned in school. This diagram depicts a pathway that is capable of following a command, learning the rules and objective of the task, setting goals, planning action/s and taking action. This pathway is considered supervised because the robot is still taking commands from a teacher.

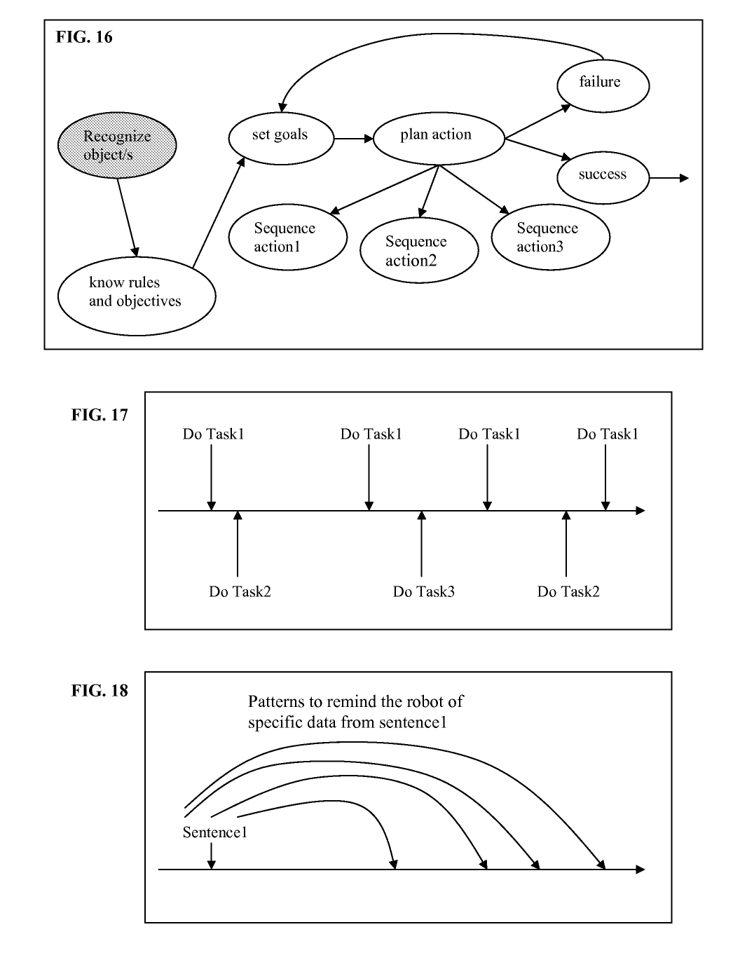

FIG. 16 depicts a diagram showing an unsupervised pathway. The robot, upon recognizing certain objects from the environment, will automatically do things in a logical manner. For example, if the robot is in a doctor's office and the clerk hands a form to the robot, it will know consciously that the clerk wants the robot to fill in the form. It doesn't need a teacher to give the robot a command to fill in the form, it does this automatically.

Simple Adaptive Intelligence (FIG. 13A)

Learning Adaptive Intelligence (FIGS. 13B-C)

Managing Multiple Tasks at the Same Time

(1). Language in the Form of Words or Sentences can Manage Multiple Tasks at Once

Sentence: “Drive home to Kaneohe and at the same time buy groceries and drop this package at the post office”. The sentence command has 3 tasks: drive home, buy groceries and drop of a package at the post office. This one sentence is all that is needed to encapsulate all the task the robot needs to do.

The robot should be intelligent to include other logical thoughts in addition to the sentence command. These logical thoughts will include: prioritizing tasks, finding out if each task is even possible to achieve, determining which tasks should go first or last and aborting a task if the robot finds the task trivial.

If the robot already had 2 tasks it wanted to accomplish, then the three new tasks will merge with the previous 2 tasks. The previous two tasks the robot plan to do are: drive home to Kaneohe and buy a lawnmower from Sears. The logical thought after merging the new tasks and old tasks is: I got too many tasks to do, I will buy the lawnmower from Sears tomorrow. This means the robot, using logic, has abandoned one of its tasks. It has also prioritized the tasks so that it knows what tasks go first and what tasks go last.

(2). The second way of managing multiple tasks is to use patterns. The AI program was following one pathway and then it jumped to another pathway then it jumped back to the previous pathway.

(3). The third way to manage multiple tasks is to combine the first and second method together. By using sentences (or events) and combining that with patterns the AI program will be able to create intelligent pathways that will manage multiple tasks. It's like creating intelligent computer programs into pathways in memory to self-manage tasks, which includes: identifying tasks, managing multiple tasks; prioritizing tasks; determining if each tasks is achievable; aborting, modifying or adding new tasks based on logic, or determining which tasks go first, second and last.

How does the robot actually manage multiple tasks?

The human robot actually thinks like a human being. Intelligent pathways will use patterns that will remind the robot what tasks to do at certain times (activating words or sentences in future pathways). Referring to FIG. 17, tasks are prioritized. Task1 is very important so the robot is reminded of the task frequently (4 times). Task2 is the second important task, so it is reminded often enough (2 times). Task3 is not important so the robot reminds itself once in a while (1 time).

Patterns can also help in organizing tasks sequentially. For example, if the first task is done then the AI program will be reminded of the second task. When the second task is done then the AI program will be reminded of the third task. Since these are tasks that are happening at the same time, being reminded frequently would be a good way to remember the tasks. (By the way, remembering things is actually a learned thing)

Tasks can also be reminded at specific times. For example, the task: “when you get home call me”, reminds the robot only when it gets home. When it recognizes its' house, the task: “call me” pops up in the robots mind (FIG. 18).

These are just some of the ways that multiple tasks can be managed. Because human robots don't operate like conventional computers, they can't insert thousands of fixed commands and expect all these fixed commands to be followed. It can only manage a limited amount of tasks at a given time. This also means that tasks can be forgotten or misinterpreted.

Complex Intelligence

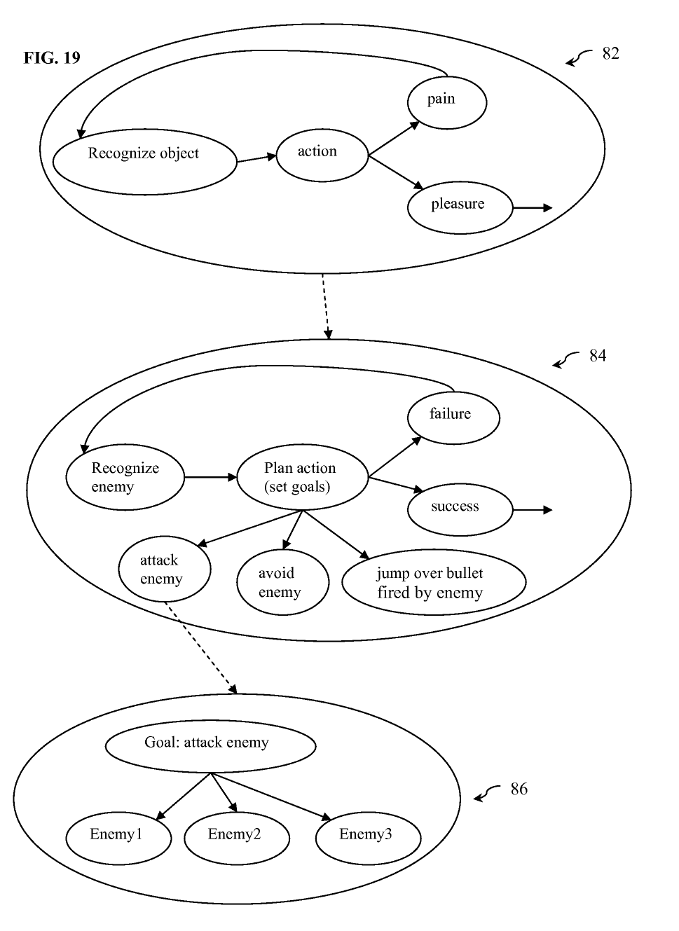

When the pathways in memory gets more complex the intelligence can be used for more complex tasks such as driving a car or playing a videogame. The pathways are also arranged in a hierarchical manner, wherein pathways inherit intelligence in its upper levels. FIG. 19 is a hierarchical tree that depicts how intelligent pathways are encapsulated. Pointer 82 is a simple adaptive pathway that can be catered to many tasks. Pointer 84 is an adaptive pathway used specifically for videogames. Pointer 86 is a pathway to attack different types of enemies in a videogame.

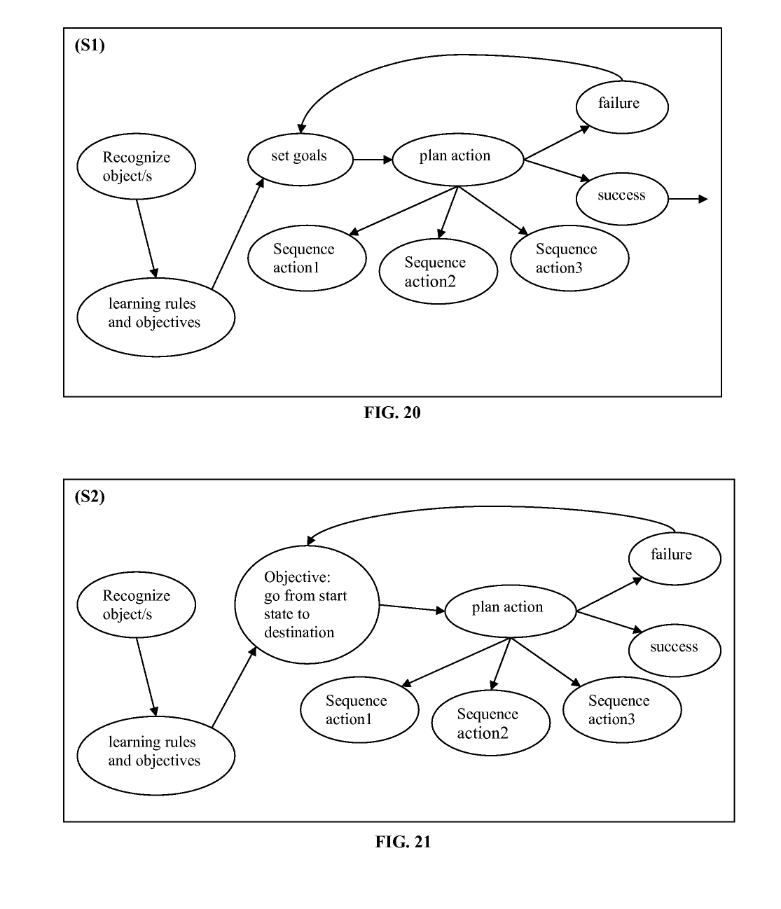

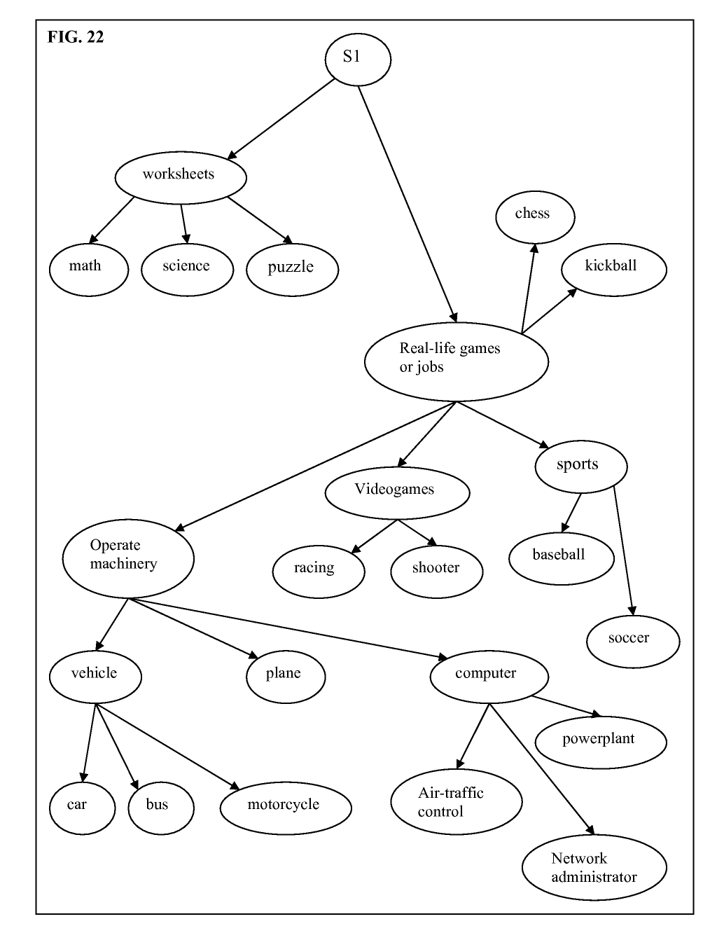

Just like object-oriented programming, objects in the hierarchical tree inherit data from its parent objects. Objects in this case are pathways. To get a better idea of inheritance, FIG. 20 is an illustration of a pathway S1 that serves as a universal adaptive pathway for any type of task or tasks. FIG. 22 is a hierarchical data structure of how pathway S1 can be applied to many tasks. Pathways S1 can be applied to worksheets, operating machinery, playing videogames, driving a car, flying an airplane or playing a real-life baseball game.

Each type of task is learned by the robot from lessons in school. Teachers teach the robot through examples and the robot has to store all the lessons in memory. These lessons will self-organize itself based on common traits with other lessons in memory. Different types of worksheets should be stored close to each other. A worksheet for math might be similar to a worksheet for science. Driving a car might be similar to driving a bus. Playing a driving videogame might be similar to driving a real car. Operating a computer might be similar to working as a network administrator. The lessons from school will be stored in pathways in memory; and each pathway will self-organize itself in an associational-hierarchical manner.

A pathway to move a robot from one location to a destination location (S2)

Current AI cars use GPS to navigate itself from a current location to a destination location. AI vacuum cleaners also use this type of technology to get itself from the current location to a destination location. This technology uses hybrid AI programs to: set a target destination, plan a route to the target destination, and execute the plan. During the robot's journey it will use various expert programs to navigate through obstacles such as maneuvering around rocks, avoiding dangerous terrains, following the rules of traffic lights and avoiding pedestrians.

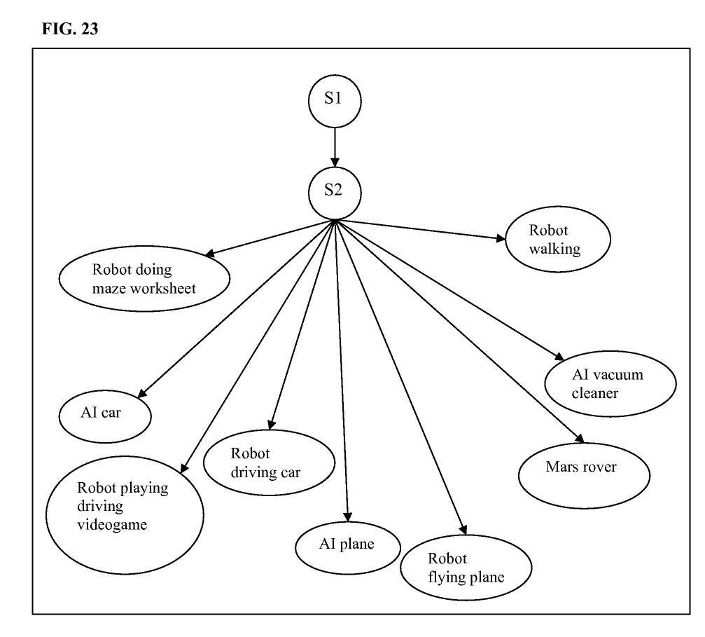

FIG. 21 is an illustration of an intelligent pathway known as S2 to move a machine from the current location to a destination location. The type of machine can be anything or the type of media of the task can be anything. The machine can be a human robot or an AI car, or an AI vacuum cleaner or the Mars Rover. Referring to FIG. 23, the media of the task can be anything as well. For example, a human robot can walk from a current location to a destination location or a human robot could be playing a videogame trying to get the character in the game to walk from a current location to a destination location. Another example would be the robot has to do a worksheet to solve a maze by moving a mouse from a current location to the destination location by drawing connected lines. Despite the different media of a task and the different types of machine used, pathway S2 is a universal pathway designed to solve the problem of getting an object from a current location to a destination location.

Multiple copies of S1 and its hierarchical tree in memory

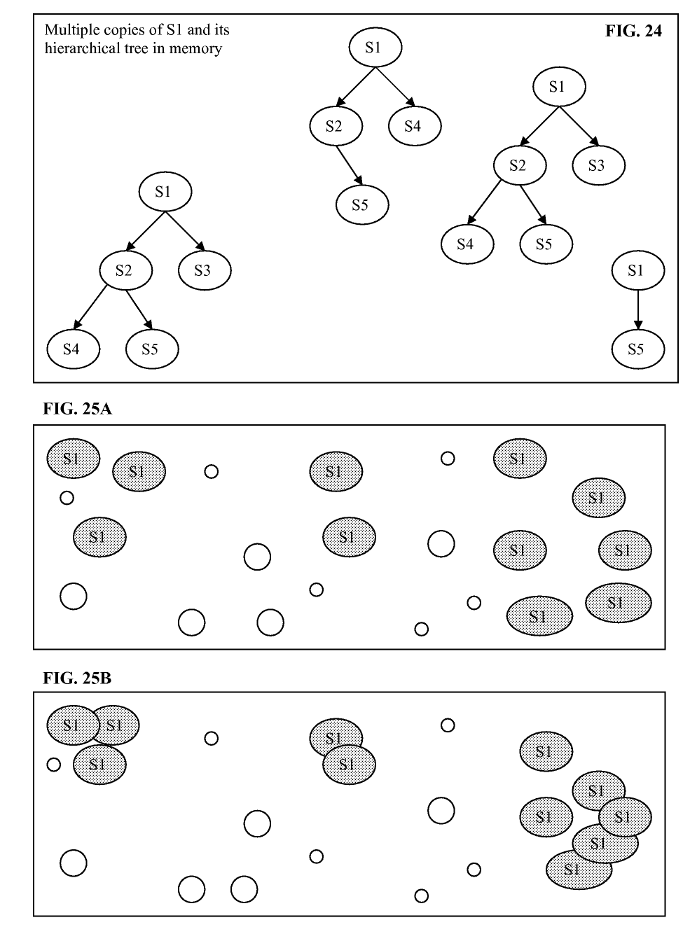

Referring to FIG. 24, pathway S1 will create a hierarchical tree based on intelligent lessons in school. Pathway S1 isn't just one pathway in memory there are hundreds of copies of S1 in memory. Each copy has a hierarchical tree that contains same, similar or different data. On one copy of S1 there might be pathways to drive a car and play a shooting game, while another copy of S1 in memory might be pathways to play a sports game, drive a truck or drive a car.

FIG. 25A-25B illustrates how multiple copies of S1 and its hierarchical trees will merge together based on self-organization. Closely stored copies of S1 will merge together based on commonality groups and learned groups. FIG. 25A shows how multiple copies of S1 are stored in memory without self-organization. In FIG. 25B closely located copies of S1 will merge together creating universal pathways. Self-organization is needed to structure hierarchical trees (or pathways) in an associational manner and also prevent repeated data from being stored in memory.

Learning Rules and Following Rules

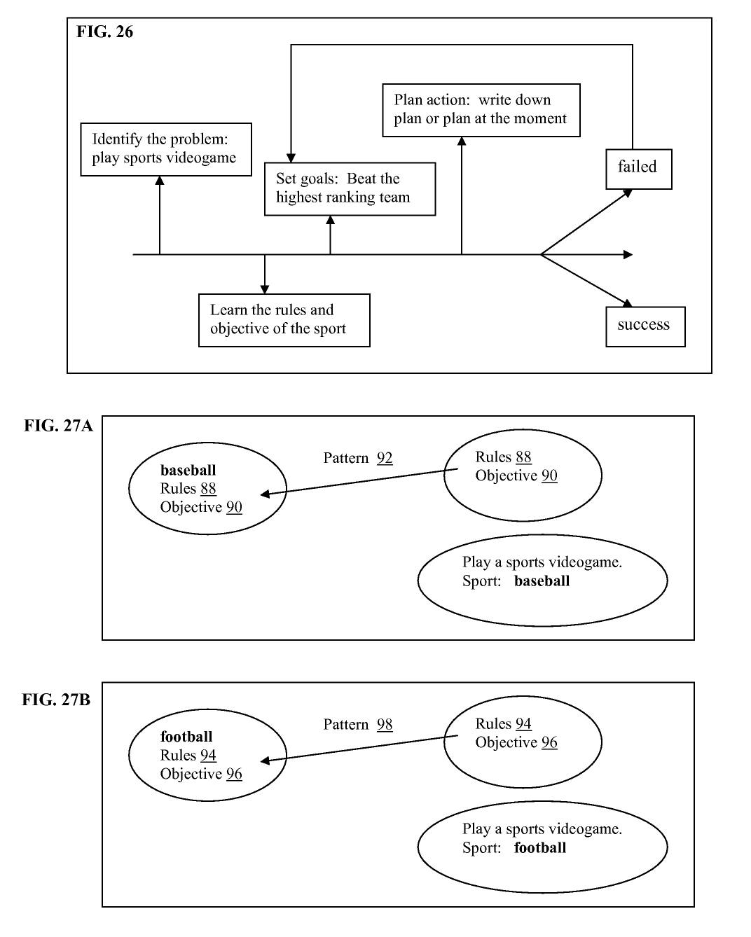

If pathway S1 is applied to a sports videogame then the diagram will look like FIG. 26. The problem is identified as: play sports videogame. Then, the next step is learning the rules and objective of the sport. Next, the robot has to set a goal, which is to beat the highest ranking team. Then, it has to plan out a strategy to beat the game. It will either write down a plan or plan at the moment. Finally, it takes action by trying an action. If it fails then it will repeat the goal. If it succeeds and achieves the goal then it will move on to another goal. Be aware that within one goal are other sub-goals and within sub-goals are other sub-sub goals.

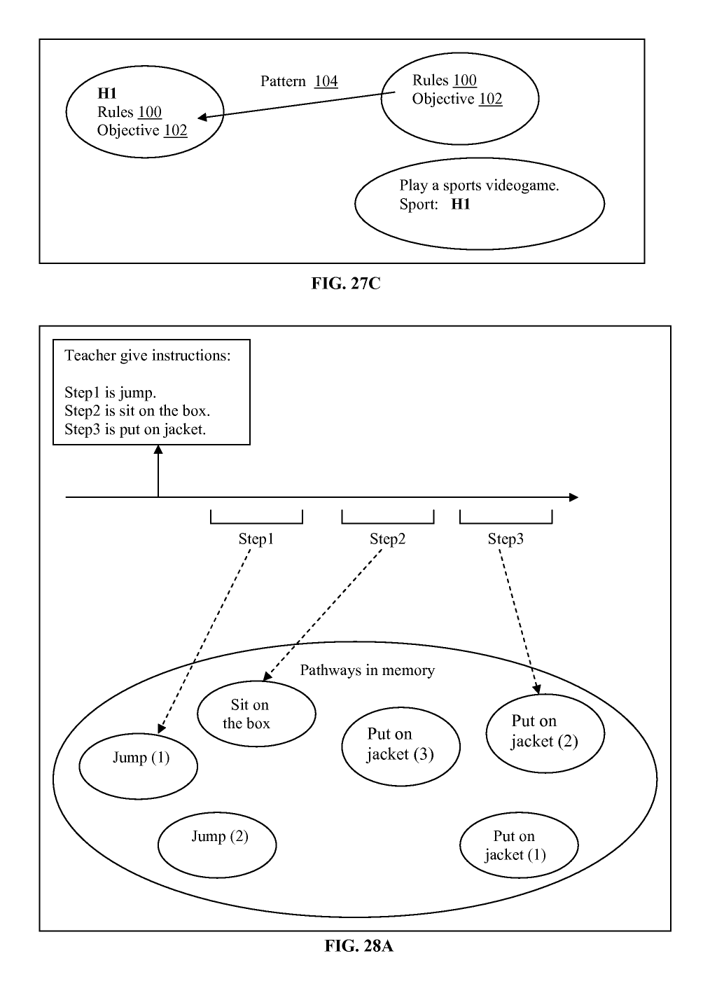

Patterns can establish a connection to rules and objectives from different areas in memory. Rules and objectives of a real sports game can be used in the same sports videogame. For example, if the robot learns the rules and objectives of a real baseball game, then it doesn't have to re-learn the rules and objectives of a baseball game in the videogame. Patterns will link the rules of the real baseball game to the baseball game in a videogame. Referring to FIG. 27A, patterns will establish the connection pointer 92 to the storage of the rules and objectives of a real baseball game. In this case, the robot learned the rules 88 and objectives 90 of a real baseball game. Rules 88 and objectives 90 will be referenced from the baseball videogame. This way the robot doesn't have to re-learn the rules and objectives of a baseball game.

On the other hand, the rules and objectives of a real baseball game and a baseball videogame are slightly different because in a real baseball game the robot has to use his body to play the sport. In a videogame the control pad is used to play the game. There should be an intelligent pathway added to adapt the game from a real baseball game to a baseball videogame.

Referring to FIG. 27B, the same method is used for a football game. Pattern 98 is used to reference the rules and objectives of a real football game. The robot has learned the rules and objectives from a real football game. When the robot plays a football videogame the rules 94 and objectives 96 will be referenced from the real football game.

The patterns are found by the activated element objects (discussed earlier). The AI program recognizes target objects from the environment and it searches for multiple copies of each target object in memory. During this process the AI program is also finding patterns. Since a real football game and a football videogame share football as their common traits, then the AI program will find patterns between their common traits. After many similar pathways a pattern is found.

If the AI program averages out all sports games from similar pathways, then a universal pathway will occur. FIG. 27C is a diagram of a universal pathway that will link the rules of a real sport game to the same sport videogame. Variable H1 will represent a sport. The rules 100 and objective 102 are referenced by pattern 104. This pathway can be used for all sports including: golf, baseball, football, soccer, basketball, hockey, track and field, surfing or racing.

Patterns can transport entire instructions from different areas in memory.

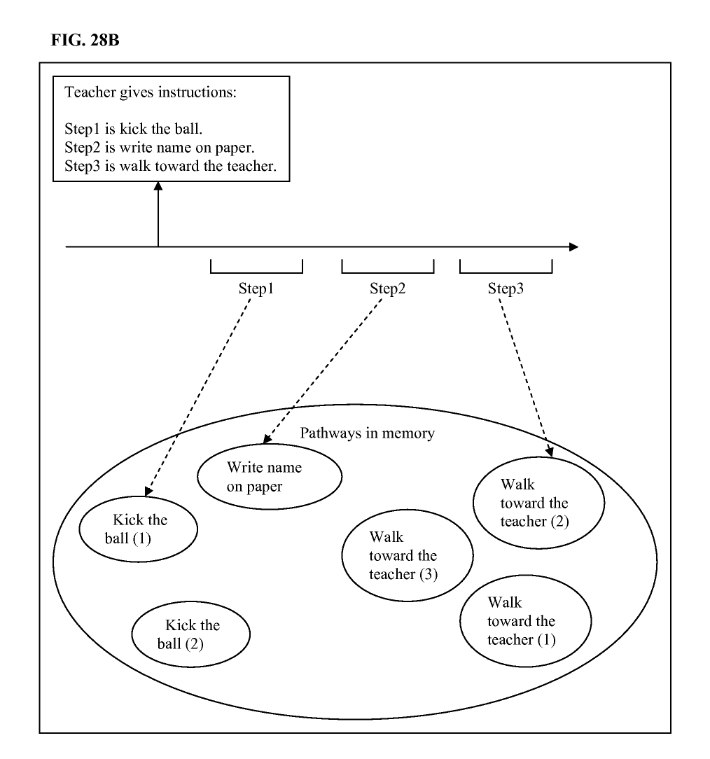

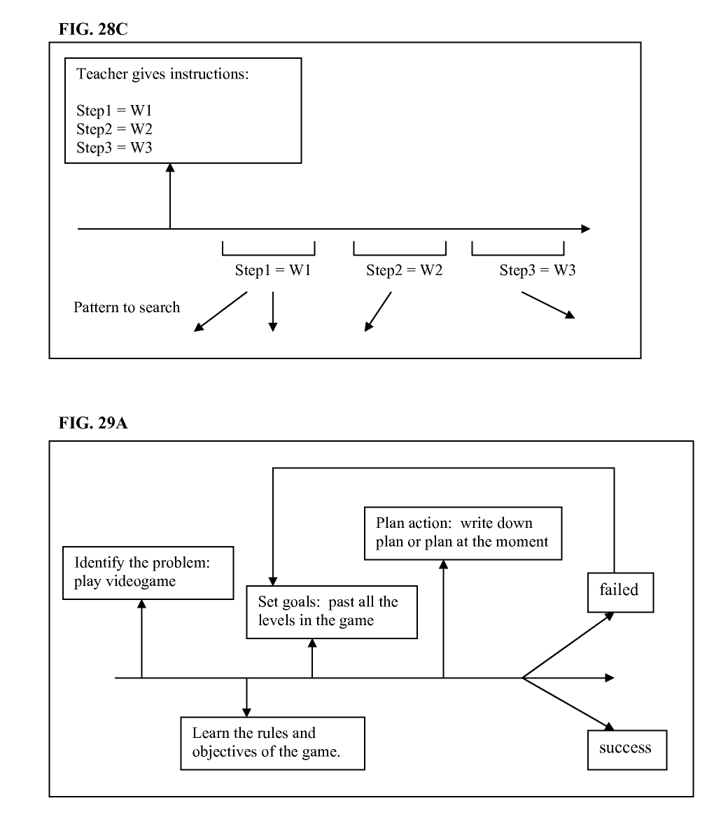

Another way to learn rules is by using patterns to put pointers to entire instructions from different areas in memory. Referring to FIG. 28A, if teachers gave the robot three instructions, then the next step for the robot is to do these instructions. Instead of teaching the robot that these steps are followed by these instructions, the robot can use patterns to search for instructions (regardless of how complex they are) from different areas in memory and copy these instructions into the current pathway. For example, in FIG. 28A, step1 is to jump, step2 is to sit on the box and step3 is to put on a jacket. These steps are followed by the robot's actions to carry out these steps. The AI program will establish reference pointers to pathways in memory for each step. This is accomplished by finding patterns on related target objects in the current pathway. Notice that step 1 has two copies in memory. The AI program picked the copy that best matches the current situation. Step 2 has only one copy so that copy is being referenced. Step 3 has three copies in memory and the AI program picked the best copy that best matches the current situation.

Entire instructions can be referenced by patterns. The start state of the instruction can be represented by a simple sentence or event—a sentence such as: “put on a jacket”. The end of the instruction can also be represented by a simple sentence or event—an event such as the jacket is on the robot's body or a sentence such as: “the jacket is on me”.

FIG. 28B shows a very similar pathway with different types of steps. However, the overall idea is the same. The pathway starts by having a teacher give 3 steps. The next step is the robot finding these instructions in memory and using these instructions to carry out the three steps. Step 1 is kick the ball, step2 is write name on paper and step3 is walk toward the teacher. Each step has a search pattern to find the instructions to carry out the steps. Step 1 has two copies in memory. The AI program picked the copy that best matches the current situation. Step 2 has one copy so the AI program picked that copy. Step 3 has three copies in memory and the AI program picked the copy that best matches the current situation.

FIG. 28C is a universal pathway created to cater to all pathways that have this pattern. W1, W2, and W3 can be “anything”. The AI program will be able to carry out the commands. Of course there should be additional intelligent pathways added such as determining wither or not the instructions to each step is located in memory (has the robot learned these steps before?). If these steps are not in memory that means the robot doesn't know what the instructions are. At this point, the robot has to find a way to carry out the step, either by asking the teacher or by reading instruction manuals or by logical thoughts.

Learning the rules and objectives through demonstrations from teachers. Learning complex rules through patterns.

Let's go back to the original section about learning the rules of an unknown game. In order to learn the rules of an unknown game, teachers will teach the robot how to look for the rules and objectives. Maybe, the robot can ask the teacher a question such as: what are the rules of the game? The teachers will tell the robot what the rules are at that point. If the rules are too complex, maybe, the teacher can write down the rules on a chalk board so that the robot can look up each rule one at a time. Maybe, the teacher will teach the rules by visual demonstration such as how to hold a golf club—put your right hand on the club handle like this, then put your left hand on the club handle like this. When you have a firm grip, you can swing the golf club like this.

Referring to FIG. 29A, other times, the rules and objectives of a game are learned through instructions. The teacher might say: look up the rules and the objectives of the game by reading instruction manuals. Or the teacher might instruct the robot to look up the rules and objectives by searching the internet. The lessons learned in school regarding the rules and objectives of a game will average itself out and when the time comes the most frequently taught lessons to learn the rules and objectives of a game will activate in the robot's mind.

The diagram in FIG. 29B shows that the robot is trying to find a way to learn the rules and objectives of an unknown videogame. It first tries to search for the instruction manual that should come with the purchase of the game. The robot didn't find the instruction manual. It will then attempt to search for the rules and objectives of the videogame by searching the internet. After the search the robot found nothing on the videogame. Finally, the robot picked up a videogame magazine that covered the videogame. He found the rules and objectives in the videogame magazine. Most of the rules and objectives are remembered in memory. However, the videogame has too much rules and strategies so the robot might have to look up certain rules during the playing of the game.

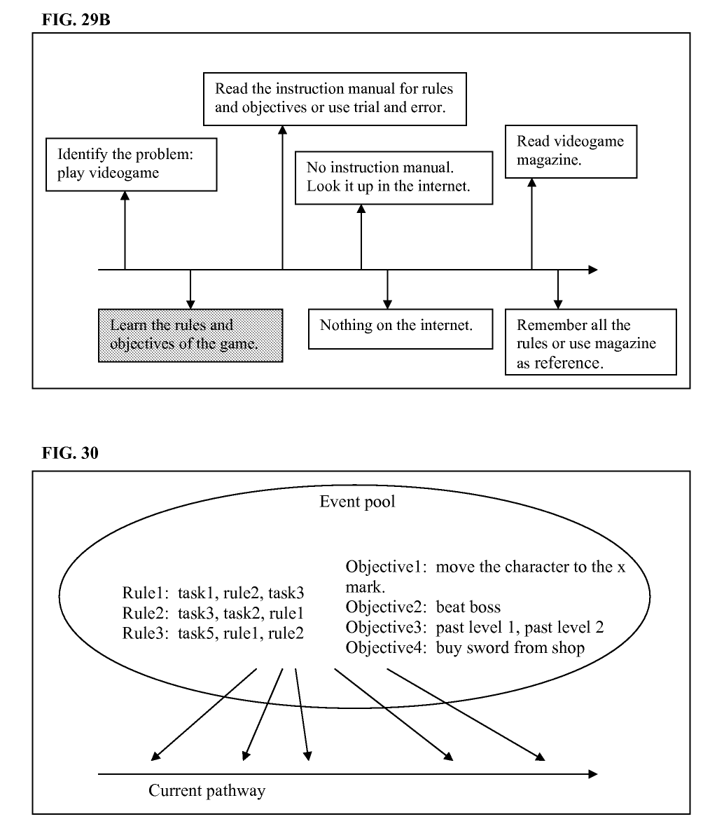

Referring to FIG. 30, the rules and objectives that the robot identifies will be stored in a container called an event pool. Patterns create the event pool as a temporary cache to store relational data. In this case, the rules and objectives are stored in the event pool. Rules and objectives can be sequential or it can be unpredictable (or both). If the robot learns the rules of a game the next time it plays the same game the rules will be stored in specific times in the pathway. If the robot is playing an unknown game the rules and objectives of the unknown game will be stored in the event pool with an unknown time in the pathway for each rule.

The rules and objectives can be in any data type, but it will most likely be words or sentences. Words and sentences encapsulate instructions to accomplish tasks. Each rule is usually in the form: if recognize object then take action. These are some rule examples: if recognize enemy1 then take action1, if recognize traffic lights and the light is green then move forward, when the gasoline tank is empty then fill the tank, from the white line wait for the green light to move forward.

There is no fixed law that states rules have a condition part and an action part. Rules can actually be anything. Rules can be in the form: if-then statements, when-statements, or encapsulated task sequences or discrete math functions or any intelligence pathways that can be represented by language.

Driving a Car Example

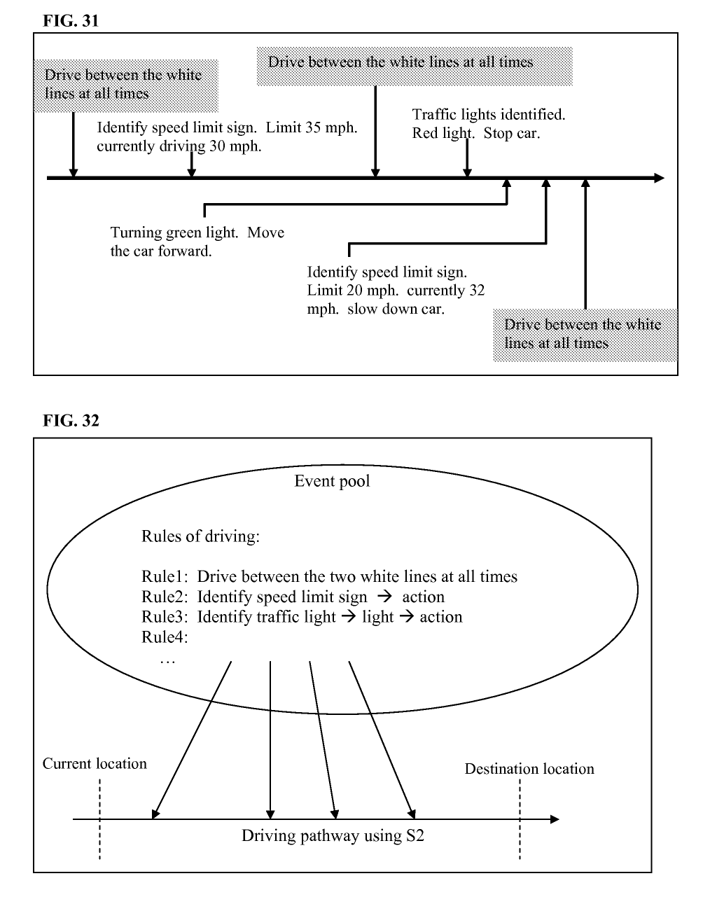

FIG. 31 is a diagram of a pathway to drive a car. Certain rules are activated based on certain recognized objects from the environment. When the robot recognizes the traffic light, it will take a certain action. When the robot sees a speed limit sign it will make sure the speed of the car doesn't exceed the speed limit.

Referring to FIG. 32, pathway S2 is derived from pathway S1. Remember that S1 is a universal adaptive pathway. Pathway S2 is a pathway to move the machine from the current location to the destination location. In this car example, the robot is using pathway S2 to get from its current location to its destination location.

At the same time it is trying to get from the current location to the destination location, the rules of driving are being followed based on the event pool (which is created from patterns). The robot also has memories of specific driving pathways of different locations. These specific driving pathways have exact times when certain rules are used and what the robot driver will encounter on the road. Specific traffic lights, routes, pot holes on the road, houses, street signs, environments and so forth will be remembered in each pathway. This makes it easy for the robot to drive on familiar routes. These are also routes that have been driven by the robot many times. However, in terms of unfamiliar routes and locations, the robot will use strategies in terms of logic to get from its current location to its destination.

What if the robot doesn't know a rule?

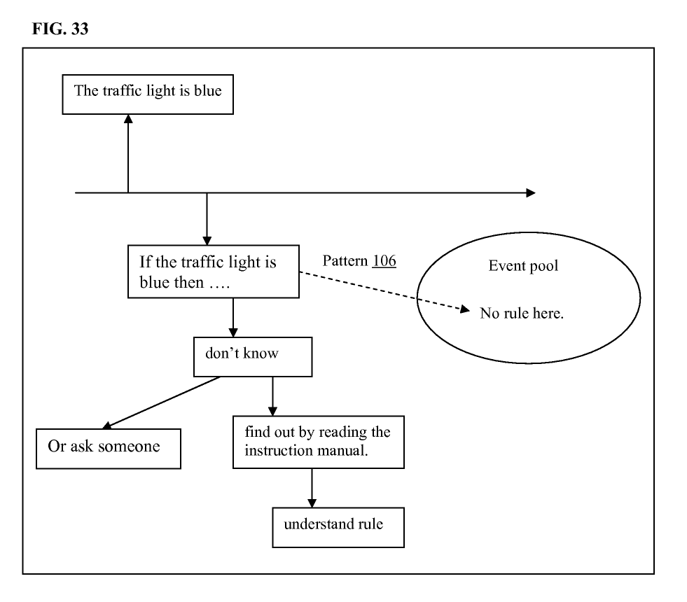

If the robot is playing a car videogame and in the game the robot encounters something that it never learned before, for example, if the traffic light is blue, the robot will not know the rules of what to do when the traffic light turns blue. FIG. 33 shows a diagram depicting how the robot will solve the problem of not knowing the rules of a game. When the robot encounters a blue traffic light it will use pattern 106 to search the event pool for a rule. Usually this rule: (Y1) if recognize a blue traffic light then . . . Y2. The search pattern 106 will use Y2 as the action. However, if there is no match for Y1, it will activate sentence: “don't know”. This will then activate sentence: “find out by reading the instruction manual”. The robot will pick up the instruction manual and search for the part about the blue traffic light. The instruction manual says that the blue traffic light indicates the car should drive to the curb and refuel (although this is a fictitious scenario, this can be applied to rule searching).

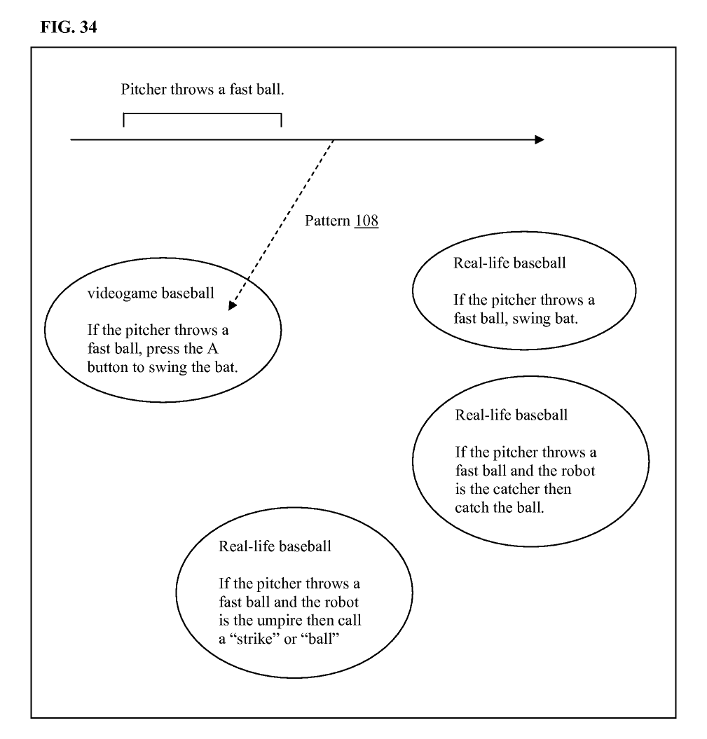

In terms of conflicting rules the conscious will manage multiple same rules. Usually sentences such as: this rule only applies to Contra or this rule is for baseball only or this rule is fictitious and only applies to this driving game. Patterns will also know where to look for certain rules (specific search points) if there are multiple same rules in memory. It really depends on what the situation is or what kind of game the robot is playing. Referring to FIG. 34, for the game of baseball, there are multiple rules in memory regarding a situation. The situation is: “the pitcher throws a fast ball”. Depending if the robot is playing a videogame or a real baseball game the instructions are different. If the robot was playing a videogame pattern 108 will be used to search for the instructions.

Playing the Zelda Videogame

Learning the Rules and Objectives of a Game Through Trial and Error

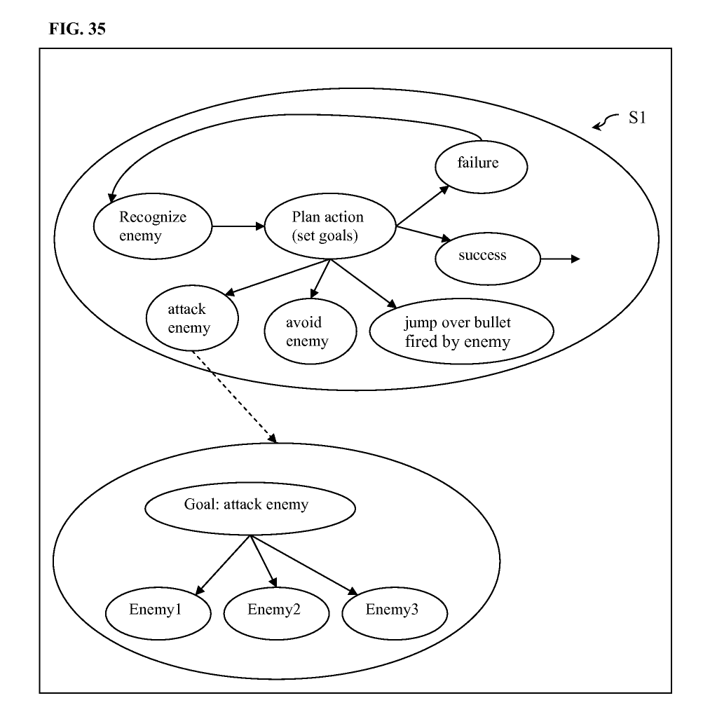

Referring to FIG. 35, pathway S1 is a universal adaptive pathway. Pathway S1 is applied to fighting different enemies in the videogame. Within pathway S1 are three options when recognizing an enemy: attack enemy, avoid enemy or jump over bullet fired by enemy. Within pathway “attack enemy” are three types of enemies: enemy1, enemy2 and enemy3. Each enemy has a different strategy in order to defeat. Some strategies are also encapsulated. For example, one strategy might be to jump over the bullet the enemy fired and the next strategy is to attack the enemy.

Most of the enemies that the player has to defeat are based on trial and error and there are no rules that are given to defeat a particular enemy. The robot will probably use pathway S1 to fight an enemy. During countless encounters with the same enemy the robot will build pathways in memory that will defeat each enemy in the best possible way. These optimal pathways to defeat an enemy (rules) will be stored in the event pool. These rules will be modified in the future if the player finds a better way to defeat that enemy.

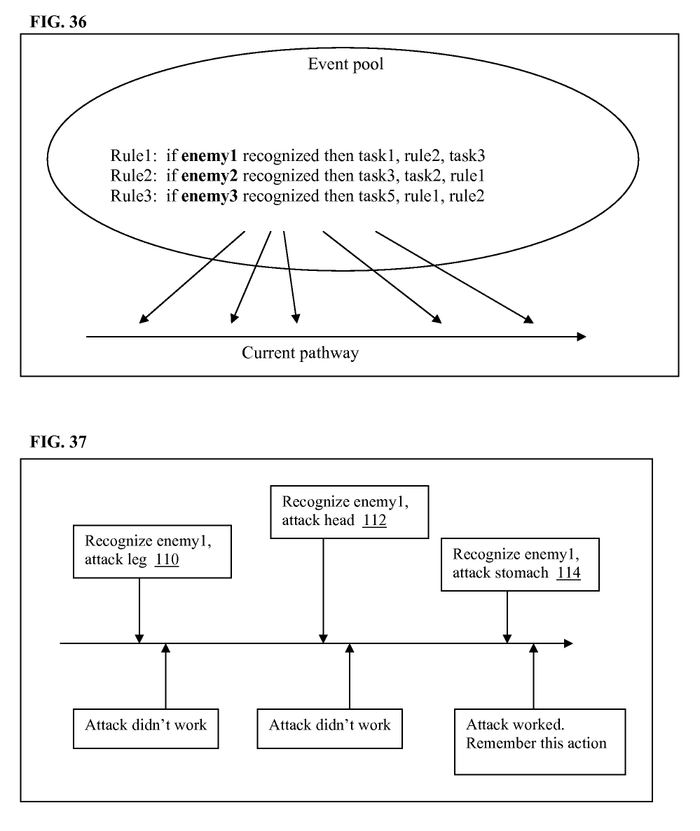

The event pool is only put into pathways when there are patterns found between many examples. If the robot recognizes certain enemies then it will respond by using a strategy. For example, if the robot recognizes enemy1 then it will execute task1, rule2, and task3. In real world situations there are many actions to take when recognizing certain enemies. Rules can also be encapsulated with other rules in the event pool. The simple example in FIG. 36 just illustrates how rules are followed in a game.

The rules in the event pool can also conflict with two or more other rules. Through trial and error, the robot can solve conflicting rules by prioritizing and selecting between two or more conflicting rules. It can also delete rules that it doesn't need or create new rules that it has found through trial and error. For example, if there is one rule that state: move forward when the traffic light is green and there is another rule that state: stop when there is a tree in front of the road what happens if the traffic light is green and there is a tree in front of the road? The AI program will use logic to create a new rule: move forward and go around the tree (the new rule is created through logic). This way it has fulfilled the first rule and the second rule. All this is done through the adaptive pathway S1.

Learning the Controls of a Videogame

With everything mentioned, the AI program learns the controls of a videogame by understanding the rules of the game. This is accomplished by reading instruction manuals or reading strategy guides for that particular game. These rules will be identified and stored in a rule container (a temporary cache for rules). While the robot is playing the game certain rules will activate at certain times based on patterns. For example, at the beginning of the game the rules of a control pad is outlined such as the joystick will move the character around, the A button is used for punching, the B button is used for kicking, the C button is used for jumping. The rules of the control pad can be complex as well. For example, one rule can state that in level 2 the A button is used for swimming or during boss battles the C button is used for swinging the sword around.

Rules for controlling a videogame can also be learned by the adaptive pathway S1. If the objective of the game was to balance a character on a bicycle then the robot has to push buttons on the control pad to balance the character on the bicycle. If it fails it will try again and create a new strategy. After many trials the robot will create the right pathways in memory to balance the character on the bicycle.

This method requires many intelligence working together in order to accomplish. For one thing it has to know the rules of the control pad and what buttons control what actions in the game. Then it has to use pathway S1 to plan an objective, and loop itself until that objective is achieved. The objective in this case is to balance the character in the game on a bicycle. It will try a strategy and see what the results are. If the results fulfill the objective then it will be remembered. If not, then it will try again and again until the objective is achieved.

To complicate this method more there are other hierarchical conscious thoughts that can be activated. For example, if the robot tries for 6 times and the results haven't improved then it will stop trying to balance the character on the bicycle. Another example is if the robot is hungry and needs to eat, it will stop playing the game, (possibly press the pause button) go and get something to eat and then continue where it left the game.

Learning the rules of the control pad can be applied to all types of controls. A human being has innate built-in controls to move its' arms, legs, head, eyes, mouth, vocal cords and so forth. A car has a steering wheel, foot pedals, breaks, front mirrors and side mirrors. A plane has a joy stick, hundreds of radio buttons, several monitors, foot pedals and acceleration lever. A TV remote has buttons that the user can press to change the channels, turn the TV off or on or select options. A computer has a mouse, keyboard, touch sensors, microphone and voice commands to control the computer. These are just some of the controls that various machines have to interface a user with a particular machine. Regardless of the different controls, the intelligent pathway S1 will allow the robot to adapt to a machines' control pad and learn to control the machine so that it does what the robot wants it to do.

Adaptive Planning and Acting to Defeat Enemies (J5 Pathway)

The intelligent pathway S1 can also be used as an adapting program. The AI program can learn to set a goal, try an action and repeat itself until a desired outcome results. Intelligent pathway S1 can be used to practice a videogame, defeat certain enemies in the game, learn the controls of a game, maneuver a plane, practice golf skills, practice shooting targets and so forth. The reason why humans are partly intelligent is because of intelligent pathway S1. We can learn to adapt to the environment and make ourselves better in the future.

For example, if the robot was playing the legend of Zelda and there is a monster called enemy1 that the robot has to beat, then he has to create a plan to beat enemy1. Based on the rules and controls in the game, the robot can plan out an attack on enemy1. If enemy1 is defeated that means that strategy is good and the robot will remember this strategy in the future. If enemy1 is not defeated that means that strategy is bad and the robot will loop itself to find a new strategy to defeat enemy1. Referring to FIG. 37, After trying 3 times the robot finally found a weak spot in enemy1. Strategy 114 will be stored in the pathway while strategy 110 and strategy 112 will be forgotten (Sometimes its pain and pleasure that decides what is a good or bad result).

This intelligent pathway, S1, will be used many times. Tasks and encapsulated tasks will be using S1 repeatedly to create newly desired tasks to accomplish a goal. The robot playing Zelda will be using S1 to past the game. Then, the robot will use S1 to defeat specific enemies (enemy1, enemy2, or enemy3). Next, the robot will use S1 to past each level in the game. In case it fails in level2, it will try again and learn from its past mistakes. Next, the robot will use S1 to plan strategies to achieve certain simple goals in Zelda. For example, a simple goal would be to get the character from one location to another location in the videogame. If it fails then it will try another strategy. The robot will repeat this process over and over again until it successfully gets the character from the current location to its destination location.

Logic Thinking Example (L3 Pathway)

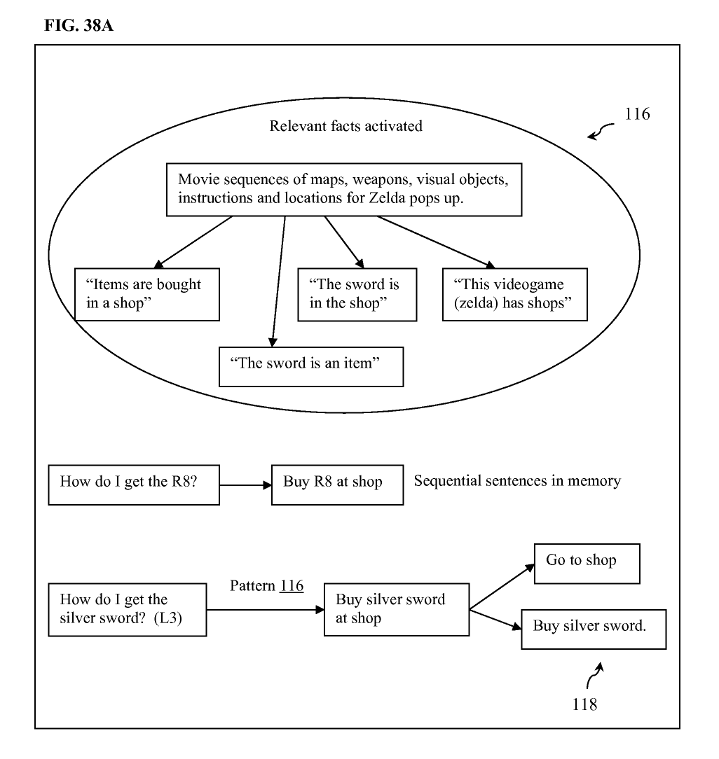

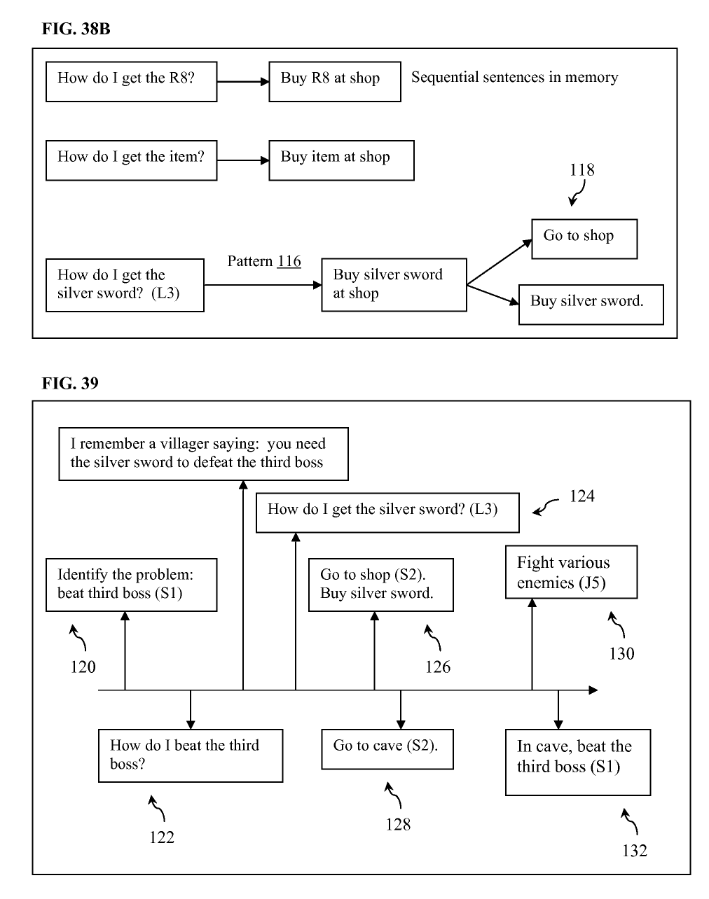

Answering a question requires many patterns working together in order to accomplish. Referring to FIG. 38A, the question: “how do I get the silver sword?”, require the player to use facts and movie sequences related to the current situation to come up with an answer. The complexity of the question is hidden from the robot and the robot has to find the patterns in order to answer the question. The question is given and the answer is given. The job of the robot is to find the hidden patterns 116 between the question and the answer. In this case, the question is: “how do I get the silver sword” and the answer is: “buy silver sword at shop”. The response 118 to the answer is: “go to shop” and “buy silver sword”.

Referring to FIG. 38B, an alternative variable for the silver sword will not work. How do I get the house? Buy house at shop won't make any sense. The key is that pattern 116 contains the activated element objects from the question asked: how do I get the silver sword, and from the current environment. Target objects like the type of videogame (Zelda is a role playing game), the current location of the character and does the videogame have shops. All these target objects will gather all of its element objects and all element objects from all target objects will compete with one another to be activated. Patterns 116 are activated element objects to certain target objects in the current pathway. They are represented by sentences, but they could be represented by visual images, sound, taste, touch or by hidden data.

Actually, most of the logic in pattern 116 is not needed. The fact that the silver sword is an item and that all items can be bought at a shop will activate the sentence: buy silver sword at shop. If R8 was replaced with house, the AI program will determine that house is not an item. Therefore, it will not activate the sentence: “Buy house at shop”.

However, the logic behind actions 118 is very complex in that the robot has to know if the game has any shops or if it is even possible for the player to reach a shop. After determining the game has shops, it has to find out what shops have the item—is it the shop in emerald village or is it a shop in Demon cave? The second action: “buy the silver sword” will activate other sentences such as: do you have enough money to buy the silver sword? This requires the robot to press the select button to view the money count. Then it has to determine how much the silver sword will cost. If it is determined that there is not enough money to buy the silver sword then it will have to plan a strategy to get more money. In the game of Zelda, there are several ways of getting money: the robot can get money by cutting trees, or defeating enemies, or selling existing items. It has to determine which methods will be used to get more money. If the robot decides on one of these methods other logical thoughts have to be included such as what areas to go to find monsters. If the robot goes to the caves the monsters are harder to defeat and can result in death during battle, while in other areas the monsters are easy to defeat, but the money acquired is very little. These types of logical thoughts are not found by simply finding patterns between words and sentences, but by using internal functions set up by the programmer such as the 4 different data types in the 3-d grid, fast forward or rewind in long-term memory to search for data, or using pattern objects to come up with logical thoughts.

Playing a Zelda game is a very difficult task to accomplish—especially if the robot wants to past the game. Many years of learning from teachers are needed to build the robot's intelligence at a human-level. The robot must learn the ABC's first before it can read and write. After learning how to read, write and communicate it will take advance logic classes to build even more intelligent pathways in memory. Knowledge from college courses can be created in memory. Over the years, as the robot learns more and more the pathways become more intelligent. A bootstrapping process occurs, wherein pathways in memory are inserted, deleted and modified on pre-existing knowledge.

Combining all the Intelligent Pathways Together to Play the Zelda Game

Let's combine all the different forms of intelligence into one super intelligent pathway. I will be using the Zelda game to illustrate how the robot accomplishes a specific task in the game. FIG. 39 illustrates how the robot will defeat the third boss in the game. The robot will first identify the problem which is to beat the third boss (step 120). Step 120 will be using the S1 pathway to accomplish this task. Next, it will devise a plan to defeat the third boss. In this case step 122 is activated by the conscious. The robot remembers that a villager it has encountered a few hours ago said that he needed the silver sword in order to defeat the third boss. As a result of this activated thought, the robot will activate step 124 which is a question to be answered by the robot. The robot is wondering how to get the silver sword. The logic behind the Q&A is from the intelligent pathway L3. Pathway L3 is basically used to find an answer to a question (previously discussed). Step 126 is the answer and is also the action the robot will take. There are two actions the robot will take: go to shop and buy silver sword. Go to shop will be using intelligent pathway S2 to accomplish. Pathway S2 is to plan a strategy to take the character from the current location to the destination location in the game. In this case the destination location is a particular shop. After the character in the game buys the silver sword it will move on to step 128. Step 128 is to go to the cave, which also uses intelligent pathway S2. Pathway S2 is to plan a strategy to take the character from the current location to the destination location in the game. In this case the destination location is the cave. During the character's travel, it will no doubt encounter enemies. In step 130, intelligent pathway J5 is used to defeat different types of enemies in the game. Finally, when the character reaches the cave, it will have to defeat the third boss (Step 132). Step 132 uses the intelligent pathway S1 to find a way to defeat the boss.

As you can see, the steps to accomplish one task in the game of Zelda is very complex and requires several intelligent pathways and encapsulated intelligent pathways working together simultaneously.

Intelligent pathways build on previously learned intelligent pathways. They merge with other intelligent pathways that have association nearby. Some data in the pathways forget information and others are forgotten intentionally. The pathways are also adaptive; and learns from trial and error or by understanding rules.

Saving the Videogame in Memory and Continuing where the Game Ended the Last Play Time

When playing a videogame, especially playing the legend of Zelda, the player has to save the game many times and continue playing the game where it last stopped. This means tasks are not done continuously, but are done in fragmented sequences. The robot will use patterns to save a game and the next time it plays the game it will continue where it left off. When the robot plays the game, the patterns will activate all the relevant knowledge from the previous game. Relevant knowledge such as: what were the objectives of the game, the rules of the game, the plan, the strategies and so forth.

The robot can stop playing a game and replay the same game 1 hour later, 2 days later or even 3 weeks later. The pattern will transport all the relevant knowledge from the previous game and the robot will know what the objectives of the game is, the current objective of the game, the overall objective of the game, the rules of the game, the plan to achieve the objectives and so forth. The replaying of the game might not be the continuation of the previous game, it might be to start a whole new game or to play the game from 3 previous game plays. The 4 different data types will create these intelligent pathways in memory to save a game and to continue the game in the future.

Future Prediction

My attempt in this patent application is to present a method where an AI program can predict the future in an accurate and realistic way. It's easy for the AI program to predict the future for a simple math equation because math equations have consistent patterns. However, trying to predict the future to curing cancer is an obstacle because there are no consistent patterns for unknown future pathways. Since the AI program doesn't know the cure to cancer, it will not have any pathways in memory that will lead to a cure.

One purpose of the present invention is to design an AI program that can predict the future for “unpredictable” events. These events are impossible to predict. For example, is it impossible to predict what a human being will say and do in the future? If the robot had an appointment with the president of the United States do you think it is possible the robot can predict the exact words and actions the president will make? If the robot doesn't know the meaning to a word and searches the internet for the answer, is it possible for the robot to predict what the search results will be? If the robot had to predict the exact movement of each water drop in a storm, do you think it is possible? These are just some events that are considered impossible to predict.

Pathways in memory forget to prevent overloading of data in memory. By the time the AI program searches for a pathway in memory some content in said pathway are deleted or missing. The purpose of the future prediction function is to find the longest future pathway that will benefit the AI program. All the future pathways are constructed by taking continuous sections of pathways in memory and combining them together.

Since data in pathways are forgotten, another purpose of the future prediction function is to “reconstruct” what the original pathway was when it was first stored in memory. Each pathway have 4 different data types: 5 sense objects, hidden objects, activated element objects and pattern objects. This means the AI program has to reconstruct all 4 data types for each future pathway. This also means that the AI program has to, not only reconstruct what the robot senses from the environment (5 sense objects), but also reconstruct the hidden objects generated by the 5 sense objects, the element objects activated by the 5 sense objects and the pattern objects that was matched in memory.

It might appear like the 4 different data types is a burden, but quite the opposite. The 4 different data types help the AI program to remember what was sensed from the environment. Things that the robot sensed from the environment such as sight, sound, taste, touch and smell generate hidden objects or it activates related element objects such as meaning or stereotypes. These extra objects that are generated by the 5 sense objects can help the AI program remember what the actual 5 sense objects are. For example, if the robot encounters a cat image the meaning of the cat image will activate such as the sound “cat”. In the future, data in the pathway are forgotten; the image of the cat is gone from the pathway. The pathway still has the activated sound object “cat”. This sound object will help the AI program to reconstruct what the original cat image looked like.

The predicted future pathways should have 3 qualities: (1) Future pathways have to be accurate and realistic to what will eventually happen. (2) Future pathways have to be long, continuous and consistent. (3) Future pathways have to have the least amount of possibilities. The optimal future pathway is a controlled fabricated future pathway containing the 3 qualities, described above, that will benefit the AI program in the future (or robot).

How Future Pathways are Fabricated

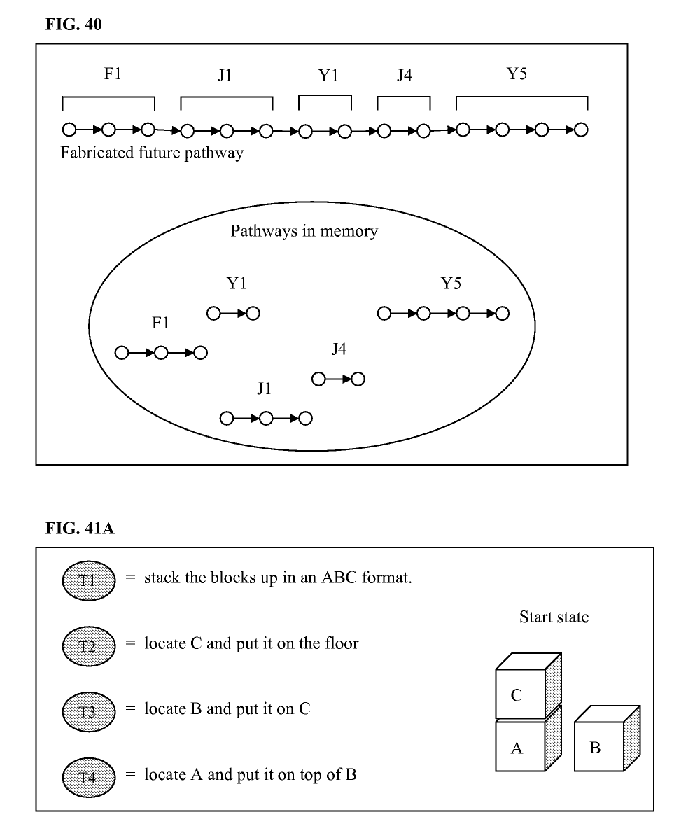

From each state in a future pathway the AI program has to fabricate the most likely continuation. The longer and more accurate a future pathway is the better the future prediction. FIG. 40 shows a diagram of a long future pathway fabricated by taking continuous pathways in memory.

Functions (or steps) to predict the future:

1. predict future pathways by using hierarchical data analysis.
2. predict future pathways by using linear and universal pathways.
3. predict future pathways by reconstructing forgotten pathways.
4. predict future pathways by using external reconstructive programs.
5. predict future pathways by using a time machine.
6. predict future pathways by using logical learning.

The 6 steps mentioned above are used in combinations to come up with future pathways. They work together in combinations so that future pathways are accurate and realistic to what will eventually happen in the future. Note: (1) predict future pathways by using hierarchical data analysis. (2) predict future pathways by using linear and universal pathways. Both topics have been discussed in detail in provisional patent application: 61/028,885. Only a summary of the two topics will be given in the next section. This patent application will mainly focus on the remaining topics:

(3) predict future pathways by reconstructing forgotten pathways.
(4) predict future pathways by using external reconstructive programs.
(5) predict future pathways by using a time machine.
(6) predict future pathways by using logical learning.

Predicting the Future Using Hierarchical Data Analysis

The AI program uses entire universal pathways from memory to come with the most likely future pathways. Two factors will be used to analyze universal pathways: pathway intersections and pathway strengths. After many training, universal pathways are structured in a hierarchical manner and each state in a pathway has a probability of when the next state will occur. The job of the AI program is to determine which future pathway will most likely occur in a hierarchical manner, wherein future pathways are ranked based on the most accurate future prediction and most detailed future prediction.

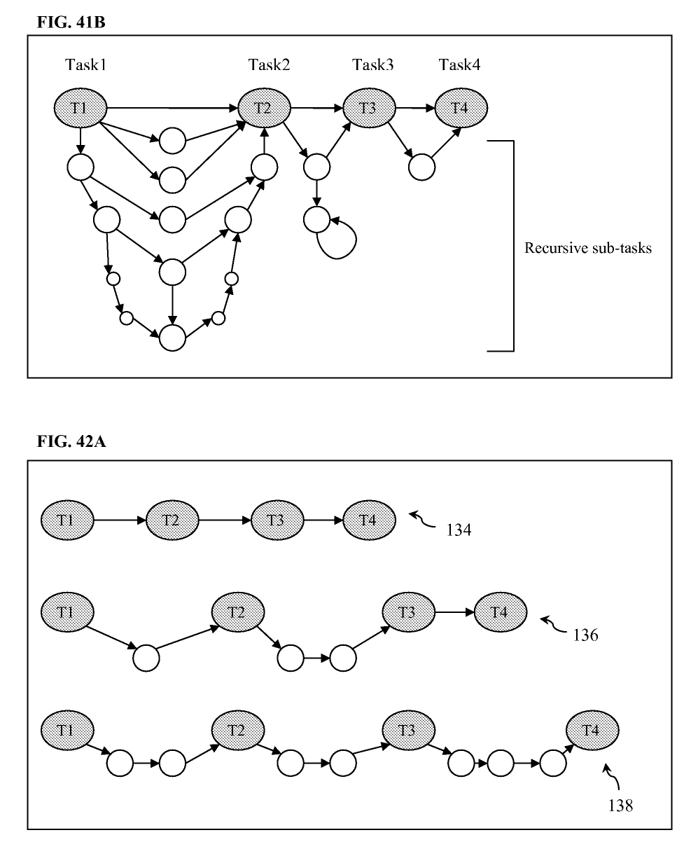

FIG. 41A-B shows a universal pathway to solve the ABC block problem. This universal pathway is structured in such a manner that the most important tasks are outlined first (T1-T4). Within each task are encapsulated sub-tasks and they are also arranged in a hierarchical manner. Referring to FIG. 42A, the AI program will first predict tasks that are consistent and don't have much variations. Pathway 134 is a simple future pathway that is most likely to occur. If there are variations to a future pathway then the AI program has to generate future pathways for each dominant possibility. In Pathway 136 the future pathway is more detailed and instructions in most of the tasks are inserted in pathway 136 based on the most likely event to happen. Pathway 138 is an even more detailed future pathway. This will go on and on until every frame and every data in the frame is predicted for each future pathway. Predicting future pathways will depend primarily on the strongest future possibilities and not all future possibilities. Pathways in memory have 4 different data types: 5 sense objects, hidden objects, activated element objects and pattern objects. The job of the AI program is to try to predict all 4 different data types in future pathways. All frames and all details in each frame in a given future pathway are to be predicted. This would be a very very very difficult task because the AI program not only has to predict what the machine will sense from the environment, but also predict what the activated element objects will be and predict what the hidden objects will be (hidden data generated from the 5 senses) and predict what the pattern objects will be in future pathways. For example, if the AI program predicts that it will witness an event; and this event triggers a logical thought, the AI program has to predict what this logical thought is. Despite this difficult problem, the future prediction doesn't have to be 100 percent accurate, it can be approximate. As long as there exist some kind of pattern between similar future pathways, an approximate future prediction is efficient.

Referring to FIG. 42B, each future pathway will be ranked based on which future pathway is most likely to happen. Usually the rankings will have detailed future pathways at the top level and summarized future pathways on the bottom level. As new frames are encountered from the environment the rankings shift and some future predictions are discarded while new future pathways are generated. With the addition of new frames the detailed future pathways will change dramatically while the summarized future pathways stay the same. Future pathway 134 doesn't change while a large part of future pathway 138 changes dramatically.

Predicting the Future for Infinite Possibilities

Sometimes predicting the future is impossible because a certain state in a future pathway require data that can be anything. Imagine you are trying to predict a math problem without knowing what the equation is. The variations can be infinite and even if the AI program predicts the future of a math problem based on the most likely equations, the outcome of the prediction will not be optimal. In order to solve this problem words and sentences are used to represent future possibilities that are infinite. If the AI program wants to predict the future of solving a math problem, but doesn't know what the equation is then it will use sentences stating when it will start solving a math problem and it will also use sentences stating when it has finished solving the math problem. The details of the math problem will be delayed until more data comes in. In the moment when the AI program receives the equation of the math problem it will predict the future in detail what steps it has to take to solve the problem. This will go on and on until every frame of the math problem is predicted. The logic behind the math problem will also have to be predicted.

Predicting the Future Based on Universal Future Pathways and Patterns

In terms of predicting the future based on infinite possibilities an extension of the last example would be to include not only sentences and events, but also universal future pathways and patterns. When playing a game like Tetris or Bejeweled the possibilities are endless and the pathways do not reflect an adequate strategy to play these games. In order to solve this problem the AI program has to create universal future pathways in terms of strategies and patterns. This method is equivalent of putting expert AI programs to play specific games in future pathways.

Referring to FIG. 43, a universal future pathway comprises: an event pool and a future pathway. The event pool contains tasks and task sequences and each task or task sequence has a pointer to when it will happen in the future pathway. Tasks can be anything, it can be a sentence or an event. The time that a task will occur in the future pathway can have several values: exact time, estimated time, constant time or void time. If a task or task sequence has an exact time that means the robot knows exactly when that task will occur (very rare). If a task or task sequence has an estimated time that means the robot will have a time range when that task will occur. If a task or task sequence has a constant time that means the task is continuous and the robot is executing the task continuously. Driving a car for example require the driver to continuously drive in the middle of two lines on the road. Finally, if a task or task sequence has a void time that means the robot doesn't know when that task will happen and it might or might not happen within a given domain block.

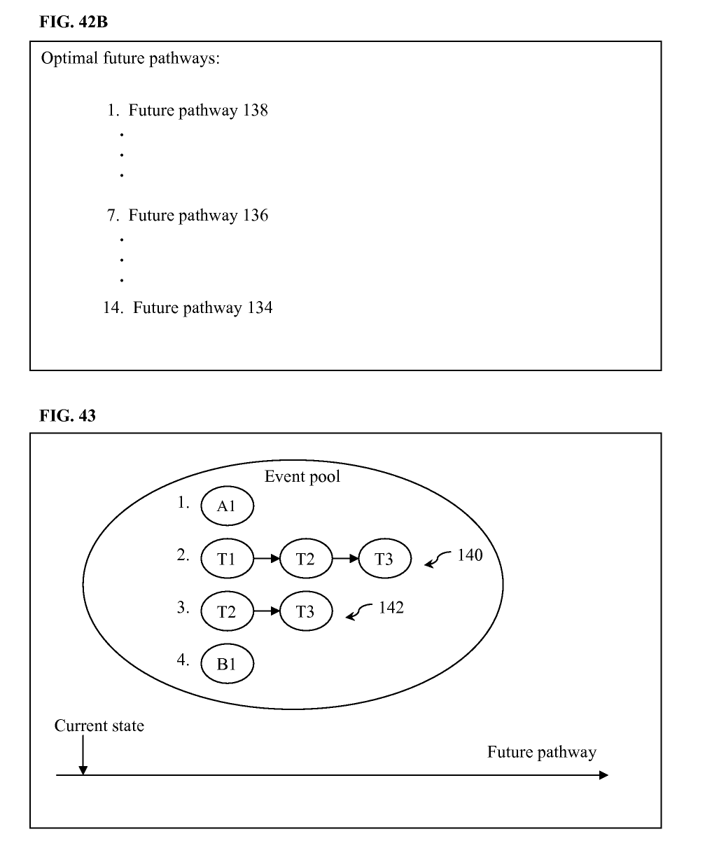

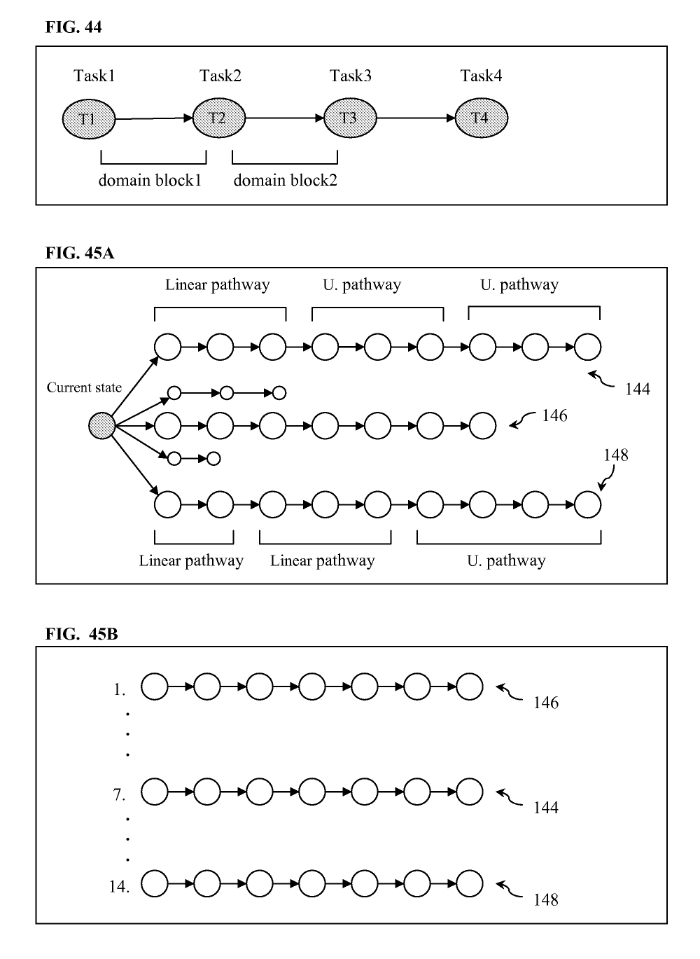

Each task has a domain block in the future pathway that states the task will happen within a certain domain. In FIG. 44, the start of task1 and the beginning of task2 is one domain block and the beginning of task2 and the beginning of task3 is another domain block. These domain blocks are usually defined by a sentence or an event. There is no start state of a task or an end state only sentences or events stored in pathways that represent the start and end of a task.

Tasks and task sequences in the event pool will be structured in a hierarchical manner, wherein the most frequently occurring task or task sequence will be outlined. This will help the AI program predict which tasks or task sequences will most likely occur and which are least likely to occur. However, most tasks and task sequences are still unpredictable. Referring to FIG. 43, the tasks and task sequences are arranged in a hierarchical manner, wherein the list will contain the highest frequency of task occurrence. Also, tasks 142, which is encased in task sequence 140 can also be included in the event pool.

There are two types of future pathways: (1) Linear pathways which are pathways that have only one future possible sequence. (2) Universal future pathways which are pathways that have many possible future outcomes. Both linear future pathways and universal future pathways will be used in combinations to predict the future. Only unpredictable outcomes use universal future pathways. Linear future pathways are preferred because they give the AI program a detail future pathway with exact tasks and time these tasks will occur. The idea is to predict the future accurately and precisely and list the most dominant future pathways. As new data is encountered by the robot the list will update itself. FIG. 45A is a diagram depicting a tree-like structure of future pathways using both linear and universal future pathways. FIG. 45B show the ranking of the most dominant future pathways in the tree.

Note: (1) predict future pathways by using hierarchical data analysis. (2) predict future pathways by using linear and universal pathways. Both topics have been discussed in detail in provisional patent application: 61/028,885.

Reconstruct Forgotten Pathways in Memory

Pathways in memory forget to prevent overloading of data in memory. By the time the AI program searches for a pathway in memory some content in said pathway are deleted or missing. The purpose of the future prediction function is to find the longest future pathway that will benefit the AI program. All the future pathways are constructed by taking continuous sections of pathways in memory and combining them together.

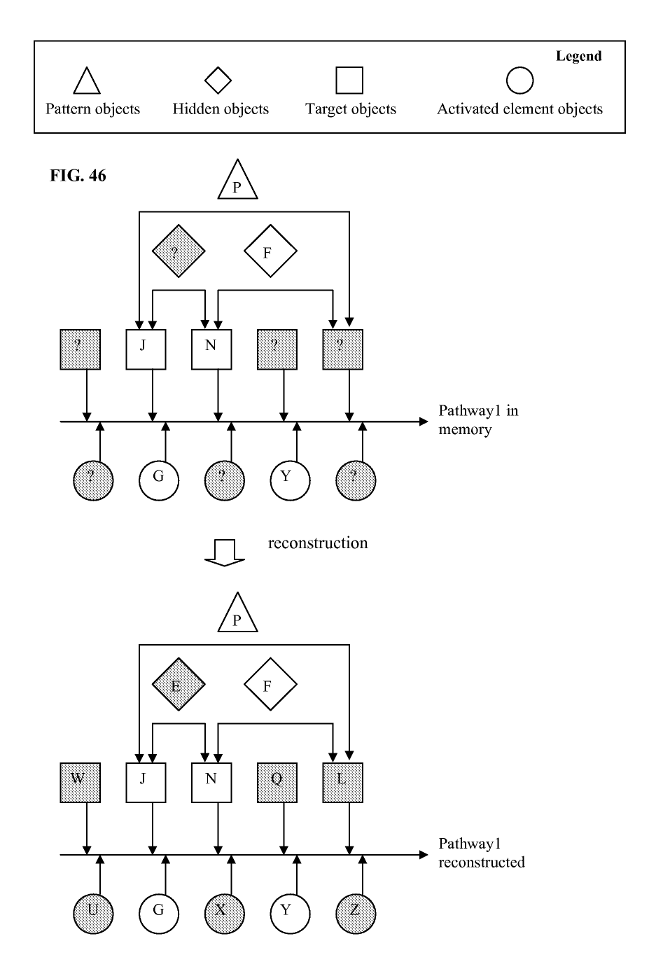

Referring to FIG. 46, since data in pathways are forgotten, another purpose of the future prediction function is to “reconstruct” what the original pathway was when it was first stored in memory. Each pathway have 4 different data types: 5 sense objects, hidden objects, activated element objects and pattern objects. This means the AI program has to reconstruct all 4 data types for each future pathway. This also means that the AI program has to, not only reconstruct what the robot senses from the environment (5 sense objects), but also reconstruct the hidden objects generated by the 5 sense objects, the element objects activated by the 5 sense objects and the pattern objects that was matched in memory.

It might appear like the 4 different data types is a burden, but quite the opposite. The 4 different data types help the AI program to remember what was sensed from the environment. Things that the robot sensed from the environment such as sight, sound, taste, touch and smell generate hidden objects or it activates related element objects such as meaning or stereotypes. These extra objects that are generated by the 5 sense objects can help the AI program remember what the actual 5 sense objects are. For example, if the robot encounters a cat image the meaning of the cat image will activate such as the sound “cat”. In the future, data in the pathway are forgotten; the image of the cat is gone from the pathway. The pathway still has the activated sound object “cat”. This sound object will help the AI program to reconstruct what the original cat image looked like.

I will be outlining three methods to reconstruct forgotten pathways in memory. All three methods work together to reconstruct a future pathway from different pathways in memory. The three methods are: 1. hierarchical tree reconstruction. 2. branch tree reconstruction. 3. individual object reconstruction.

Reconstructing data in the forgotten pathway is done hierarchically, first, with the long hierarchical trees (long pathways), then, with the branch trees in the hierarchical trees, finally, with the individual objects in the branch trees.

1. Hierarchical Tree Reconstruction

FIG. 47A-47B are diagrams depicting a hierarchical tree 150 being reconstructed. This method takes long sections in a forgotten pathway 150 and finds the closest original pathway matches in memory. The cut points in a hierarchical tree 150 determines the areas that are most likely not in the original pathway. The cut points of the hierarchical tree 150 depend on the strength of objects in the tree and also on the similiarities/dissimilarities between matches found (hierarchical tree 152 and hierarchical tree 154). In hierarchical tree 152 the cut point is: object P. In hierarchical tree 154 the cut point is: object L.

2. Branch Tree Reconstruction

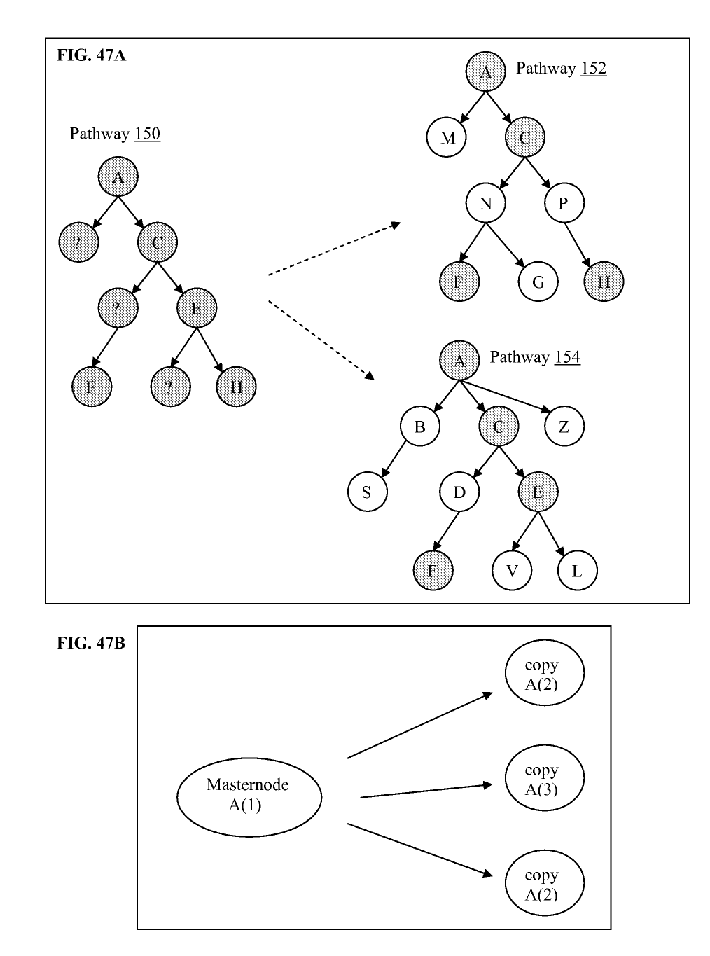

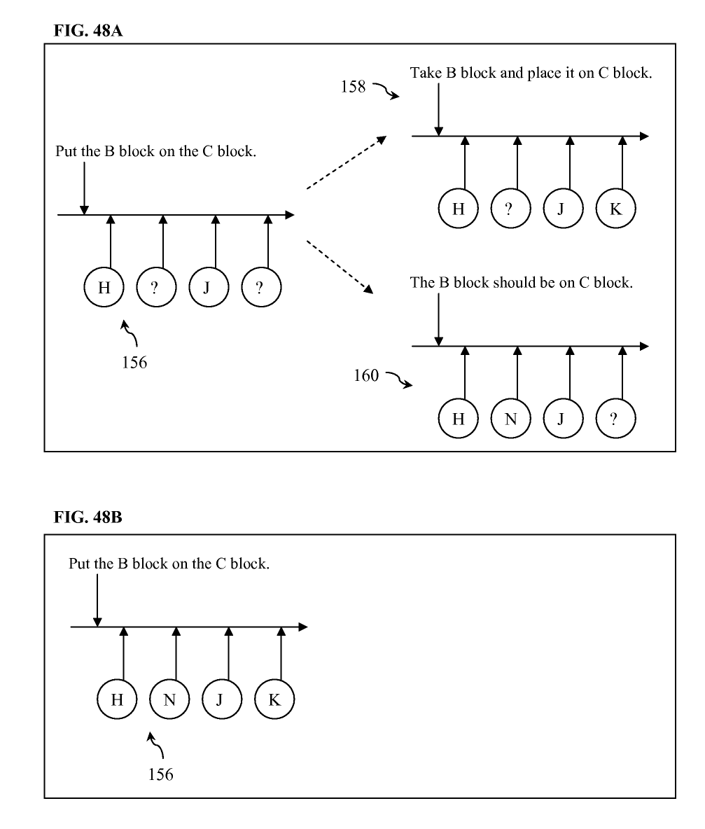

FIG. 48A is a diagram depicting a branch tree 156 being reconstructed. This method takes branch trees from a forgotten pathway 150 and finds the closest original branch tree matches in memory. The cut points in a branch tree 156 determines the areas that are most likely not in the original pathway. The cut points of the hierarchical tree 156 depend on the strength of objects in the branch tree and also on the similarities/dissimilarities between matches found. In this example there are no cut points in branch tree 156. However, the AI program found objects from similar branch matches that can be used for reconstruction. FIG. 48B depicts the reconstructed branch tree 156 from branch tree 158 and branch tree 160. Object K was taken out of branch tree 158 and object N was taken out of branch tree 160.

3. Individual Object Reconstruction

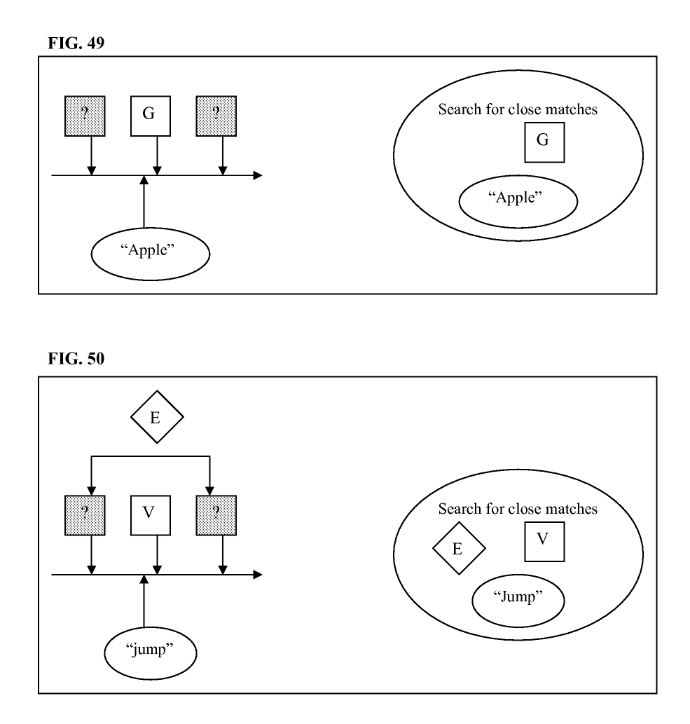

The individual objects such as visual objects, action objects or event objects have to be reconstructed. In order to do this the domain of an object has to be taken out of the forgotten pathway 150. In FIG. 49, the visual object is apple. There are three frames representing apple, in which, two are forgotten and the one frame in the pathway is fuzzy. The search function must search for the two missing frames by using the remaining data in the pathway: visual object G and activated element object “apple” (also known as a learned object). The learned object “apple” can search for any visual floater for “apple” in memory. Next, the visual object G will pinpoint exactly what image to look for in all copies of apple floaters. When visual object G is located the two missing frames will most likely be very close-by. The AI program can guess at this point which two frames fill in the two missing frames in the pathway.

In FIG. 50, the hidden object is a “jump”. The AI program has to reconstruct the two missing visual frames. The search function must search for the two missing frames by using the remaining data in the pathway: visual object V, hidden object E and activated element object “jump” (also known as a learned object). The learned object “jump” is a sound object. The learned object “jump” can search for any jump floater in memory. Next, the visual object V will pinpoint the exact areas in each jump floater. The hidden object E will also help in pinpointing the exact areas in each jump floater. The more data used for the search the more accurate the search will be. For example, if the jump sequence had two visual objects instead of one that will make the search function find a better match in memory. When visual object V is located in memory the two missing frames will most likely be close-by.

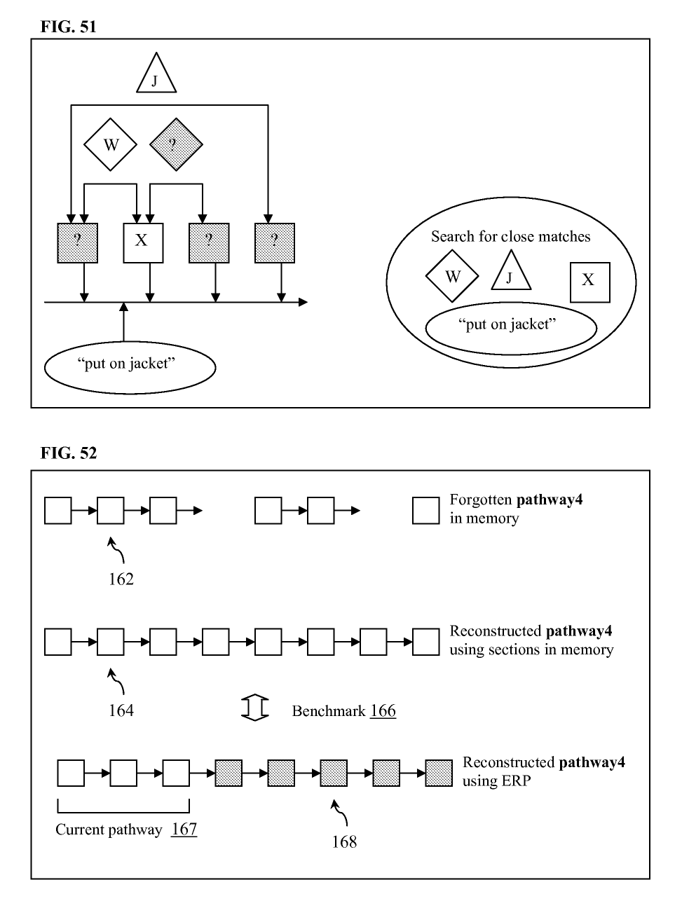

In FIG. 51, the event object is: “put on jacket”. The AI program has to reconstruct the four missing objects: 3 visual frames and 1 hidden object. The search function must search for the 4 missing objects by using the remaining data in the pathway: visual object X, hidden object W, pattern object J and activated element object “put on jacket” (also known as a learned object). The learned object “put on jacket” is a sound object. The learned object “put on jacket” can search for any visual floater of anyone putting on a jacket in memory. Next, the visual object X will pinpoint the exact areas in each “put on jacket” floater. The hidden object W will also help in pinpointing the exact areas in each “put on jacket” floater. The pattern object J will help the search function even more. The more data used for the search the more accurate the search will be. For example, if the “put on jacket” sequence had three visual objects instead of one that will make the search function find a better match in memory. When visual object X is located in memory the three missing frames will most likely be close-by. The missing hidden object will also be close-by.

For these three examples: visual object (FIG. 49), an action object (FIG. 50) and an event object (FIG. 51), the missing data is outlined. In real world problems each pathway in memory doesn't record wither data is missing or not. It's up to the AI program to guess where the missing data are. It also has to guess where the missing data was originally stored in memory. The pathways store data in a hierarchical manner and the pathways forget data in a hierarchical manner. Thus, it's hard to actually delete data from a pathway entirely.

External Reconstructive Programs

One way to test and verify the authentication of a reconstructed pathway in memory is to use external reconstructive programs. External reconstructive programs are additional program used to generate the original pathway from forgotten pathways in memory. The purpose of ERP (short for external reconstructive programs) is to take a forgotten pathway and to generate the original pathway.

The reason for this is because the AI program has to predict what the exact data from the environment will be in an accurate and realistic way. The future prediction should match exactly to the events that will occur in the future. The AI program will not only predict the 5 sense objects that will occur in the future, but also the other 3 data types: hidden objects, activated element objects, and pattern objects. The hardest data type to predict is the activated element objects because the AI program has to predict what element objects will activate in the robot's mind in relation to the environment—basically, predicting the conscious thoughts of the robot in the future.

External reconstructive programs are a variety of programs to reconstruct different senses. There is an ERP for visual movies, there is an ERP for sound, there is an ERP for touch and so forth. For simplicity purposes only visual objects will be used. For something like a movie sequence, the ERP must create a 3-dimensional representation of all visual objects in a movie sequence. By creating the 3-D models the visual objects can be consistent in terms of what it will look like from frame to frame. The ERP will also have physic laws such as gravity, visual object interactions and atomic structure integrity. ERP should mimic or emulate the physical objects in the real world.

Another aspect is that the reconstructed pathway using ERP can only reconstruct 2 data types in the pathway: 5 sense objects and hidden objects. Pattern objects and activated element objects can't be reconstructed using ERP.

The reconstructed pathway from a forgotten pathway will not change any data in memory. It only serves as a benchmark or a guide to give the robot a better idea of how to reconstruct forgotten pathways from sections of pathways in memory. FIG. 52 is a diagram to illustrate how ERP is used to help the AI program reconstruct sections of pathways in memory together. Pathway4 is a forgotten pathway in memory-sections of data in the pathway are deleted (pathway 162). The next step is to use ERP and reconstruct the original data in pathway4 (pathway 168). Finally, sections of pathways from memory are combined to fabricate an original pathway4 (pathway 164). The reconstructed pathway 168 serves as a benchmark 166 to the reconstructed pathway 164. This means during the process of reconstructing pathway 164 from different sections in memory, the AI program is using the reconstructed pathway 168 using ERP as a benchmark to help and guide the reconstruction process.

Referring to FIG. 52, at the end, only reconstructed pathway 164 will be used to control the AI program. Only pathways or sections of pathways in memory can be followed to take action in the future. The ERP will not change any data in memory and reconstructed pathway 168 will be deleted.

Another feature of ERP is that it can also construct what the actual event is in the future (frame-by-frame). Predicted future pathways in memory are constructed from taking sections of pathways in memory and stringing them together. These predicted future pathways are based on the robots past experiences and doesn't necessarily reflect the exact frame-by-frame events that will occur in the future. The ERP can be used to change predicted future pathways according to the current situation. This will result in future pathways that will look exactly to the pathways sensed by the robot in the future. Referring to FIG. 52, current pathway 167 is the actual 5 senses experienced by the robot. Reconstructed pathway 168 takes the data from pathway 164 and changes it according to current pathway 167. For example, if the current pathway 167 experiences a “blue” apple and pathways in memory only have experiences of a “red” apple, then the ERPs will change the color of the apple from red to blue. Other features of the apple can be changed as well depending on the current pathway, including: 3-d shape, size, length, smoothness, weight and so forth. The ERP will be used to change the predicted future pathway according to the current pathway 167 so that predicted future pathways will be the exact future pathway experienced by the robot.

Predicting the Future for Infinite Possibilities Using the Time Machine

In addition to hierarchical data analysis and the external reconstructive programs, the next method to predict the future for infinite possibilities is to include the help of the “time machine”. The time machine is explained in detail in patent application 61/028,885. The time machine is a virtual world that contains an emulated environment of the real world. All physical and non-physical properties in the real world are copied into the time machine. This would include gravity, atomic structure of objects, realistic object interactions, physic laws and so forth.

There are some events in life that can't be predicted. For example, if the robot doesn't know a meaning to a word and wants to look up the definition on the internet, the robot will not be able to predict what the results of the search is. If a teacher plans to give the robot a math equation to solve, the robot will not be able to solve the problem until after the math equation is recognized. Is it possible to predict what that math equation is before the math teacher writes down the equation? The answer is no. I use the time machine along with the methods above to solve the problem of predicting the future for unpredictable future events.

Future pathways are constructed by using hierarchical data analysis of universal pathways in memory. The future pathways are then ranked on which specific pathways are most likely to occur. Next, the future pathways use the external reconstructive programs as a benchmark to create more accurate and realistic future pathways. Then, universal pathways are included with linear pathways to create strategy pathways to predict infinite possible future events. The next method to predicting the future for unpredictable future events is to include the time machine.

The Internet

There are added features in the time machine that can be used to predict a future result based on pathways in memory. Some of these features are: embedded software, the internet, machinery, computer hardware and integrated circuits. All content over the internet are emulated inside the time machine. The internet must be created accurately and realistically. If the internet was searched in the time machine, then the results of the search should be exactly the same as the search done in the real world (the time machine is a virtual world of the real world).

If the robot predicts that it will access the internet to look for a definition of a word, then it can access the internet through the time machine. The search results done in the time machine will replace the unpredicted event in the future pathway. This is important because sometimes data in certain pathway states have to be known first before it can predict the next step.

Physical and Non-Physical Object Interactions

Another feature is the realistic targeted environment of the time machine. If someone wanted to predict how a golf ball will land in the future based on different swings, it would be difficult to predict the precise location the ball will land. The pathways in memory might have an estimated result of a swing, but the robot will not know until the results of the swing actually occur. The time machine provides a targeted environment to provide additional information to the future pathway so that it can see the results of a swing. This additional information is called a predicted result. The predicted results will include the actual results of a particular swing—what will each frame look like after that swing and where will the ball land?

The predicted results will be added to the future pathway for unpredictable events. These unpredictable events will be replaced with the predicted results and the future pathway will believe that these predicted results actually occurred. These predicted results will also activate element objects (conscious thoughts) that will result in more specific future pathways.

Referring to FIG. 53A, node 170, node 172 and node 174 are unpredictable. The time machine will be used for these specific areas in the future pathways. Notice that the universal pathway is structured in a hierarchical manner. Tasks T1, T2, T3, T4, T5 and T6 are all prominent data in the universal pathway. FIG. 53B is an illustration of a specific future pathway. Node 174 is unpredictable and the outcome can't be predicted. The time machine will be used to find a predicted result for node 174. Even though node 174 is unpredictable it is somehow connected to hierarchical task T2. Imagine if T1 is represented by “put the C block on the floor” and T2 is represent by “put the B block on the C block”. If there are sub-tasks in T I that are impossible to predict based on the universal pathway, the AI program will still understand that T2 is the next “distant” step (hierarchical organization of future pathways).

In the movie Jurassic Park, the mathematician showed a female character in the movie an example of an unpredictable event. He put a water drop on her hand and asked her to predict where that water drop will move. He stated that the water drop can move in any direction depending on the ridges on her skin, hair on her hand, movement of her hand, the wind speed and gravity. To sum up what he was demonstrating, the water drop is unpredictable in terms of where it will move next.

Now, imagine that the time machine was used to predict the various outcomes of the event. Based on the pathways in memory of movement of the hand the AI program can use the most frequently used pathways. The time machine will show the results of the water drop after each movement. If the goal of the event for the robot is to make the water drop slide to the left of the hand then all pathways, in addition to the predicted results, that lead to the water drop sliding to the left will be good future pathways. The time machine provide the predicted results for each pathway and the pathways that best meet the goals of the robot will be selected as good future pathways, while the pathways that doesn't meet the goals of the robot will be discarded.

Sometimes there are non-physical or invisible objects that need to be predicted. Things like predicting the chemical reactions of atoms. The time machine can also have realistic predicted results for chemical reactions of atoms. If the robot wants to predict the results of how atoms interact then it can use the time machine to get a predicted result for certain atom interactions. When doing science experiments physic laws such as gravity, weight, mass and so forth are important. Only the environment stored in the pathways are emulated in the time machine. If the pathways contain specific things like a table or a scale they will be emulated in the time machine and not “all” objects in the pathways. The time machine will only emulate a targeted environment. If the pathway is using a computer, the time machine will emulate a computer. If the pathway is accessing the internet, then the internet (along with a computer) will be emulated. If the pathway is playing golf, then the golf course and all golf equipments will be emulated. If the pathway is doing a science experiment, then all objects involved in the experiment will be emulated.

Predicting the Future Using Logic Learning

It's one thing to have the ability to predict the future for a math equation or the ABC block problem, but what about tasks that takes days, weeks, months, years, decades or centuries? How will long tasks that takes 100's of years to accomplish be predicted. The answer is through logic learning. The next method to predict unpredictable events is through logic learning. We learn to plan a task or we learn to outline the steps to accomplish a task. If it takes many years to cure cancer we have to learn to plan the days and months and years that we need to experiment in order to find a cure for cancer.

This is why intelligence from books and magazines are so important. The intelligence in pathways can form any type of intelligence depending on what knowledge was learned from our environment. Pathways can even form intelligent pathways to predict the future or to plan out the future. For example, the robot can conscious think of a way to cure cancer by treating future planning as a task. The robot can write down on a notebook exactly what his plans are in terms of research and development into a cure for cancer. The notebook will contain his work schedule for years and years. It will outline the day-to-day activities the robot has to work in order to accomplish his goals.

Of course it is important to plan a task first, but actually following the plan and using a form of trial and error to correct the robot's daily schedule is also important. This is why logic learning should be a bootstrapping process, wherein the robot has to learn from past experiences. First, the robot learns simple type of future planning. Then, it will build on pre-existing knowledge with more advance future planning.

The ABC block problem is predicted because of logic learning. Logic learning is actually activated element objects via words and sentences. The conscious activates each step to solve the problem. Words and sentences are used to represent an event. Repeated states in terms of visual objects can also represent an event. If the robot sees a picture of the C block on the floor and the B block is on the C block and the A block is on the B block, then that picture can represent an event.

Planning Future Events Example

Learning how to strategies and plan is a valuable asset to predicting the future. I will be using the legend of Zelda for the Nintendo Wii to depict why learning how to plan is so important. The objectives in the Zelda game are non-linear. What this means is that you don't have to past level 1 in order to get to level 2. The levels are structured in such a way that the levels are given to the player through characters in the game. For example, the princess in the emerald palace will give the player a task to accomplish and this task is considered level 1. Next, a villager will give the player a task to accomplish and that will be considered level 2. This will go on and on until all the levels of the game are accomplished. Many form of logic is needed to beat the entire game. I would say that only a robot with human-level artificial intelligence will be able to past the entire game.

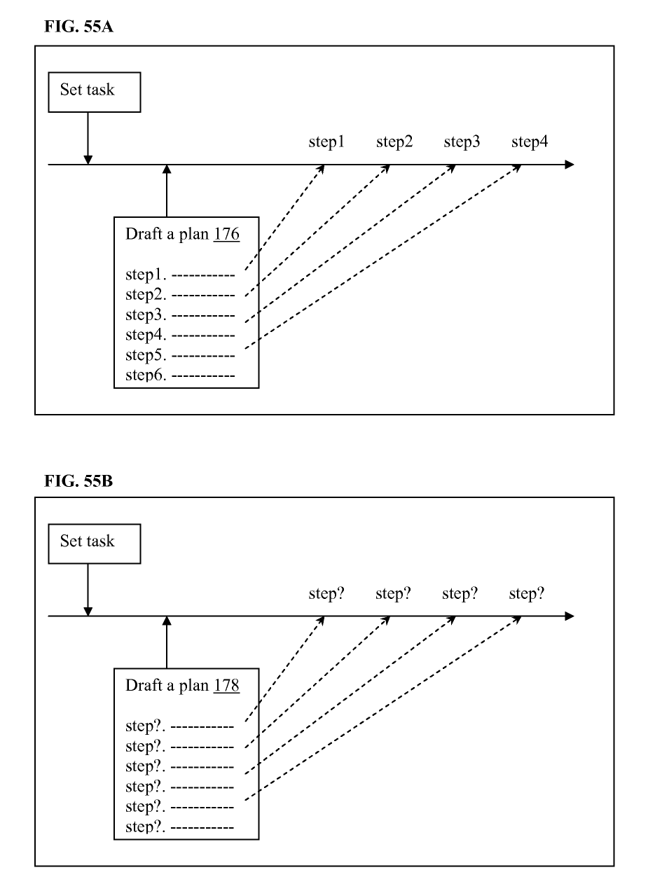

Referring to FIG. 55A, step 176 is very important to planning the future for the game Zelda. Step 176 is a task to write down a plan to beat the Zelda game. This would include writing down (on a notebook) the objectives of the game, the rules of the game, the overall strategies in the game, the strategies for each level in Zelda, the controls of the game, the actions the robot will take in the future (planned on a calendar) and so forth. By brainstorming and writing down all relevant plans and objectives on a notebook, the robot can use the notebook as reference to take action in the future (capturing sequential future events can also be recorded in any “fixed tangible media” such as a book, report papers, a video, an audio, a calendar, a computer file, a hologram, a canvas and so forth).

The calendar in the notebook is used to plan out the day-to-day tasks the robot has to accomplish in order to pass the entire Zelda game. It took me about 4 weeks to actually beat the game. The plan might include a full month of strategies. For each day the robot will pick up the notebook to see what it has to accomplish. Sometimes certain tasks are too difficult and require the robot to make changes in the plan. Planning tasks on a calendar is not an exact future prediction of the day-to-day activities of the robot, but it is an estimated day-to-day activities of the robot. Certain predicted plans might be harder to achieve or impossible to achieve and requires modification in the plan.

These plans are no different from how movie producers plan out the schedule to making a movie or how business man plan out there next projects. By setting our goals and planning out a strategy we can project what we have to do in the future to accomplish a goal. The planning is actually forming intelligent pathways in memory to predict the future. The more we learn to plan the better our future predicts will be.

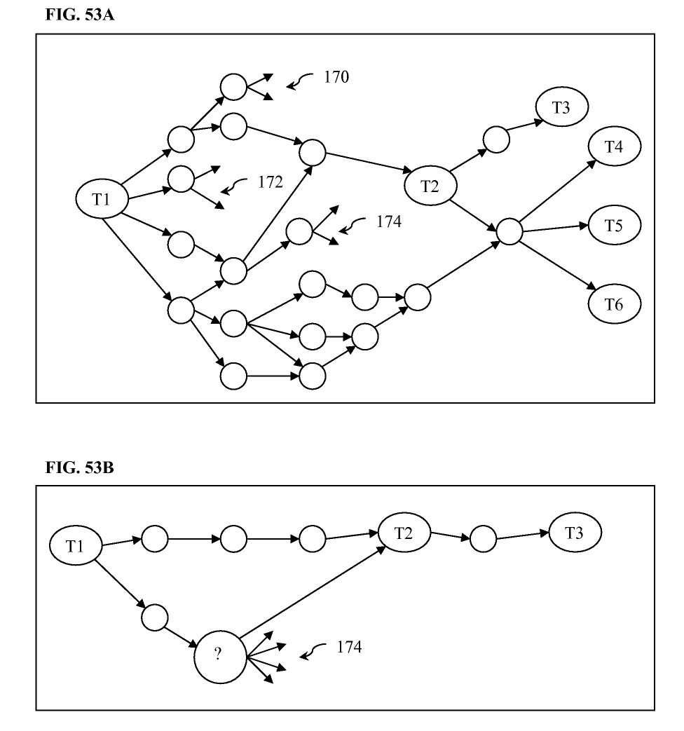

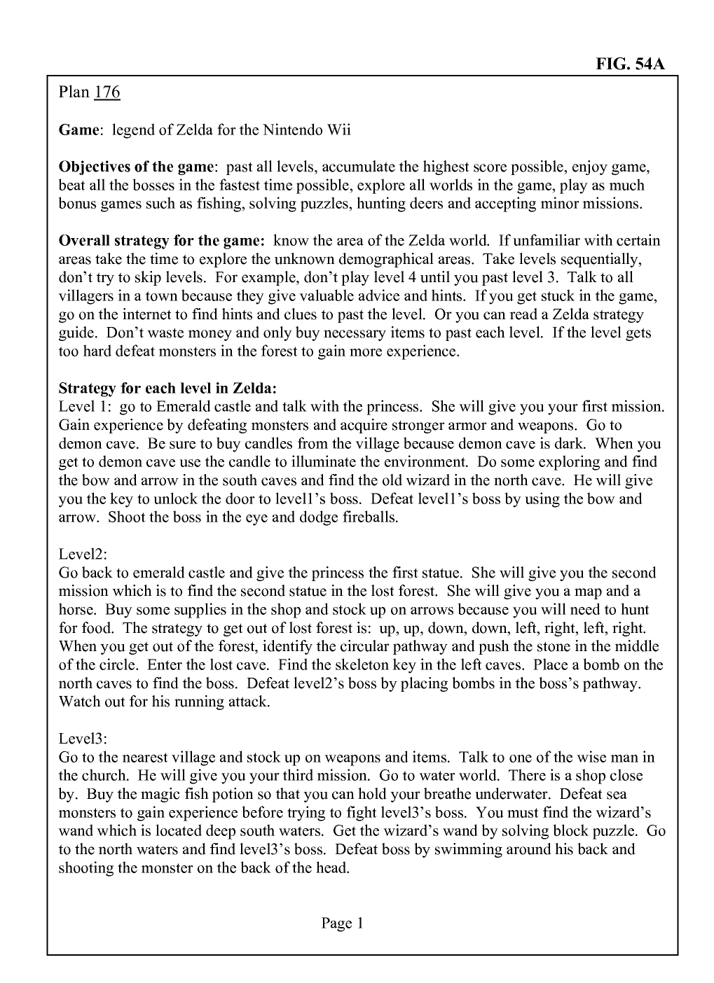

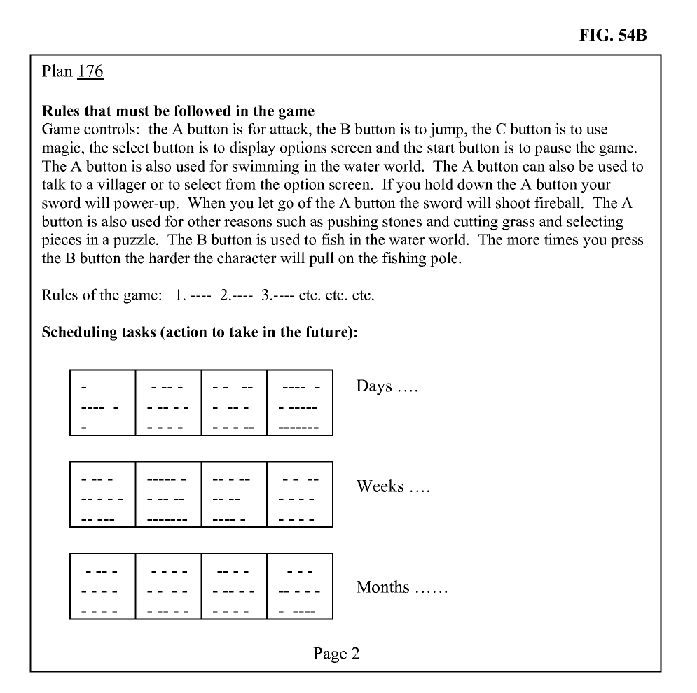

For example, in FIG. 55A and FIG. 54A-B, the robot has made a conscious decision to past the game of Zelda (step 176). Next, the robot will set up a plan (step 176). The plan will have patterns to future actions the robot will take. The AI program will look at the content in the plan and the future pathways and see there are patterns. Fore example, if the first step in the plan is to past level 1, and in the future the robot passes level 1, then the AI program can link the first step with the future event: past level 1. If the second step in the plan is to past level 2, and in the future the robot passes level 2, then the AI program can link the first step with the future event: past level 2. By the time, the AI program finishes searching for patterns, the plan step 176 will have many patterns to future events in the pathway.

The key here is that instead of predicting the entire 4 weeks of playing the game of Zelda frame-by-frame (a very difficult task), all the robot has to do is predict task 176. If the robot can predict the planning of the Zelda game (task 176), then the patterns will reference task 176 to all future events in the pathway. Let's say that it took the robot 1 hour to finish task 176. At the completion of task 176 the robot has finished outlining all plans and actions to beat the Zelda game for the next 4 weeks. This means that if the robot can predict task 176, then it has also predicted 4 weeks into the future.

Logic learning is used in this example to depict how intelligent pathways can predict how the robot will act in the future—the smarter the plan, the better the future prediction. The robot can actually plan out a 200 year research project in less than 1 month. If the plan is sufficient enough patterns will help link the contents in the plan to future events for the next 200 years. These future predictions might include the day-to-day activities the robot has to accomplish for the next 200 years.

The robot will have a better idea of the patterns between the steps in the plan and future events if the robot encounters many similar planning/acting situations. After many training of planning/acting situations, the robot will form a universal pathway in memory that can handle “any” situation. FIG. 55B illustrates a universal pathway that will cater to all situations. Plan step 178 is a universal planner, given a specific goal, will plan out a strategy on a notebook. The content in the notebook will have patterns that will link certain steps to certain future events. Since this is a universal pathway the steps in the notebook (plan step 178) are unknown and the future events are also unknown. The robot will constantly be using the notebook as reference to remind itself what it has to do in the future.

Extra note: once the future pathway is plotted the AI program can use the reconstructive methods (ERP and the time machine) to fill in all the missing parts that the future pathways don't include such as specific states in the future pathway and details of visual objects in the future pathway.

Frontier Research

Another method of predicting the future for unpredictable outcomes is to modify the data in the robot's 5 senses. For example, instead of eyes that can see 2-d movie sequences, the robot can have eyes that can see 3-dimensional objects. The movie sequence is the same, but the transaction from 2-d images to 3-d images can greatly increase the intelligence of the robot. The robot will have the ability to scan a visual object and store this object (3-d) in memory. When I say 3-d object I don't mean only external 3-d shape, but internal 3-d shape as well. This means if the robot is interrogating a suspect it can scan the suspect's brain and know exactly what the suspect will say or do in the future. Every pathway and chemical reaction is plotted from the suspect's brain (3-d model of the brain). Anything that the suspect is thinking of, the robot already knows.

By comparing this pathway and other similar pathways in memory the robot can find patterns and these patterns will create a universal pathway that can predict the exact actions and words of a person under investigation. The pattern recognition will be much harder to find compared to 2-d movie sequences.

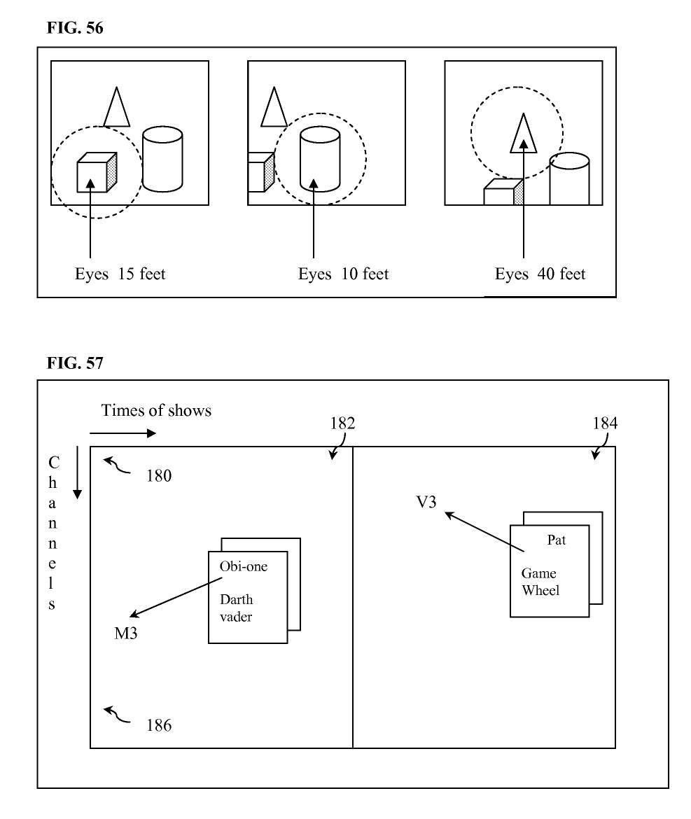

Referring to FIG. 56, there are great similarities between 2-d movie sequences and 3-d movie sequences. For one thing 3-d movie sequences will still have eye focus, wherein the robot has to focus on certain visual objects before an adequate 3-d model will be created in each frame. The focus area represents the area that is clear to the robot, while the peripheral vision will be blurry. Visual objects located in the robot's peripheral vision will have less details regarding its 3-d model. The reason for this is because there is too much information to store; and eye focus limits the amount of information stored in each frame. FIG. 56 illustrates the robot with 3-dimensional movie sequence. Each visual object will have a 3-d shape including internal atoms of each shape.

Planning to Interrogate a Suspect Example

Knowing how a suspect will think and act is extremely hard because there can be infinite possibilities. However, we can learn to predict how they will act and what they will probably say. Using this form of logic, the conscious will anticipate the outcome of what the suspect will probably say or do. The more the robot interrogates suspects the smarter it becomes in terms of predicting what they will probably say or do. Teachers will probably teach the robot what are the objectives of interrogation. One method is the good cop/bad cop method to extract information from the suspect. If that method doesn't work the robot can use another method. Goals are usually set; and lessons in criminal school will guide the robot to predict what the suspect will probably say and do. Using certain techniques learned in criminal school the robot can extract information from the suspect.

The interrogation of a suspect is just one example of how the robot uses logic to learn how to predict the actions of a human being. If we apply this to all forms of predicting the future actions of a person then you got a universal pathway that can predict the outcome of what a person is going to say and do under any circumstances. If the robot wanted to predict what a friend is going to say to him during a party, then he has to use logical skills learned in school to predict what the actions or topics the friend will bring up during the party. If the robot wanted to predict what a professor is going to say to him after Acing an exam, then he has to use logical skills learned in school to predict what the actions and topics the professor will bring up during the meeting.

Another example is if the robot had to predict the actions and behavior of specific pedestrians crossing the street. We can learn how to judge pedestrians from lessons in driving school. Teachers can say: most likely, pedestrians will walk across the street; old pedestrians will walk slower than young pedestrians; children are most likely guided by a parent when crossing the street; when there is a school sign that means many children will cross the street; when the street light is blinking that means most pedestrians will run across the street; pedestrians will J-walk frequently; when the street light is red pedestrians will not walk across the street; when the street light is green pedestrians will walk across the street.

This knowledge is what will help the robot to predict future actions of pedestrians when they are crossing the street. Other times it's by observation and analyzing certain behaviors. For example, in the future, if talking with the cell phone and walking on the street is a trend then the robot might learn a new rule: pedestrians walk across the street while talking with a cell phone when the light is green. Learning to observe and changing the rules based on observation is also an important tool to predicting the future.

Predicting a Math Problem Example

One strong talent I had in college was having the ability to predict what types of equations will be in my math exams. Based on all the knowledge that was learned and all the assignments that were given in my math class, I was able to predict what types of equations will be in my math exam. The teacher might give the class hints here and there on what types of equations will exist in the exam.

This is important because if the robot wants to predict all the equations that will be in a math exam it will need logic and knowledge from past experiences to rule out unlikely equations. For example, if the robot was in a calculus 1 class, he knows that the exam will not include simple addition or subtraction. He can also rule out equations given in geometry or algebra. Only calculus equations or things covered in calculus courses will be in the math exam. Discrete math equations will also not be in the math exam. Certainly, no equations from calculus 2 or calculus 3 will be given. By using logic and deduction skills the robot can rule out what the future outcome of an event will be and try to narrow down the possibilities so that it has a better idea of the future outcome.

Logic and deduction skills will narrow the choices of possible math equations. Now, the robot can use specific universal pathways to cater to the remaining possible math equations. For example, a universal pathway can be used to solve only equations covered in the semester. Universal pathways serve as strategies to solve “any” math equation.

Other Topics

TV Guide Example

Memories that are experienced from the environment can also be recalled and reevaluated based on intelligence. For example, I frequently look at a TV guide provided by my weekly newspaper. Referring to FIG. 57, in the TV guide is 1 week of programs listed by channels (columns) and time (rows). As I read the TV guide the meaning of each program will activate in my mind and these meaning will be represented as 5 sense objects: sight, sound, taste, touch, and smell; hidden objects or pattern objects. As I recognize certain words I am storing the meaning in that particular location in the movie sequence. For example, in pointer M3 I recognized the movie Star wars. Pictures in the movie: Star wars will pop up in my mind. A picture (or movie sequence) of Obi-one fighting with Darth Vader is stored right next to the area that I recognized the word: Star wars. In pointer V3 I recognized the game show Wheel of fortune and a picture of Pat or the spinning wheel is stored in that area.

The next time that I want to know what shows are on TV a pattern will extract the memory of reading the TV guide. This pathway in memory is forgotten so the exact images and the exact words I read are not stored in this pathway. However, the information in this pathway is sufficient enough to analyze using logic (another intelligent pathway to analyze memory pathways). As the pathway is recalled, the only thing I remember about the TV guide is an average image of what the pages looked like. No one particular area in the TV guide has an exact and clear picture. On the first page, on the left-bottom corner I see a picture of Darth Vader fighting with Obi-one and on the second page, on the middle top corner I see a picture of Pat. The Darth Vader fighting with Obi-one indicates the movie Star wars. The picture of Pat indicates the show Wheel of fortune.

What about the time and the channel of each show? That is where a different intelligent pathway is used to determine the time and the channel for each show. This intelligent pathway is created to analyze a situation. In this case, it's analyzing a forgotten memory. I know from past experiences that the rows on the TV guide displays the time that each show will begin and end. Pointer 180 is set at 7 am in the morning, pointer 182 is set at 1 pm and pointer 184 is set at 2 am. I also know from past experiences that time is usually arranged in a left to right manner. From the position of the Star wars picture I can conclude that the show will start at 8 am in the morning. Since movies normally last 2 hours, I can also conclude that the Star wars movie will end at 10 am. The picture of Pat is located at the second page at the middle-top corner so I can conclude that the show will begin at 6 or 7 pm and since game shows last for one hour the wheel of fortune show will end at 7 or 8 pm.

Now, let's analyze the channel that each show will be in. I know that the channels are displayed on the columns on the TV guide. Pointer 180 is channel 3 and pointer 186 is channel 76. Judging from the position of the Star wars picture I can conclude that the Star wars movie will be in channel 43 or 45. For the wheel of fortune show, judging from the position of the picture I can conclude that the game show will be in either channel 6, 7, or 8.

This example just demonstrates the importance of movie sequences stored in memory. Logical thoughts and common sense behavior are not limited to only computer text alone (current chatbots), but from movie sequences, sound words, hidden data, intelligent pathways and so forth to come up with logical thoughts. This example is also one way that I use to come up with intelligent thoughts. Most humans also use this type of method to think and act. However, there might be slight differences and each individual will vary based on their past experiences.

Universal AI Program Applied to all Machines

The reason for this patent application is to protect the processes and functions of the human artificial intelligence program. This section will deal with alteration of the present invention. The HAI program can be applied to all machines or computer software including: cars, trucks, forklifts, planes, electronic devices, vacuum cleaners, lawnmowers, fruit pickers, sewing machines, computer systems, operating systems, search engines and so forth.

AI Cars

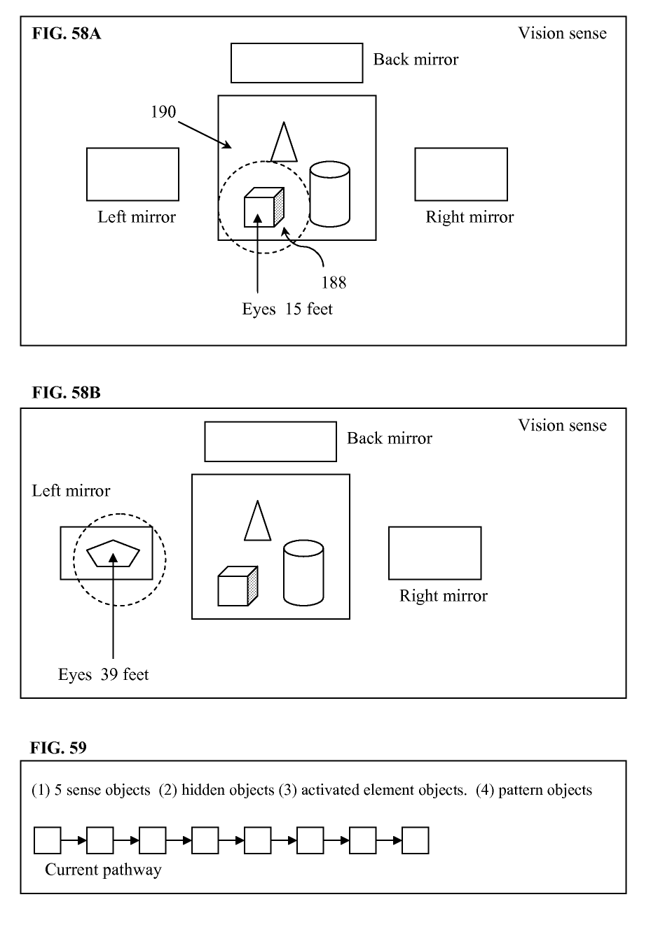

FIG. 58A is a diagram depicting the vision sense from the AI car. Vision for human robots is different from vision for an AI car. A camera will be mounted on the front of the AI car and comprises: eye focus 188 and peripheral vision 190. The vision sense will include the front camera, the back mirror, the left mirror and the right mirror. Additional mirrors are included because the AI car has to keep track of its surroundings. As the AI car moves the mirrors will capture the movie sequences of its environment just like the mirrors in a real car. Every millisecond, each camera (or mirror) will capture 1 frame from the environment and stored in the current pathway.

The eye focus 188 is used to focus the AI car's attention to specific areas in the front camera. The eye focus 188 will have the same type of properties as a human eye. The distance between the front camera and an object will determine the 3-dimensional shape of that object. A 3-d grid will wrap itself around the 2-d image. The eye focus will only focus on certain objects at a given state in a pathway. For example, the eye focus can be looking at a traffic light or the eye focus can be staring at several pedestrians or the eye focus can be staring at a street sign. In FIG. 58B, the eye focus is staring at the left mirror at a pentagon shape. The back mirror, left mirror and the right mirror are not stored in memory unless the AI car decides to stare at these mirrors. Only the front camera is stored in the current pathway at all times (most specifically, the eye focus 188 and its peripheral vision 190). Actually, if the robot chooses it can stare away from the front camera and the front camera will not be stored in the current pathway.

In FIG. 59, the current pathway will store the 4 data types in the pathway as they occur: 5 sense objects, hidden objects, activated element objects and pattern objects. In this AI car the 5 senses are slightly different from a human robot. The vision sense is a little different because it includes 3 additional mirrors: back, left and right mirrors. The sound sense will probably come from a microphone in and outside the car. The internal instructions will also be different from a human robot. The car might have external and internal sensors built such as outside the car or inside the car. These sensors include feelings of pain and pleasure. If someone throws a rock on the car the rock will cause the car to feel pain in the spot that was hit. If someone slams the door too hard the car will feel pain. If someone yells at the car the microphone will cause the car to feel pain. If the camera was looking at the sun the car will feel pain. These types of pain and pleasure are necessary in order to learn and to adapt.

All instructions from the car will also be recorded in the current pathway as they occur. If the driving wheel was turned to the left the data will be recorded in the current pathway. If the air conditioner was turned on the data will be recorded in the current pathway. If the foot pedals (both accelerate foot pedal and breaks) are pressed the data will be recorded in the current pathway. These instructions are important because when the AI car searches for the optimal pathway in memory, the instructions in the optimal pathway is the actions the AI car will make.

Learning Basic Grammar

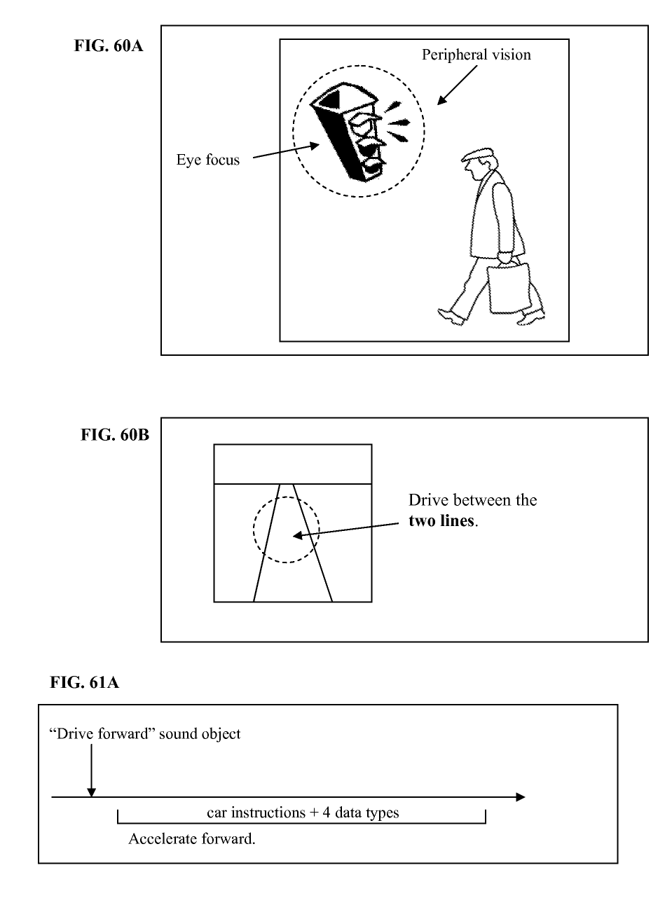

Referring to FIG. 60A-B, the first step for the AI car is to learn basic words and sentences. The AI car must associate a variety of visual object to sound words. For example, the AI car has to know that the sound “traffic light” is referring to the visual traffic light in the front camera, the sound “two lines” is referring to the two lines on the road, the sound “pedestrians” is referring to the visual pedestrians on the street, the sound “street sign” is referring to the visual street signs on the road. All these sound words should be associated with their respective visual objects. The way that the AI car learns these associations is through the lessons described in parent applications for the human artificial intelligence program.

In this case, there should be a teacher that will supervise the learning. The teacher will be in the car guiding the AI car's eye focus to a certain visual object and saying: “traffic light” or “this is a traffic light”. The AI car will associate the words (or words from a sentence) to the visual object. Learning to control the eye focus can also come from sentence commands. For example, the teacher can say: “focus on the traffic lights”, the pattern that will occur next is the AI car moves the front camera toward the traffic lights.

Supervise Learning

For a human robot, the parent will guide the human robot to walk and the guide will create pathways in memory to walk. For an AI car, a teacher will drive the car and the AI car will store the instructions in memory. This is how the AI car will have pathways to turn a corner or to drive forward or to stop the car or to turn on the air conditioner.

Actions and hidden objects also have to be learned by the AI car. Things like: drive towards the tree” must have the meaning of locating the tree and accelerating the AI car towards the tree. Meaning to words like: towards, slowly drive, drive fast, stop, next to, on top, on the side, from the R1 to R2, here, there, over there and so forth must be understood.

Sentence Commands

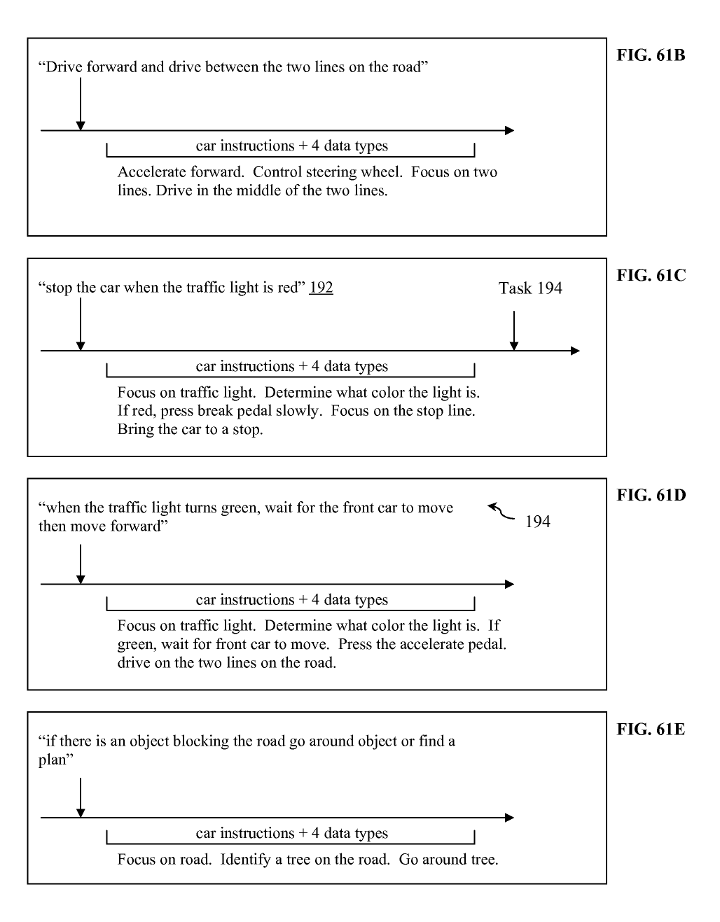

After a basic grammar is understood by the AI car, the next step is to include sentence commands to instruct the AI car to take an action. FIGS. 61A-E are examples of sentence commands. The top of the pathway are the sentence commands and on the bottom of the pathway are the car instructions and the 4 data types: 5 sense objects, hidden objects, activated element objects and pattern objects. In FIG. 61A, the sentence is “Drive forward”. The sentence is a sound object and comes from the teacher's mouth. After the sentence “drive forward” is given the teacher will accelerate the car forward. The AI car will create pathways in memory by recording the sentence and the instruction that comes after the sentence. As more and more training is given the pathway becomes stronger and stronger. After the strength of the pathway reaches a threshold the pathway will be automatic. If the teacher says: “drive forward” the AI car will automatically drive forward without the supervised instructions from the teacher.

More complex sentences can be learned. In FIG. 61B, the sentence is: “drive forward and drive between the two lines on the road”. The action will result in the car accelerate forward, the eye focus will concentrate on the two lines on the road, the steering wheel will turn based on where the two lines are located. These instructions are learned by the supervised training from the teacher. The teacher will be using words and sentences to teach the AI car and at the same time he will do the movement of the eye focus and the controlling of the car. The AI car will associate certain words with certain internal controls and find patterns. After many repeated supervised training the pathways will contain patterns to do things automatically. The next time the AI car hears the teacher say: “drive forward and drive between the two lines on the road”, it will drive forward and drive between the two lines on the road without the supervised training from the teacher (automated action from the command sentence).

Sequence Tasks

The pathways can be more complex by combining tasks together in one pathway. In FIG. 61C-D, there are two sentences: “stop the car when the traffic light is red” 192 and “when the traffic light turns green, wait for the front car to move then move forward” 194. The sentences are stored in sequences in the pathway. First, sentence 192 is given and the instructions from sentence 192 will occur. Finally, sentence 194 is given and the instructions from sentence 194 will occur. These types of task sequences can be as long as the teacher wants it to be (lengthening of pathways is discussed in parent applications).

Universal pathways should be created based on many similar pathways. For example, in FIG. 61E, the sentence: “if there is an object blocking the road go around object or find a plan”, is a universal pathway because the object in the sentence can be anything. Object can be a tree, a rock, another car, a house, a deer or a bus. Patterns will be established in terms of what actions it has to do to go around the object. Sometimes the object can be big or small, the universal patterns will decide what instructions the AI car has to use to go around the object.

The sentences used in FIGS. 61A-E can be represented in a fuzzy logic manner. For example, the sentence: “turn to the left and drive between the two white lines slowly” can be represented as: “slowly, drive to the left and follow the two white lines”. These two sentences are constructed differently, but the meaning behind them are exactly the same. Representing language in a fuzzy logic manner is covered in detail in parent applications.

Planning Routes

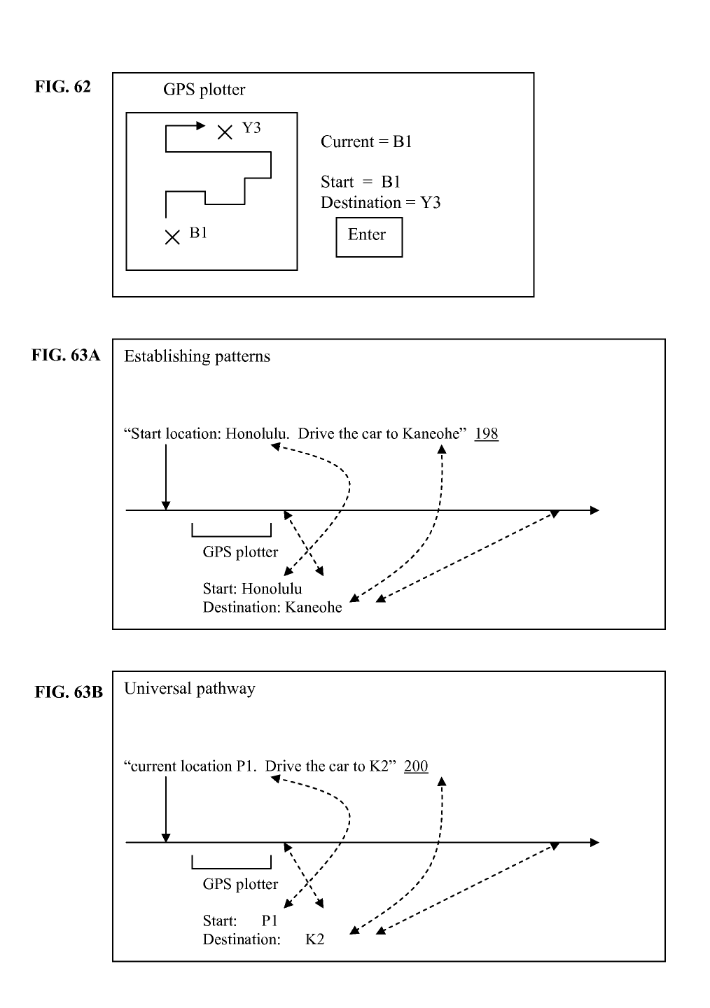

Since human beings are inefficient when it comes to planning routes I decided to include an external function called the GPS plotter (FIG. 62). The GPS plotter basically uses satellite technology to plot the shortest route from a start location to a destination location. Once the start location is entered and the destination location is entered the enter key is pressed and the program will plot the shortest path from the start location to the destination location.

This GPS plotter is graphed into the AI car as a sense. Just like vision sense and sound sense the GPS plotter is another sense. During the supervised training the teacher will plot the start location and the destination location on the GPS plotter and hit the enter key. All information in the GPS plotter will be stored in the current pathway.

The AI car's job is to find patterns between sentences given by the teacher and the GPS plotter. In FIG. 63A, all words in the sentence will establish itself with contents in the GPS plotter. This will include Honolulu (a city in Hawaii) and Kaneohe (another city in Hawaii). The Honolulu word in sentence 198 will create a pattern with the GPS plotter's Start location: Honolulu. The current location is automatic and the GPS plotter is always showing the AI car's current location. The Kaneohe word in sentence 198 will create a pattern with the GPS plotter's destination location: Kaneohe. These patterns will also establish connections to visual sense of Honolulu and Kaneohe—the AI car might recognize the street sign with the words Honolulu or the AI car might recognize the city Honolulu from the environment. These patterns are established between the sound sentence and the different senses of the car. The current location of the AI car will also establish patterns with the routes that the GPS plotter will travel.

Referring to FIG. 63B, a universal pathway will result when many similar pathways are encountered. The patterns in the pathways will establish that the variable P1 in sentence 200 is inserted into the Start location in the GPS plotter and the variable K2 in sentence 200 is inserted into the destination location in the GPS plotter. Patterns will also establish that the enter key in the GPS was pressed.

The AI car has to be versatile and changes its instructions based on specific meaning to sentences. For example, if the destination location was plotted as the library and during the route to the library the driver changes his mind, then the AI car has to find the patterns to this situation. If the driver said: “I change my mind, I want to go to the supermarket instead”, then the AI car has to confirm this by asking the driver a question such as: “are you sure you want to go to the supermarket instead of the library?”. If the driver says yes, then it is confirmed and the AI car will plot a new route from the current location. Another factor is that if the driver changes the destination location too much times the AI car has to either ignore the driver's commands or ask why questions. These things are all done through years and years of learning from a supervised teacher. The learning will create patterns within similar pathways creating universal pathways.

More advanced topics such as identifying danger on the road, recognizing obstacles, traffic jams, car accidents, forbidden routes or multiple destination locations can also be learned. Building an AI car that can talk and converse with human beings at a human-level is harder to achieve. Grammar structure and output of sentences from the AI car are not predefined, but are learned from school teachers. These abilities (talking and giving speeches) take years and years of learning. These topics are further discussed in the human artificial intelligence program (parent applications).

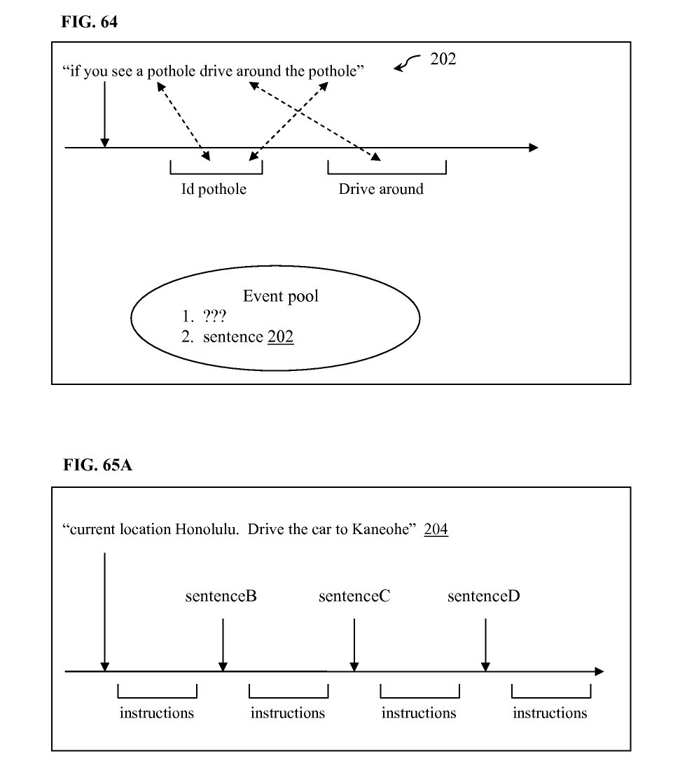

Rules are also stored in memory through patterns. In FIG. 64, the patterns establish that the words: “pothole” is referencing the visual image of a pothole on the road. The words: “see a pothole” is referring to the identification of the pothole in the environment. The words “drive around the pothole” is referring to the visual sense and the hidden objects that result from driving around the pothole. The patterns will establish a sentence pattern: if R1 then R2. In this case, if the AI car recognizes R1 then R2 will happen in the future. Since this rule is repeated many times and that the occurrence of the if-then statement is not consistent (not occurring at a specific state in a pathway), the sentence 202 is put into an event pool where the AI car knows that this rule might or might not happen during driving.

Conflicting rules are also learned through logic and analytical skills. These topics are discussed in parent applications.

Building Conscious Thoughts in the AI Car

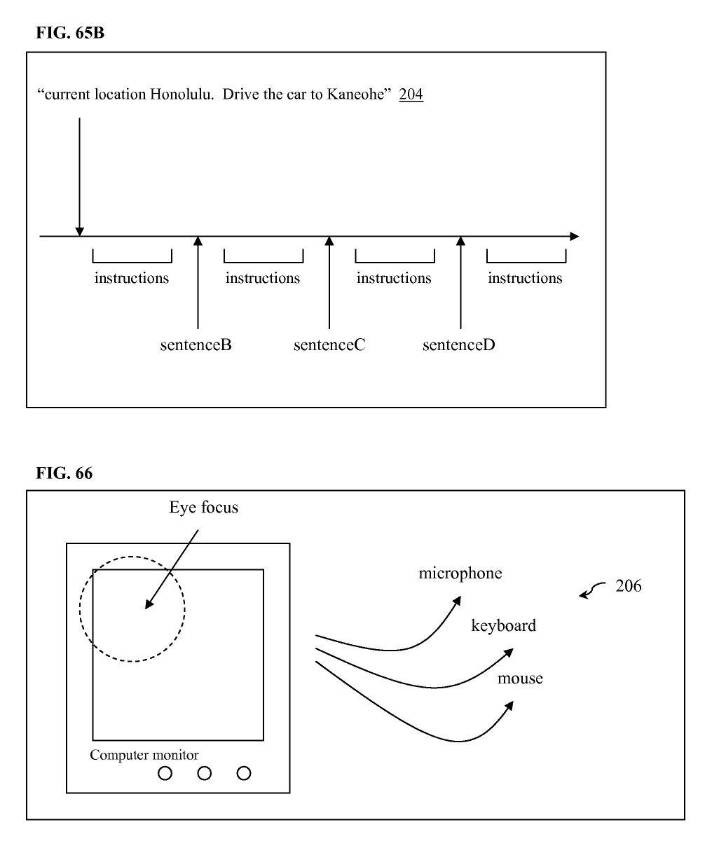

Just like the human robot, the AI car also has activated element objects. When it recognizes certain target objects in memory it will activate certain element objects. These activated element objects are the conscious of the AI car. FIGS. 65A-B illustrates how conscious thoughts are activated in the AI car's mind. FIG. 65A is a supervised training by a teacher. Sentence 204, sentenced, sentenceC and sentenceD are said by the teacher. The teacher is also driving the car and the instructions and the sentences are stored in the current pathway. FIG. 65B is an unsupervised pathway. SentenceB, sentenceC and sentenceD are so strong in the pathway that they activate automatically without the teacher's voice. The driver in the AI car says sentence 204 and the AI car activates sentenceB, sentenceC, sentenceD and all the instructions in between automatically. This is how the pathways in memory transitions from supervised to unsupervised.

AI Operating Systems

The AI operating system works pretty much the same way as the AI car. The vision sense in the operating system is the computer monitor (FIG. 66). Since a monitor is 2-dimensional then the movie sequence will only include 2-d frames. There will be eye focus as well to concentrate on specific areas on the computer monitor. Sound objects will enter the AI OS through a microphone. Other senses can also include the keyboard, mouse or touch senses on the computer monitor (pointer 206).

A basic grammar has to be established such as: icon, folder, folder icon, type text, move folder, arrange files, search for files, display options and so forth. Hidden objects (or action words) have to be understood as well such as next to, 5 inches from the table icon, loud noise, run, walk, around, on top of, underneath and so forth. Actually, the computer monitor is 3-d because a videogame or movie is represented in 3-d.

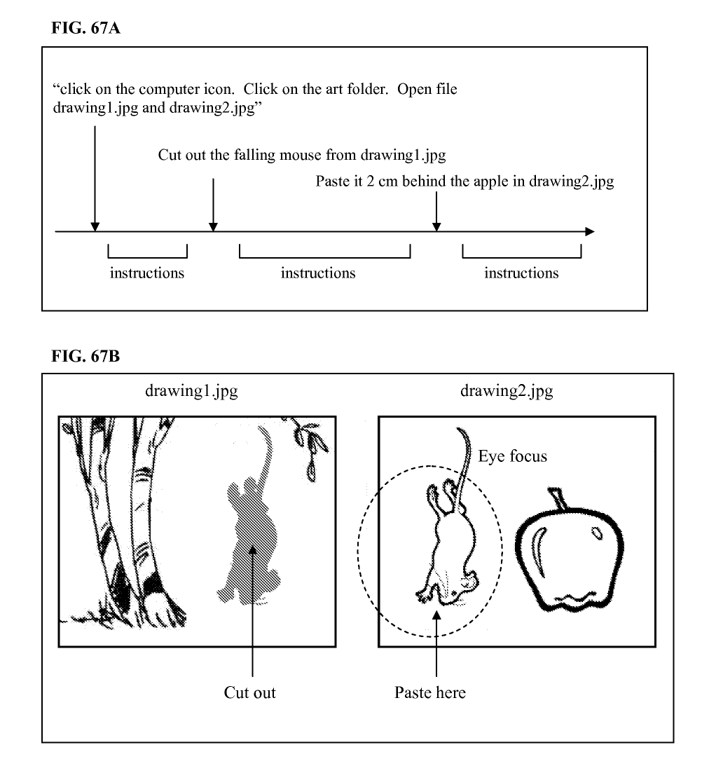

Next, just like the AI car, sentence commands are learned and understood through patterns found in similar examples. FIG. 67A is a diagram of sequential sentence commands given by a user to open files and to manipulate two image files. The first step is: “click on the computer icon. Click on the art folder. Open file drawing1.jpg and drawing2.jpg”. The AI OS will follow the instructions already in the pathway following step1. The second step is: “Cut out the falling mouse from drawing1.jpg”. The AI OS will follow the instructions already in the pathway following step2. Step 3 is: “Paste it 2 cm behind the apple in drawing2.jpg”. The AI OS will follow the instructions already in the pathway following step3 (FIG. 67B).

These sentence commands are given and then the AI operating system will follow certain instructions. These instructions are learned by supervised training from a teacher or by comparing similar examples to come up with universal patterns. Sentence commands can also be chained together forming complex sequences. All sentences are also represented by meaning and not just words in the sentences (representing language in a fuzzy logic manner).

Conclusion: The content discussed above is to depict alternative embodiment of the present invention. The human artificial intelligence program can be applied to all machines and computer software. For example, search engines can also be applied. The AI search engine can look for information over the internet in an intelligent way by using a form of human logic to gather relevant data from webpages, pictures, movies, songs, computer software, or a combination of media. Features that can be included in the AI search engine can be: solving math equations without needing a calculator, solving science problems without doing any experiments, reading an entire website and answering complex questions on specific pictures and text, seeing a movie online and being able to answer complex questions on the movie (deep logic such as Shakespeare movies), being able to project the weather months and years in advance, being able to answer any type of question a user might have with a human-like response and so forth.

Using the techniques in the human artificial intelligence program, the AI search engine will create sequence pathways that will search for content over the internet intelligently. The pathways must be trained so that each sequential task will yield a better search result. For example, if there was 3 tasks in a pathway, the AI search engine will gather content over the internet related to task 1, then using the content from task 1 the search engine will use task 2 to narrow down the content even further, next using the content from task 2 the search engine will use task 3 to narrow down the content even further. The end result is a more accurate and precise search result. Tasks in this AI search engine can be sentence commands, questions/answers from users, activated conscious thoughts, encapsulated instructions and so forth.

Learning Distance

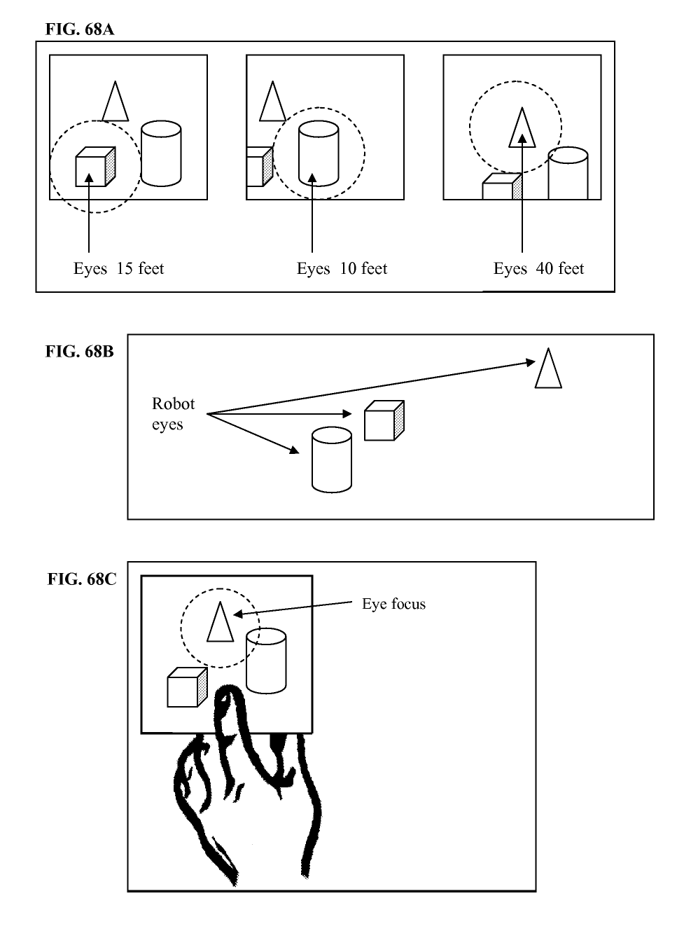

FIG. 68A-B is a real life-view of three shapes in our environment. The human eye focuses on an object and the distance is determined by the widening or the shortening of the retinal. The cube is 15 feet away from the robot, the cylinder is 10 feet away from the robot and the triangle is 40 feet away from the triangle. The distance between the robot's eyes and an object will determine the 3-dimensional shape of that object. A 3-d grid will wrap itself around the 2-d movie sequence.

The distance between the robot's eyes and an object is stored in the current pathway as it occurs and are known as hidden objects. FIG. 68C is the robot looking at a picture that resembles a frame in FIG. 68A. When the robot looks at the picture, it will activate the hidden objects associated with each object automatically. The picture (or a similar picture) will have a 3-d grid wrap around each image in the picture.

This is important because if the robot is holding a 2-d picture, the objects in the picture do not have a 3-dimensional shape. However, because the association between the distance hidden object and the visual object (the cube, cylinder or triangle) is so strong the distance hidden object is activated when the visual object is recognized. This gives the 2-d images in the picture a 3-dimensional shape. The AI program will use this method to derive logical and analytical data from the 2-d picture.

Touch Object

Most of the 5 senses in this and parent applications focus on visual objects. Hardly anything is mentioned about touch objects. As stated in previous applications touch objects are stored in the 3-dimensional grid. For a human robot, the touch sense will create a 3-dimensional touch floater of the robot's physical body in memory. All sensors on the robot will be stored in this touch floater.

The touch senses can also create 3-d touch floaters for any visual object or non-visual object. For example, if the robot is blind it can feel the visual object and the data from the touch sense will generate a 3-d touch floater of that object. If the robot isn't blind and it can see a visual object, the touch object will be wired to the visual 3-d object (if you include distance and eye focus). If the robot is looking at a cube and the robot touches the cube in all angles then it will store a touch floater next to the visual floater of a cube. The touch floater will have strong association to the visual floater of the cube. Sometimes the association between touch and vision is so strong that you can blindfold the robot and the robot can touch a cube and have the word “cube” activate in its' mind.

Air is one example of a non-visual object. Although we can't see air we can feel what air is. The word “air” is associated with the touch object air. The next time that the robot feels wind the sound object “air” activates in its' mind.

Ranking for Hierarchical Pathways

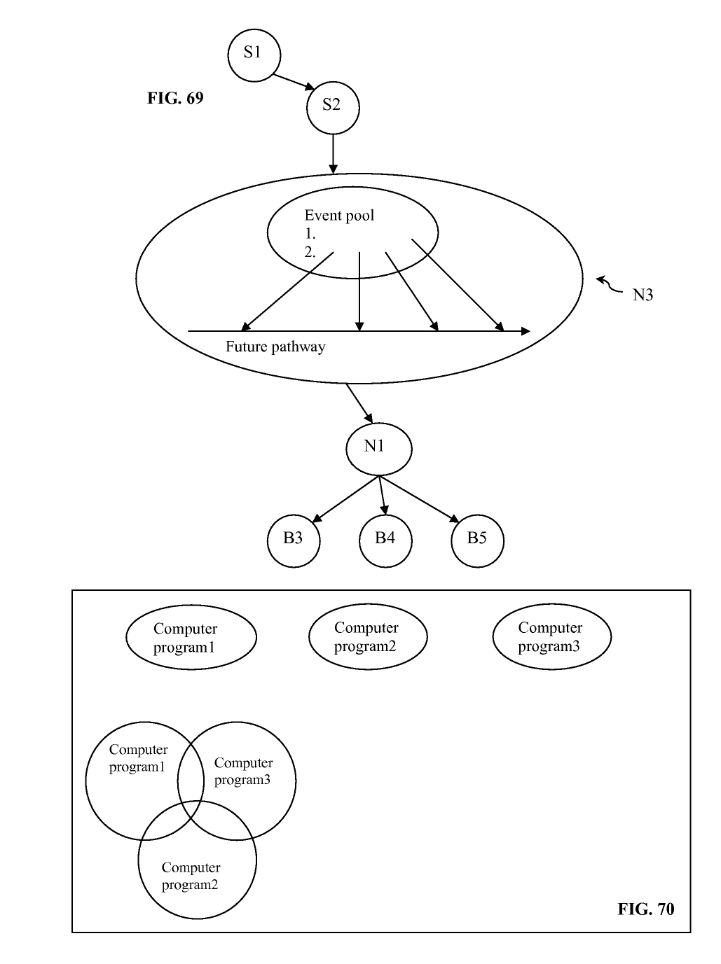

This part was left out from the future prediction section. FIG. 69 is a diagram illustrating a hierarchical tree (or pathway) for driving a car. B3, B4, B5 are derived from N1, N1 is derived from N3, N3 is derived from S2 and S2 is derived from S1. If B4 is the closest match to the current pathway the future pathways will be ranked in the order listed below. The highest rankings are specific pathways, while the lower rankings are universal pathways.

Best Future Pathways Rankings:

| | | | | | | |
|---|---|---|---|---|---|---|
| (1) B4 | (2) B3 | (3) B5 | (4) N1 | (5) N3 | (6) S2 | (7) S1 |

Similar driving route are stored in memory so the AI program will use specific pathways to drive from one location to the next (B3, B4, B5). Notice that the universal pathways: S2 and S1 are in the lower rankings. The top rankings will have specific driving pathways while the lower rankings will have more universal driving pathways in terms of strategies.

If pathway N3 is the closest match to the current pathway then the future pathways will be in the order listed below. This also means that the there are no specific pathways that match with the current pathway and the AI car has to use universal pathways (or strategy pathways) to drive the car.

For unknown pathways the rankings will be in this order:

| | | |
|---|---|---|
| (1) N3 | (2) S2 | (3) S1 |

The driving area is not familiar so the AI program uses strategy pathways to find a way to drive from the current location to the destination.

Intelligent Pathways Merge Together

A pathway in memory comprises 4 different data types: 5 sense objects, hidden objects, activated element objects and pattern objects. The combination of all 4 data types will create the “intelligence” of each pathway. As an illustration, imagine each pathway as a computer program. Each computer program has its own functions and operations to fulfill certain tasks. The computer codes to a Windows operating system are different from the computer codes to a Mac operating system or a Linux operating system. Despite there differences the Windows operating system, the Mac operating system and the Linux operating system have similarities. Each operating system is also written with many different programming languages—programming languages that are incompatible with each other. If we merge the functions of the three operating systems together based on commonalities, a universal operating system will be the result (FIG. 70).

If Microsoft wanted to add a new feature into the Windows operating system such as Internet explorer then Internet explorer will be stored in the Windows operating system. Internet explorer will then merge itself with the closest features to the other two operating systems. Hypothetically, if the Mac operating system has a similar feature called Internet navigator then Internet explorer will move toward Internet navigator. This will also bring the Windows operating system closer to the Mac operating system. Computer programs and their encapsulated functions will merge together based on common traits.

The big difference between conventional computer programs and intelligent pathways in the HAI program is that conventional computer programs was written to solve a “fixed” problem. The process of changing the computer codes with patches when a problem arises is not efficient. Designing a complex computer program also takes years and years of planning, testing and code writing. Conventional computer programs are also non-linear programming that is limited to a domain scope. Intelligent pathways in the HAI program are considered sequential programming because it is applied to sequential data. Sequential programming is more affective than conventional computer programs because it can store a lot more data and it can manage conflicting rules.

The present invention can be used to write computer software without the need of human programmers. This means that human computer programmers are not needed to build computer software. Another feature is that the different computer programming languages used to write computer software can be universalized into one computer programming language.

The key to this new form of writing computer software is that the codes are written by patterns from the environment. The environment can be complex like the real world or the environment can be simple like in an Atari game. In the real world the lessons from school teachers causes us to create intelligent pathways in memory. Lessons learned in school causes us to create intelligent pathways to drive a car, read a book, give a speech, operate a computer or run a business. If a human being can drive a car that means there exist a computer program to drive a car in memory. If a human being can solve a complex math problem that means there exist a computer program to do complex math in memory.

Language is always the key to forming complex intelligence because language can encapsulate entire objects, actions or events. The more complex the environment is the larger the language database should be. Simple environments like 2-d environments can have a simple form of language. If humans evolve and is aware of the 4^{th} dimension then it has to form a larger language database.

All machines will come from the same universal artificial intelligence program. The process is quit simple. Intelligent machines are built with different senses. Each sense will have predefined pain and pleasure (loud noise is pain, bright light is pain, food image is pleasure and so forth). Vision of the machine will determine the complexity of its environment. The environment can be 3-d, but if the vision system has basic colors the data stored in pathways can be little. If the vision system is advanced like a human eye with 64-bit colors then the data stored in pathways can be large. The built in senses in the machine can be minor like a computer virus or advance like a human being. The senses can be 3, 5 or 200. The different types of machines will go through the same learning process. Language will be learned and lessons from school teachers will build intelligent pathways to not only accomplish goals but to adapt and evolve. Intelligent pathways in memory will merge together (self-organize) and create hierarchical intelligent pathways.

Organization of Future Pathways

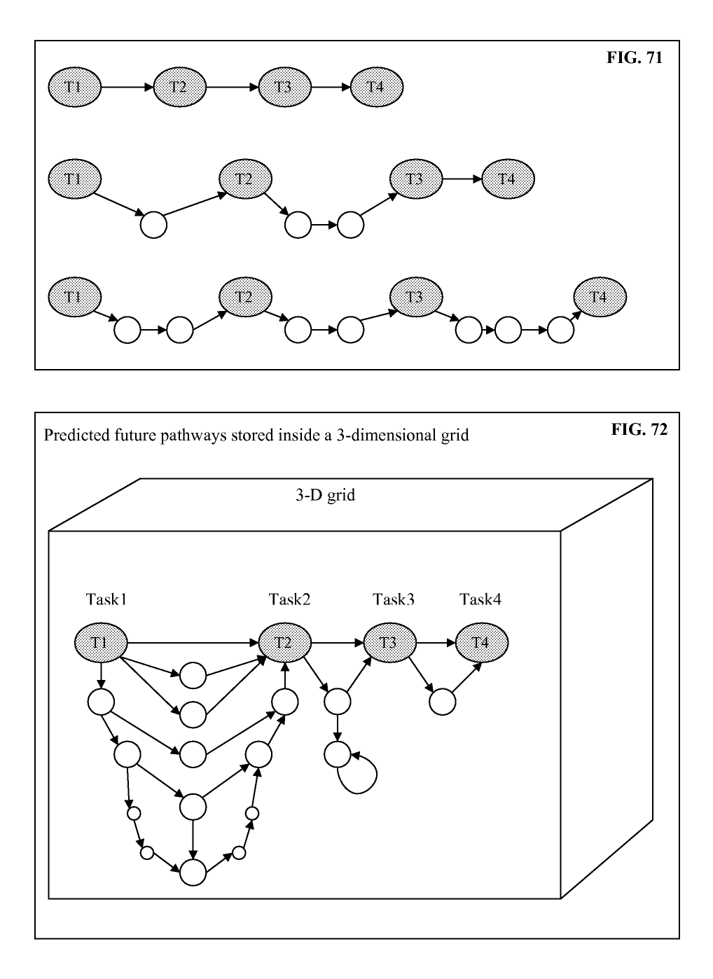

For the most part, all future pathways are structured in a hierarchical manner inside a 3-dimensional grid. The main goal of the AI program is to predict future pathways that are long and accurate. This would include fabricating continuous pathways in memory together into one long future pathway (FIG. 40). Referring to FIG. 71 and FIG. 72, all future pathways fabricated by the AI program will need to self-organize itself so that common future pathways are grouped together. The future pathways can't be copied from memory directly because future pathways are constructed from fragmented pathways in memory. Future pathways are also a combination of all 6 prediction methods mentioned earlier. For this reason, all predicted future pathway has to go through self-organization.

There are three advantages to this technique: 1. It is easier for the AI program to generate more future pathways. 2. It is easier for the AI program to rank all future pathways in terms of which future pathway is optimal. 3. It is easier for the AI program to calculate the probability of a future pathway occurring in the future. For the first advantage, if all predicted future pathways are structured in a hierarchical manner the AI program can generate more future pathways by analyzing, modifying and copying existing similar future pathways. This would also help in preventing any “repeated” prediction of future pathways or sections of future pathway that the AI program has already predicted.

For the second advantage, each predicted future pathway has already been compared and ranked. The position of the future pathway in the 3-d grid will determine how similar a future pathway is to other predicted future pathways. This will provide an estimated guess as to how desirable a future pathway is from all predicted future pathways. Therefore, an estimated rank of the future pathway can be determined based on the position of the future pathway in the 3-d grid.

For the third advantage, each predicted future pathway is grouped in a hierarchical manner and each future pathway can be compared with each other to determine the probability of occurrence in the future. This technique would require objects or events from each future pathway to be linked to each other. Existing algorithms for probability of occurrence can be used to determine the likelihood of a future pathway occurring in the future.

Adaptable AI Program (Focus on Adaptable Future Prediction Function)

In patent application: Ser. No. 12/110,313, the intelligent robots in the time machine (called virtual characters) will collaborate together to do “work”. If we combine this along with the lessons described above about adaptability, we can create an adaptable AI program that doesn't have fixed functions. This type of adaptable AI program is neverending and the robots in the time machine will work together to modify and optimize all functions in the AI program.

The intelligent robots in the time machine doesn't use any time because the time machine is a virtual world that emulates the real world. 20 years can pass in the time machine and only 1 second has past in the real world. This gives the robots a perfect opportunity to use human intelligence to solve a problem. FIG. 73 depicts a flow diagram illustrating the steps a robot can take to use human intelligence to solve a problem. In step 208, the robot has to define a problem to solve and to devise a plan to solve that problem. In order to do this the robot has to use human intelligence to identify a problem to solve. Creativity and imagination will give the robot ideas to set up a plan to solve this problem. In step 210, the robot has to use computer software or devices to solve that problem. If the computer software exists then he can use that computer software to solve the problem. If the computer software doesn't exist then he has to create the computer software or modify existing computer software. The robot also has to determine what types of software to use to solve a particular problem. If the robot has to solve a complex math equation, then the robot has to use a mathematical software. If the robot has to predict the future, then the robot has to use a prediction software. In step 212, if the robot has to modify a computer software, he can insert, delete or modify algorithms or functions in the computer software. Using human intelligence the robot will find the most optimal and efficient way to develop the computer software. In step 214, sometimes it requires a robot with human intelligence, at runtime, to determine input and output variables to be inserted into the computer software. Since the robot in the time machine is void of time he can reason (using human intelligence) what kinds of input and output variables are needed from the user during runtime. In step 216, the robot can also control the output of the computer software. He can define what the computer software will output based on a problem. For example, when someone is searching for images over the internet, the user might want to search for only black and white drawings. The user will define that the pictures outputted on the screen will only be black and white.

Notice in FIG. 73 that the robots working in the time machine are able to modify an adaptable AI program to solve any problem. This adaptable AI program can be known as a universal AI program because it can be used to solve “any” problem. This type of universal AI program is also void of time and the problem can be solved by using a team of intelligent robots working together.

Using the Adaptable AI Program to Predict the Future

We can also use the adaptable AI program to predict the future. Predicted future pathways stored in the 3-dimensional grid can be structured in such a manner that the robots working in the time machine can predict the future more realistically and accurately. The intelligent robots in the time machine (called virtual characters) will collaborate together to do “work”. “Work” in this case would be to predict the future accurately and realistically. The intelligent robots will use the future pathways and configure them in a certain way to either extract information or predict an optimal future pathway.

There are no fixed steps to predict the future. The robots in the time machine have to use existing computer programs to predict the future. If they find certain computer programs not efficient, they will use different computer programs that are efficient.

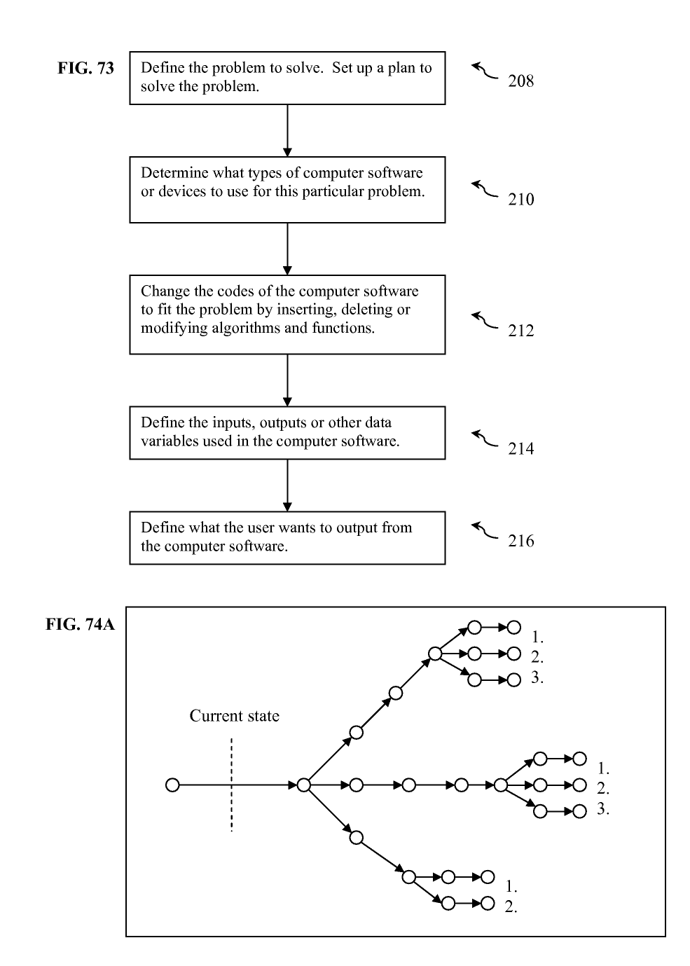

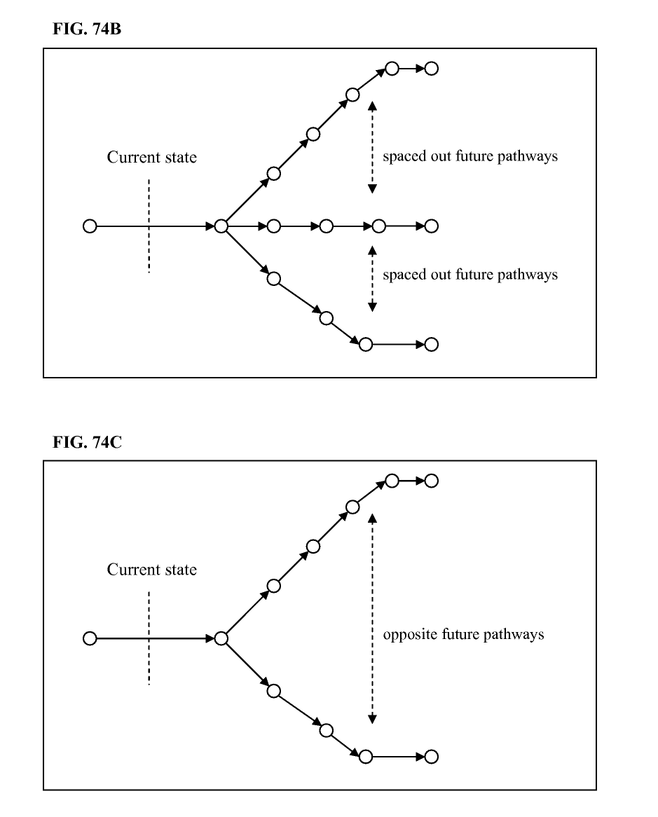

FIGS. 74A-C shows three types of future pathway structure that will allow robots to extract information or predict an optimal future pathway. In FIG. 74A, the future pathways are limited to similar future pathways in a group. The AI program doesn't want to predict too many similar future pathways so some groups are limited to 2 or 3 future pathways. In FIG. 74B, the future pathways are spaced out to give the AI program a more diverse future pathway. This will allow the AI program to determine variations to a current situation. It can also provide valuable information on the various possibilities of a current situation. In FIG. 74C, the future pathways are organized in an opposite manner. If a future pathway is predicted, then the AI program has to predict what the opposite of that future pathway is. For example, if the AI program predicts a baseball team winning a game the AI program will predict what will happen if the baseball team loses the game. These three examples FIGS. 74A-C are just some of the possible examples to illustrate how future pathways can be structured in a 3-dimensional grid to extract information. The structure of predicted future pathways should depend on what type of problem the robots are trying to solve and what kind of information they want to extract from future pathways.

Changing Objects or Events in a Future Pathway

Because the future pathways are structured in a hierarchical manner the robots working in the time machine can insert, delete or modify objects or events from any future pathway. Objects and events in future pathways are linked to one another in the 3-d grid so that when one future pathway is modified any similar or hierarchical future pathway will be affected. This will allow the robots to play what-if scenarios. For example, Al Gore is known as the father of the internet. He was the person directly responsible for passing the bill that allowed universities in the United States to create the internet. If the robots wanted to know what the timeline would be like (or the probable timeline) if Al Gore hadn't passed that bill, then the future prediction function should be able to “re-calculate” future pathways that could of happened if Al Gore hadn't passed the internet bill. My guess is that if Al Gore hadn't past that bill the United States would delay the development of the internet by 5-10 years. Either an independent computer company will develop a commercial software for the internet or someone else from the government would have past a similar bill to fund the internet.

The last example given illustrates how the robots can modify certain objects or events in predicted future pathways and the future prediction function is able to easily re-calculate future pathways hierarchically. All objects and events in all future pathways are linked together and structured hierarchically so that if one object or event in one future pathway is modified, similar or hierarchical future pathways are also modified. This saves the robots a lot of computer processing time and it prevents any repeated predictions.

The robots can also insert new objects or events in a future pathway and the future prediction function have to re-calculate what could of happened if the new object or event is inserted into the future pathway. For example, if the internet was built in 1950 what would the timeline be like. Or if the computer was built in 1920 what would the timeline be like.

Predicting the World Series Baseball or the Super Bowl 3 Years into the Future

A more difficult task is to predict the World series or the Super bowl 3 years into the future. Imagine the year is 1990, the robots has to predict the exact frame-by-frame event of the Super bowl in 1993. The entire game, including half-time, has to be predicted as it will happen in 1993. This would include: which two teams will play against each other, the game play, every movement of each player, who will win the game, what will each player say or do after winning the game and so forth.

From a human point of view this would be “impossible”. The reason for this is because we are looking at this problem from a human intelligence point of view. This problem is complex, but if we look at it from robots that are billions and billions of times smarter than a human being, it would be “possible” to predict the Super bowl 3 years into the future. This is why super intelligent robots are needed to predict future events accurately.

In order to predict the Super bowl 3 years into the future the robots have to know “everything”. Every fraction of a millisecond has to be predicted for “all” atoms on planet Earth for the next 3 years. All intelligent and non-intelligent objects have to be predicted. For intelligent objects such as a human being all physical actions has to be predicted every fraction of a millisecond. Non-physical actions such as thoughts of a human being also have to be predicted. What that person sensed from the environment in terms of his/her 5 senses must be predicted along with the thought process of what was activated because of the 5 senses.

In terms of predicting the Super bowl 3 years into the future, every football game played within the next 3 years has to be predicted precisely including all football games played in high school, college, recreational, professional football or in a videogame. In order to predict each football game, all other events leading to each football game has to be predicted. A player might be riding his skateboard one day and breaks his leg. This injury will prevent a player from playing in a football game. Another example is a player can be watching a movie and he might decide to use an idea from the movie to play a football game. All events and objects will affect the future, so in order to predict the Super bowl 3 years into the future, the robots have to predict all events and objects for the next 3 years on planet Earth leading up to the football game.

Predicting the Future Actions of a Human being

In order to predict the actions of a human being the robots have to analyze all aspects of that person—ranging from the physical structure of that person to the way the person thinks. Below is a list of things the robots have to predict in order to understand how a person will act in the future.

Predicting the Actions of a Human being
1. predict the physical atoms and motion of the human being every fraction of a millisecond.
2. predict what the human being is sensing from the environment including sight, sound, taste, touch and smell.
3. predict what the human being is thinking of as a result of their 5 senses.
4. predict random or systematic behavior taken by the human being.
5. predict the physical structure of the human being's brain including: every pathway in memory and the functions of the brain.

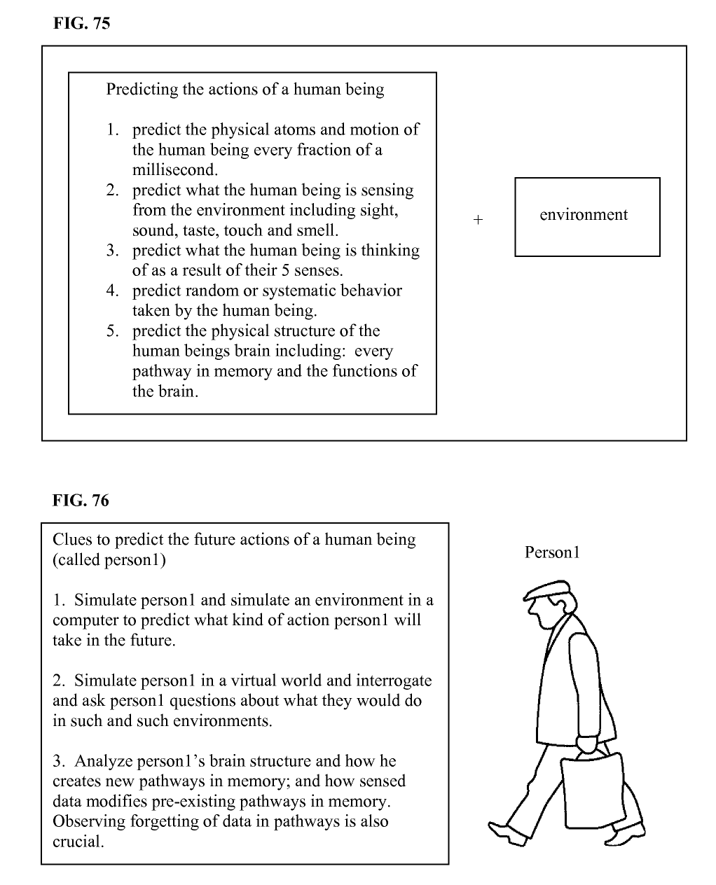

With all this information about a person, the robots will also predict the environment that the person will exist in. All chemical and physical atomic interactions have to be considered from the environment. FIG. 75 depicts an illustration of how the robots will predict the actions of a human being. First, the robots will predict microscopic data from the person, then it has to predict the microscopic data from the environment the person will exist in; and finally, the robots will predict how the person will behave within an environment. Sometimes the person wants to do a task, but the environment will prevent it from carrying out that task. For example, if the person is walking backwards and is unaware of the wall behind him, the environment will decide the person will stop at the wall.

FIG. 76 depicts additional clues that the robots can extract from a person (called person1) to predict person1's future actions. These are known as simulated techniques to predict the thought process of person1. These clues will make future predictions on person1 easier to predict. Below is a list of techniques that can be used to extract additional information from person1.

Clues to Predict the Future Actions of a Human being (Called Person1)

1. Simulate person1 and simulate an environment in a computer to predict what kind of action person1 will take in the future.
2. Simulate person1 in a virtual world and interrogate and ask person1 questions about what they would do in such and such environments.
3. Analyze person1's brain structure and how he creates new pathways in memory; and how sensed data modifies pre-existing pathways in memory. Observing forgetting of data in pathways is also crucial.

For the first technique the robots can simulate thousands of situations and output an average of what person1 is most likely to do in the future. In technique 2 the robots can ask specific questions to person1 to be used to target person1's actions. All three techniques can be used in combinations to better understand how person1 behaves and, hopefully, the robots can use this information to predict the exact actions of person1 in the future.

Another technique the robots can use to predict the actions of a human being is by analyzing DNA and to understand how cells behave because of instructions in DNA. DNA is simply a series of computer codes that unravel itself into an organism. By studying how DNA affects cell division and how these cells behave, the robots can formulate a model of that human being's brain (or any physical body part). How does the person think, what are the factors that trigger an action, what motivates that person to take action, what kind of innate traits are preprogrammed into that person, what are the innate likes of that person, what are the innate dislikes of that person, how do different cells in that person's body behave, how do these cells divide, how quickly do these cells divide, what areas will these cells be located after division and so forth. The DNA of an organism will answer these questions and the robots have to understand every microscopic detail concerning DNA for an organism in order to understand how that organism will behave in the future.

Predicting the actions of a human being is one thing, but predicting the actions of two or more intelligent objects is exponentially harder. If there exist two human beings and the robot has to predict each of their actions, the actions of person1 can't be predicted without predicting person2's actions. Both person1 and person2 have to be predicted as a group and not as individuals. These robots have to be able to predict all intelligent and non-intelligent objects on planet Earth for the next 3 years in order to predict a future event that will occur in 3 years. Imaginary objects and digital objects also have to be predicted. This problem may seem “impossible” if we look at it in terms of human intelligence. But, if we look at this problem from a robot that can think billions and billions of times smarter than a human being, it is “possible”.

The foregoing has outlined, in general, the physical aspects of the invention and is to serve as an aid to better understanding the intended use and application of the invention. In reference to such, there is to be a clear understanding that the present invention is not limited to the method or detail of construction, fabrication, material, or application of use described and illustrated herein. Any other variation of fabrication, use, or application should be considered apparent as an alternative embodiment of the present invention.

What is claimed is:

1. A method of creating human artificial intelligence in machines and computer software to predict the future and past with pinpoint accuracy, the method comprising:
an artificial intelligent computer program repeats itself in a single for-loop to:
receive input from the environment based on the 5 senses called the current pathway,
use an image processor to dissect said current pathway into sections called partial data,
generate an initial encapsulated tree for said current pathway; and prepare variations to be searched,
average all data in said initial encapsulated tree for said current pathway,
execute two search functions, one using breadth-first search algorithm and the other using depth-first search algorithm,
target objects found in memory will have their element objects extracted and all element objects from all said target objects will compete to activate in said artificial intelligent program's mind,
find best pathway matches,
find best future pathway from said best pathway matches and calculate an optimal pathway,
generate an optimal encapsulated tree for said current pathway,
store said current pathway and its' said optimal encapsulated tree in said optimal pathway, said current pathway comprising 4 different data types: 5 sense objects, hidden objects, activated element objects, and pattern objects,
follow future instructions of said optimal pathway,
retrain all objects in said optimal encapsulated tree starting from the root node,
universalize pathways or data in said optimal pathway; and
repeat said for-loop from the beginning;
a 3-dimensional memory to store all data received by said artificial intelligent program; and
a long-term memory used by said artificial intelligent program.

2. A method of claim 1, wherein said artificial intelligent program further comprising: a 3-dimensional grid to store and organize predicted future pathways in a hierarchical manner, which serves to minimize repeated future predictions as well as making future predictions easier for said artificial intelligent program.

3. A method of claim 2, wherein organization of predicted future pathways can also be structured in any manner or style, according to a problem being analyzed, by using current algorithms or mathematical functions by said artificial intelligent program.

4. A method of claim 1, in which said artificial intelligent program will predict the future using 6 prediction functions: predict future pathways by using hierarchical data analysis; predict future pathways by using linear and universal pathways; predict future pathways by reconstructing forgotten pathways; predict future pathways by using external reconstructive programs; predict future pathways by using a time machine; and predict future pathways by using logical learning.

5. A method of claim 4, wherein said universal pathways comprising at least one of the following: pattern strategies, computer programs, tasks, task sequences, the 4 data types, comprising: 5 sense objects, hidden objects, activated element objects and pattern objects, and language to represent future events.

6. A method of claim 4, wherein said external reconstructive programs comprising various computer software targeted at certain sensed data in pathways to reconstruct forgotten future pathways to its original state, for example, the sense of sight requires a video software to sharpen sequential images to its original state.

7. A method of claim 6, wherein said external reconstructive programs further reconstruct forgotten future pathways by changing aspects of objects in the forgotten future pathway to objects in the current pathway, said aspects of objects comprising at least one of the following: color, size, 3-d shape, length, width, texture and object traits.

8. A method of claim 7, in which forgotten pathways reconstructed by said external reconstructive programs create imaginary future pathways based on the current pathway and pathways in memory to the exact future the robot will experience from the environment; and serves as a benchmark to aid said artificial intelligent program to fabricate more realistic future pathways.

9. A method of claim 4, in which said time machine comprising: a virtual world that emulates physical objects, chemical interactions and physic laws from the real world; and creating realistic and accurate targeted virtual environments based on objects in pathways in memory.

10. A method of claim 9, wherein said time machine further comprising additional features including: embedded software, the internet, machinery, computer hardware and integrated circuits, which help said artificial intelligent program to predict the future accurately and realistically.

11. A method of claim 10, in which said artificial intelligent program searches predicted future pathways sequentially, starting from the current state, and to provide predicted results to unpredictable events, whereby if an unpredictable event is difficult to provide a predicted result said artificial intelligent program will skip said unpredictable event and move on to the next unpredictable event in sequence order.

12. A method of claim 4, wherein said predict future pathways by using logical learning comprises the steps of:
using human intelligence to create an outline or plan of a sequence of future events; and
capturing said sequence of future events in a fixed tangible media, said fixed tangible media comprising one of the following: a book, report papers, a video, an audio, a calendar, a computer file, a hologram and a canvas.

13. A method of claim 12, in which said predict future pathways by using logical learning further comprises the steps of:
searching in pathways for any patterns between data in fixed tangible media and future events; and
if patterns are found, designating reference pointers between data in fixed tangible media and future events.

14. A method of claim 13, wherein said artificial intelligent program predicts the future by predicting the steps to creating a fixed tangible media, whereby data in said fixed tangible media contains reference pointers to future events.

15. A method of claim 1, wherein said artificial intelligent program form complex human intelligence comprising:
pathways in memory learn knowledge by a bootstrapping process, whereby new knowledge builds on previously learned knowledge;
pathways in memory go through trial and error to keep pathways that lead to pleasure and forget pathways that lead to pain;
pathways in memory are structured in a hierarchical manner; and
similar pathways or pathways stationed in various local areas in memory self-organize to structure intelligent pathways in a hierarchical manner.

16. A method of claim 15, in which pathways in memory can form human intelligence to solve a universal problem by using conscious thoughts from said artificial intelligent program, the method comprising the steps of activating conscious thoughts to: identify a problem to solve; set goals; plan steps to achieve goals; use trial and error to bypass obstacles; and finalizing the method by at least one of the following: accomplish goals and abort goals.

17. A method of claim 16, in which said universal problem is moving an object from a start location to a destination location,

18. A method of claim 15, wherein knowledge is learned by said artificial intelligent program attending school from kindergarten through college.

19. A method of claim 1, wherein said artificial intelligent program is adaptable and can be applied to at least one of the following: a machine, a software program, an electronic device and a network, wherein compatibility of external and internal sensors or controls is interfaced with said artificial intelligent program through modification of data recorded in pathways in memory.

20. A method to predict the future actions of a human being, comprising the steps of:
predicting the physical atoms and motion of said human being every fraction of a millisecond;
predicting what said human being is sensing from the environment including sight, sound, taste, touch and smell;
predicting what said human being is thinking of as a result of their 5 senses;
predicting random or systematic behavior taken by said human being;
predicting the physical structure of said human being's brain including: every pathway in memory and the functions of the brain;
simulating said human being and simulating an environment in a computer to predict what kind of action said human being will take in the future;
simulating said human being in a virtual world and interrogating and asking said human being questions about what they would do in such and such environments;
analyzing said human being's brain structure and how he creates new pathways in memory; and how sensed data modifies pre-existing pathways in memory and observing forgetting of data in pathways in said human being's brain;
predicting said human being's surrounding objects and their actions, said surrounding objects comprising at least one of the following: intelligent object, non-intelligent object, imaginary object and digital object.
